(19) United States
(12) Patent Application Publication
(10) Pub. No.: US 2022/0138753 A1
(43) Pub. Date: May 5, 2022

(54) INTERACTIVE SWARMING

(71) Applicant: Raise Marketplace, LLC, Chicago, IL (US)

(72) Inventors: William A. Wright, Los Gatos, CA (US); Lars P. Wright, San Francisco, CA (US); Christopher J. Wright, San Francisco, CA (US)

(73) Assignee: Raise Marketplace, LLC, Chicago, IL (US)

(21) Appl. No.: 17/085,087

(22) Filed: Oct. 30, 2020

(51) Int. Cl. G06Q 20/40; G06F 16/245; G06N 20/00

(52) U.S. Cl. CPC G06Q 20/4016; G06N 20/00; G06F 16/245

(57) ABSTRACT

A method includes evaluating a transaction using a first swarm member to generate a first cooperative prediction related to the transaction. The first cooperative prediction is based, at least in part, a first affinity value of the first swarm member to one or more other swarm members. The method also includes evaluating the transaction using a second swarm member to arrive at a second cooperative prediction related to the transaction. The second cooperative prediction is based, at least in part, on a second affinity of the second swarm member to one or more other swarm members. A swarm prediction related to the transaction is generated based on both the first cooperative prediction and the second cooperative prediction.

### CROSS REFERENCE TO RELATED PATENTS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

### Technical Field of the Invention

This invention relates generally to data communication systems, and more particularly to data communication systems employing interactive swarming.

### Description of Related Art

Data communication systems include user computers, service provider servers, data storage servers, and network infrastructure that allows the various components of a system to communicate data with each other. The service providers provide a wide variety of digital data services, including, but not limited to, data storage services, streaming video services, digital music purchases, other digital content purchases (e.g., video files, gift cards, etc.), digital assistant services (e.g., dictation, time management, contact management, project management, etc.), etc.

Modern data communications systems often encounter various decision points in the course of providing data services. These decision points can include determining optimal routing paths for delivering data, determining whether a request for access to a service is authorized, determining whether a requested payment transactions is fraudulent, determining whether a data packet includes malicious content, and so on.

Current data communications systems employ various techniques for making decisions, including the use of statistical algorithms, estimation rules, and even artificial intelligence (AI).

### BRIEF DESCRIPTION OF THE SEVERAL VIEWS OF THE DRAWING(S)

FIG. 1 is a schematic block diagram of an embodiment of a data transactional network in accordance with the present invention;

FIG. 2 is a schematic block diagram of an embodiment of a computing device in accordance with the present invention;

FIG. 3 is a schematic and functional block diagram of an embodiment of a fraud detection computing system in accordance with the present invention;

FIG. 4 is a functional block diagram of an embodiment of a transaction and related data for processing by the fraud detection computing system in accordance with the present invention;

FIG. 5 is a functional block diagram of an embodiment of transactional data and tools of the fraud detection computing system for generating a fraud evaluation answer for a transaction in accordance with the present invention;

FIG. 6 is a logic diagram of an example of a method executed by a fraud detection computing system for generating a fraud evaluation answer for a transaction in accordance with the present invention;

FIG. 7 is a functional diagram of an example of a fraud evaluation answer in accordance with the present invention;

FIG. 8 is a logic diagram of an example of a method executed by a fraud detection computing system for generating an initial fraud evaluation answer for a transaction in accordance with the present invention;

FIGS. 9A-9H are functional block diagrams of an example of generating a fraud evaluation answer for a transaction of by a fraud detection computing system in accordance with the present invention;

FIG. 10 is a functional block diagram of another example of generating an initial fraud evaluation answer for a transaction of by a fraud detection computing system in accordance with the present invention;

FIG. 11 is a logic diagram of a further example of a method executed by a fraud detection computing system for updating an initial fraud evaluation answer for a transaction in accordance with the present invention;

FIGS. 12A-12G are functional block diagrams of another example of generating a fraud evaluation answer for a transaction of by a fraud detection computing system in accordance with the present invention;

FIG. 13 is a logic diagram of an example of a method executed by a fraud detection computing system for updating fraud evaluation tools in accordance with the present invention;

FIG. 14 is a functional diagram of an example of a transaction-matrix in accordance with the present invention;

FIG. 15 is a schematic diagram illustrating interactive relationships between swarm members in accordance with embodiments of the present invention;

FIG. 16 is a functional block diagram illustrating a method of interactive swarm prediction, in accordance with embodiments of the present invention;

FIG. 17 is a functional block diagram illustrating a method of adjusting affinity values in accordance with embodiments of the present invention;

FIG. 18 is a functional block diagram illustrating a method of cooperative-decision training in accordance with embodiments of the present invention;

FIG. 19 is a functional block diagram illustrating context-based affinity in accordance with embodiments of the present invention;

FIGS. 20A-20D illustrate a context-values table in accordance with embodiments of the present invention;

FIG. 21 illustrates a context-definition table in accordance with embodiments of the present invention;

FIG. 22 illustrates an affinity table in accordance with embodiments of the present invention;

FIG. 23 is a functional block diagram illustrating a method of evaluating a transaction request for fraud in accordance with embodiments of the present invention;

FIG. 24 is a functional block diagram illustrating a method of multiple hypothesis tracking, in accordance with embodiments of the present invention;

FIG. 25 is a functional block diagram illustrating a method of using multiple hypothesis tracking to evaluate changes in a target's classification in accordance with embodiments of the present invention;

FIG. 26 is a functional block diagram illustrating a method of intra-group communication in accordance with embodiments of the present invention;

FIG. 27 is a block diagram illustrating communication of data among Bots included in a swarm in accordance with embodiments of the present invention;

FIG. 28 is a functional block diagram illustrating a method of implementing fraud detection as a service in accordance with embodiments of the present invention;

FIG. 29 is a functional block diagram illustrating a method of establishing evaluation parameters in accordance with embodiments of the present invention;

FIG. 30 is a block diagram illustrating a refinement module in accordance with embodiments of the present invention; and

FIG. 31 is a functional block diagram illustrating refining predictions in accordance with embodiments of the present invention.

### DETAILED DESCRIPTION OF THE INVENTION

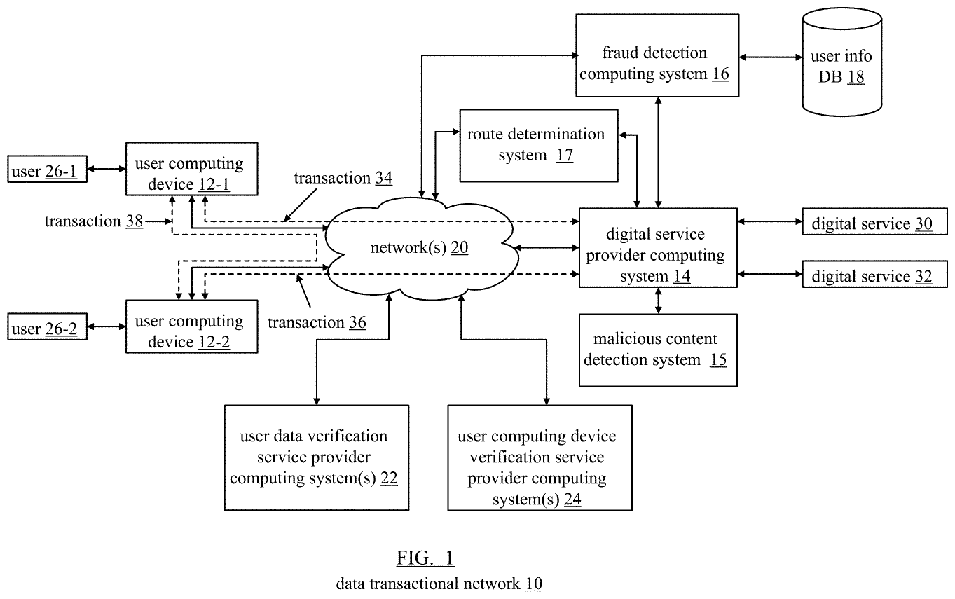

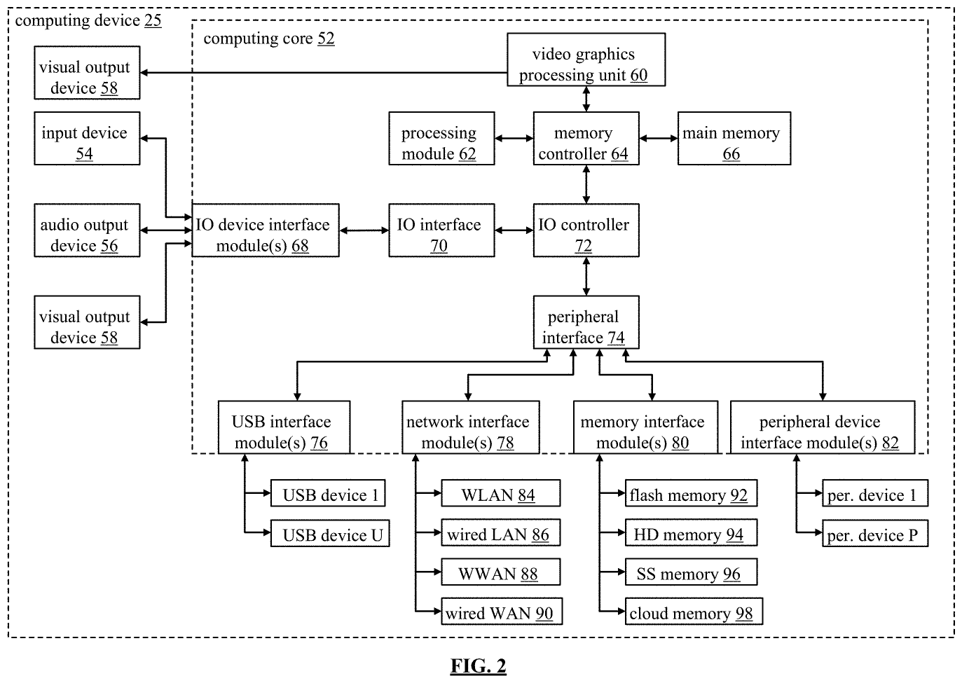

FIG. 1 is a schematic block diagram of an embodiment of a data transactional network 10 that includes user computing devices 12, a digital service provider computing system 14, a malicious content detection system 15, a fraud detection computing system 16, a route determination system 17, a user information database (info DB) 18, one or more networks 20, a user data verification service provider computing system 22, and a user computing device verification service provider computing system 24. Each of the user computing devices 12 has a construct similar to the computing device 25 of FIG. 2 and is associated with a user. As used herein, a user is a person, a group of people (e.g., user group), a business, and/or other entity (e.g., a trust, an agency, etc.).

The network 20 includes one more local area networks (LAN) and/or one or more wide area networks (WAN). Each WAN and/or LAN of the network 20 is a public network and/or a private network. A LAN may be a wireless-LAN (e.g., Wi-Fi access point, Bluetooth, ZigBee, etc.) and/or a wired network (e.g., Firewire, Ethernet, etc.). A WAN may be a wired and/or wireless WAN, such as the Internet, cellular telephone infrastructure, data switching network, and/or satellite communication infrastructure.

Each of the malicious content detection system 15, the fraud detection computing system 16, the route determination system 17, the user data verification service provider computing system 22, and the user computing device verification service provider computing system 24 includes one or more computing devices, such as the computing device 25 of FIG. 2, and may also include a database, or have access to an external database.

Within the data transactional network, a computing device generally includes a computing core and is any electronic device that can communicate data, process data, and/or store data. A further generality of a computing device is that it includes a central processing unit (CPU), a memory system, user input/output interfaces, peripheral device interfaces, and an interconnecting bus structure.

As specific examples, a computing device is a portable computing device and/or a fixed computing device. A portable computing device is a social networking device, a gaming device, a cell phone, a smart phone, a personal digital assistant, a digital music player, a digital video player, a laptop computer, a handheld computer, a tablet, a video game controller, and/or any other portable device that includes a computing core. A fixed computing device is a personal computer (PC), a computer server, a cable set-top box, a satellite receiver, a television set, a printer, home entertainment equipment, a video game console, and/or any type of home or office computing equipment that includes a computing core.

As an overview of operation, the data transaction network 10 supports transactions regarding digital services between computing devices of the network 10. In general, a transaction is an exchange of digital information where one party provides first digital information (e.g., a request for something) to a second party in exchange for receiving second digital information (e.g., a response to the request) regarding a digital service.

A digital service is one of a variety of services. For example, a digital service is accessing a streaming video and/or music for a fee (e.g., per video, a monthly subscription fee, etc.), where the first digital information includes user account information and a request for the vide and the second digital information includes the streaming video. As another example, a digital service is using on-line software (e.g., word processing, illustrating, presentations, etc.) for a fee. As yet another example, a digital service is regarding an on-line sale of a gift card, or the like. As a further example, a digital service is regarding an on-line purchase of a gift card, or the like. As a still further example, a digital service is regarding use of a gift card, or credit card, to purchase an item that will be physically shipped from the service provider to the user. As a still further example, a digital service is regarding storage and/or access of digital information with an on-line data storage service provider for a fee. As a still further example, a digital service is regarding a feature of a social media platform. Note that, as used herein, on-line means engaging at least a portion of the data transaction network to support a digital service at least partially.

Other examples of a digital service include performing malicious content detection, and making data routing determinations. For example, malicious content detection can include using malicious content detection system 15 to detect malware in packets being transferred through network 20, or in data objects being stored, read, or otherwise processed by digital service provider computing system 14. An example of routing determinations includes using route determination system 17 to determine an optimal route through all or a portion of network 20. Determining a route can be performed upon request of a device external to network 20, or automatically by network 20 even if route determination is not specifically requested by an external device.

In a more specific example of operation, a user 26, via its user computing device 12, initiates a transaction regarding a digital service. For example, the user computing device 12-1 initiates transaction 34 with the digital service provider computing system 14 regarding digital service. As another example, the user computing device 12-2 initiates transaction 36 with the digital service provider computing system 14 regarding digital service 32. As yet another example, the user computing device 12-1 initiates transaction 38 with the user computing device 12-2 regarding digital service. In any of these examples, malicious content detection or route determination digital services can be performed in addition to other digital services. In alternate embodiments, malicious content detection or route determination can be provided as stand-alone digital services.

In the example of transaction 34 between the user computing device 12-1 (for its user 26-1) and the digital service provider computing system 14 regarding digital service 30, the digital service provider computing system 14 receives a request for the transaction 34. Prior to processing the transaction 34, the digital service provider computing system 14 invokes the fraud detection computing system 16 to render a decision as to the likelihood that the transaction includes an element of fraud (e.g., fraudulent account, account take over, fraudulent payment information, etc.). In an embodiment, the fraud detection computing system 16 is integrated with, embedded in, and/or affiliated with the digital service provider computing system 14.

The fraud detection computing system 16 utilizes a selective combination of evaluation tools, fraud analysis tools, and/or swarm organizational tools to produce a fraud analysis model to render a fraud evaluation answer based on a wide variety of data. The evaluation tools, fraud analysis tools, and swarm organization tools are artificial intelligent (AI) modules that each execute a particular function(s) as will be described in greater detail with reference to one or more of the remaining figures.

The fraud detection computing system 16 executes the fraud analysis model using data it collects from various sources to automatically render a fraud evaluation answer. The answer is one of “low risk of fraud” or accept; a decision of “high risk of fraud” or reject’; or a decision of further review or agent review. The data used by the fraud detection computing system 16 is from the user information database 18, the user data verification service provider computing system 22, the user computing device verification service provider computing system 24, and/or other sources of information relevant to fraud detection for a particular transaction, for a particular user, for a particular digital service, and/or for a particular digital service provider computing system.

After an answer is rendered, the fraud detection computing system 16 collects data regarding the accuracy of its fraud evaluation answer. If the answer was incorrect or inaccurate, the fraud detection computing system 16 determines the nature of the inaccuracy and makes adjustments to tools, data sets, and/or creates new tools to address the inaccuracy. With such a system and methodology, automated fraud detection can be substantially improved. For instance, processing of fraudulent transactions can be reduced from 7-9% to less than 1% with negligible impact on speed of processing the transactions.

As an implementation variant, the user verification service provider computing system 22 is integrated with, embedded in, and/or affiliated with the digital service provider computing system 14. As an extension of the implementation variant or as another implementation variant, the user computing device verification service provider computing system 24 is integrated with, embedded in, and/or affiliated with the digital service provider computing system 14.

In an alternate example of transaction 34 between the user computing device 12-1 (for its user 26-1) and the digital service provider computing system 14 regarding digital service 30, the digital service provider computing system 14 receives a request for the transaction 34. Prior to processing the transaction 34, the digital service provider computing system 14 invokes the malicious content detection system 15 to render a decision predicting the likelihood that data associated with the transaction includes malicious content.

In conjunction with providing the requested digital service, digital service provider computing system 14 can also invoke route determination system 17, to render a decision predicting a likelihood that a selected route, or routing mechanism, through network 20 is likely to result in a successful transmission of the message, command, data object, etc. In this context, successful transmission can refer simply to data reaching its intended destination, or reaching its intended destination within a threshold number of hops, within a threshold time period, with less than a threshold number of errors, using less than a threshold amount of bandwidth, or in a way that satisfies other specified transmission metrics.

FIG. 2 is a schematic block diagram of an embodiment of a computing device 25 that includes a computing core 52, one or more input devices 54 (e.g., keypad, keyboard, touchscreen, voice to text, etc.), one or more audio output devices 56 (e.g., speaker(s), headphone jack, etc.), one or more visual output devices 58 (e.g., video graphics display, touchscreen, etc.), one or more universal serial bus (USB) devices, one or more networking devices (e.g., a wireless local area network (WLAN) device 84, a wired LAN device 86, a wireless wide area network (WWAN) device 88 (e.g., a cellular telephone transceiver, a wireless data network transceiver, etc.), and/or a wired WAN device 90), one or more memory devices (e.g., a flash memory device 92, one or more hard drives 94, one or more solid state (SS) memory devices 96, and/or cloud memory 98), and one or more peripheral devices.

The computing core 52 includes a video graphics processing unit 60, one or more processing modules 62, a memory controller 64, main memory 66 (e.g., RAM), one or more input/output (I/O) device interface module 68, an input/output (I/O) interface 70, an input/output (I/O) controller 72, a peripheral interface 74, one or more USB interface modules 76, one or more network interface modules 78, one or more memory interface modules 80, and/or one or more peripheral device interface modules 82. Each of the interface modules 68, 76, 78, 80, and 82 includes a combination of hardware (e.g., connectors, wiring, etc.) and operational instructions stored on memory (e.g., driver software) that is executed by the processing module 62 and/or a processing circuit within the interface module. Each of the interface modules couples to one or more components of the computing device 12-16. For example, one of the IO device interface modules 68 couples to an audio output device 56. As another example, one of the memory interface modules 80 couples to flash memory 92 and another one of the memory interface modules 80 couples to cloud memory 98 (e.g., an on-line storage system and/or on-line backup system).

Note that a computing device of the digital service provider computing system 14, the malicious content detection system 15, the fraud detection computing system 16, the route determination system 17, the user data verification service provider computing system 22, and/or of the user computing device verification service provider computing system 24 may include more or less components than shown. For example, when a computing device is functioning as a server, it may not include speakers and/or other IO components that are geared toward human interface. As another example, a computing device includes multiple processing modules 62 and/or multiple main memories 66. As yet another example, a computing device includes only one network card coupled to the network interface module 78.

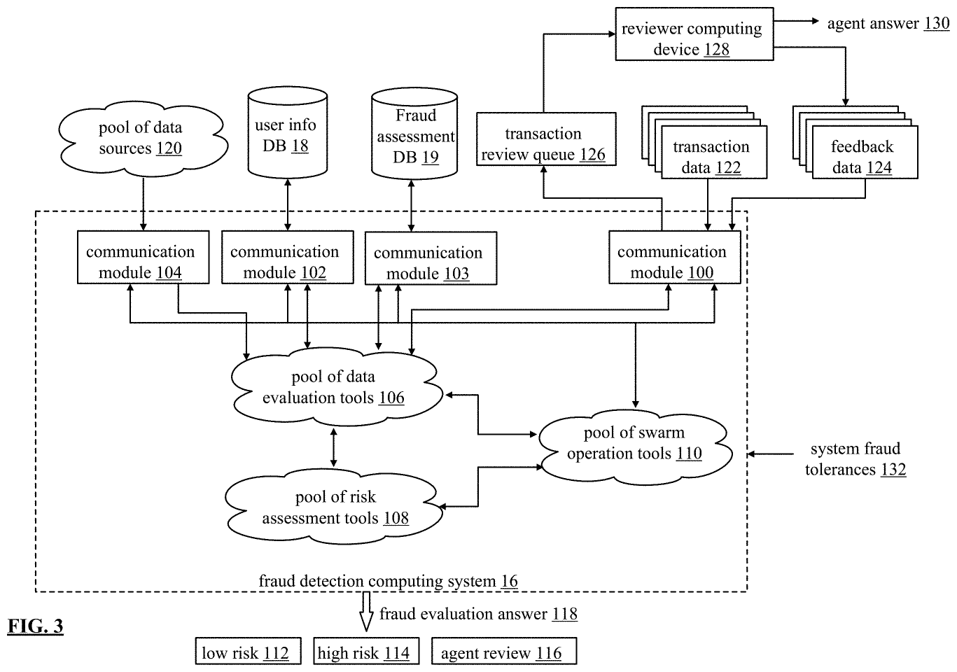

FIG. 3 is a schematic and functional block diagram of an embodiment of a fraud detection computing system 16. In functional terms, the fraud detection computing system 16 includes communication modules 100-104, a pool of evaluation tools 106, a pool of risk assessment tools 108, and a pool of swarm operation tools 110 operating on one or more of the computing devices of the system 16. The tools are artificial intelligent (AI) modules that each execute a particular function(s) to facilitate the automatic generation of a fraud evaluation answer 118. In some circles, the AI modules may be referred to as “computer bots” or “bots”. Malicious content detection system 15 and route determination system 17 can include elements similar in both form and operation to those illustrated and discussed with respect to fraud detection computing system 16.

The communication modules 100-104 are specific-function swarm operational tools that include specific (e.g., proprietary, limited access, etc.) application programming interfaces (API) to enable communication between the tools of the pool of evaluation tools 106, of the pool of risk assessment tools 108, and/or of the pool of swarm operation tools 110 to support the fraud analysis model and/or modifications to the model. The communication modules 100-104 further function to enable tools of the fraud analysis model to communicate with a pool of data sources 120 that is external to the fraud detection computing system 16. The communication modules 100-104 further support tools communicating with the user information database 18, and fraud assessment database 19. Note that the pool of data sources 120 includes the user data verification service provider computing system 22, the user computing device verification provider computing system 24, other sources of information relevant to fraud detection for a particular transaction, for a particular user, for a particular digital service, and/or for a particular digital service provider computing system.

In an example of operation, the fraud detection computing system 16 receives transaction data 122 regarding transactions. The transaction data includes data regarding the transaction, which includes source identity information regarding a source of the transaction, destination identity information regarding a destination of the transaction, and information regarding the digital service of the transaction action. For example, if the source of the transaction is a user, then the source identity information includes the identity of the user and identity of the user's computing device; if the destination is a digital service provider computing system 14, then the destination identity information includes identity of the service provider and identity of one or more computing devices of the system 14.

The fraud detection computing system 16 also receives, or has stored, system fraud tolerances 132 for the digital service provider computing system 14 and/or for the particular digital service being requested. In general, the system fraud tolerances 132 provide guidance for the fraud detection computing system 16 on how tightly to apply its analysis (e.g., the level of confidence an answer is right, before rendering it). In many instances, the system fraud tolerances 132 are a balancing of customer experience, speed of service, and closing a sale of a digital service versus the risk of the sale being fraudulent (e.g., to a bad actor, a bad actor impersonating a good actor, fraudulent payment, etc.). Each time the fraud detection computing system 16 renders a decision of “agent review”, the customer experience may be degraded and the likelihood that the sale will not close increases dramatically.

Further, each time an automated answer to accept or reject is wrong, it harms the service provider. As such, some service providers (e.g., providers that have relatively low volume and relative high costs for digital services) may want a tight tolerance to ensure that little fraud actually occurs at the potential cost of more “agent review” answers. While other service providers (e.g., provides that have relatively high volume and relative low costs for digital services) may have a high tolerance to fraud transaction answers being wrong so they can reduce the number of agent reviews.

For a given transaction and in accordance with the system fraud tolerances 132, the fraud detection computing system 16 creates a fraud evaluation model, which includes selected tools of the pools of tools 106-108. The fraud detection computing system 16 then retrieves data from the pool of data sources 120, the user information database 18, fraud assessment database 19, and/or data sources. Applying the data to the fraud evaluation model, the fraud detection computing system 16 renders a fraud evaluation answer 118, which may be a low risk answer 112 (e.g., accept the transaction), a high-risk answer 114 (e.g., reject the transaction), or an agent review answer 116.

When the answer is “agent review” 116, the transaction and the relevant data are placed in a transaction review queue 126 for subsequent review by a person operating a reviewer computing device 128. At some point in time, the person retrieves, via the reviewer computing device 128, the transaction and the relevant data from the queue 126 for human analysis. After human analysis, the person enters an agent's answer 132 (e.g., accept or reject the transaction) into the reviewer computing device 128.

The agent's answer 132 is provided to the fraud detection computing system 16 as feedback data 124. The fraud detection computing system 16 utilizes the agent's answers 132 as well as charge back information and agents' decision probability reports to determine which automated fraud evaluation answers were wrong and why. From this analysis, the fraud detection computing system 16 updates existing tools and/or creates new tools to improve accuracy of the automated fraud evaluation answers.

Fraud assessment database 19 is a structured set of data held in a computer, especially one that is accessible in various ways. Fraud assessment database 19 stores multiple fraud assessment records, where each record corresponds to a past or contemporaneous transaction. A transaction record can include: a transaction identifier; information establishing one or more transaction “fact patterns,” or context; a transaction type identifier and data relevant to the transaction. The data relevant to the transaction can include scores generated by each module used to arrive at a fraud evaluation answer; interactions between modules for adjusting evaluation protocols; a reliable fraud assessment answer; an accuracy associated with a reliable fraud assessment answer; correct auto-generated fraud risk answers; incorrect auto-generated answers that caused a good transaction to be blocked (Type 1 error); incorrect auto-generated answers that failed to block a bad transaction that should have been blocked (Type 2 error); correct agent review fraud answers; incorrect agent review fraud answers that caused a good transaction to be blocked; and incorrect agent review fraud answers that failed to block a bad transaction that should have been blocked.

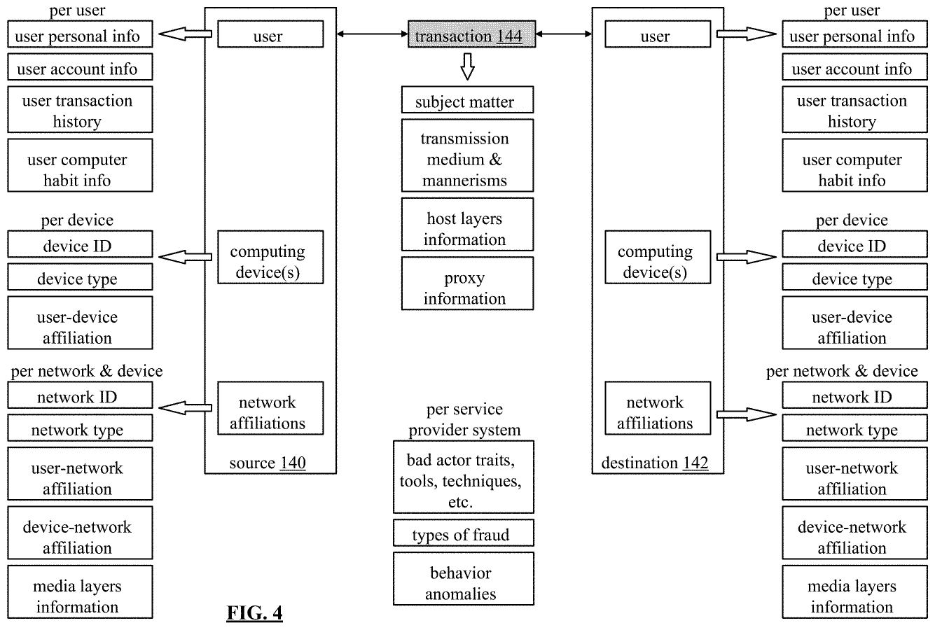

FIG. 4 is a functional block diagram of an embodiment of a transaction and related data for processing by the fraud detection computing system 16. The source 140 initiates the transaction 144 by sending a request for a digital service to the destination 142. The source 140 includes a user, the user's computing device, or devices, and the user's network affiliation, or affiliations. The destination 142 similarly includes a user, the user's computing device, or devices, and the user's network affiliation, or affiliations. Recall that a user is a person, a group of people (e.g., user group), a business, and/or other entity (e.g., a trust, an agency, etc.).

To begin the fraud evaluation analysis, the fraud detection computing system 16 gathers information regarding the source 140, the destination 142, and the transaction 144 from the pool of data sources 120, the user information database 18, and/or other sources.

For the transaction, the fraud detection computing system 16 gathers transaction data, which includes one or more of, but not limited to:
subject matter information (e.g., information regarding the digital service being requested such as name, type, purchase price, quantity ordered, type of subject matter, value of subject matter, typical nature of transaction regarding the subject matter, is source user the type of user to engage in a transaction regarding the subject matter, is destination user the type of user to engage in a transaction regarding the subject matter, etc.);
transmission medium information (e.g., information regarding how the destination received the request for the digital service such as via the internet, via a wireless data cellular service, via a Wi-Fi connection, source location, destination location, etc.);
transmission mannerism information (e.g., information regarding how conventional the transmission medium information to provide insight into “was the receiving mechanism typical for the request, for the source, for the destination”, “is the source location typical”, etc.);
host layer information (e.g., per the OSI model, information to provide insight into “was there anything unusual about the transport layer, the session layer, the presentation layer, and/or the application layer”, “if so, what is it”, etc.); and
proxy information (e.g., information to provide insight into “did the source use a proxy IP (internet protocol) address, a proxy server, and/or other proxy means”, “if so, what type and to what extent”, “how hard does it appear that the source is trying to hide its true IP address”, etc.).

For information regarding the source user, the fraud detection computing system gathers one or more of the following:
user personal information (e.g., name, nickname, mailing address, billing address, age, phone number(s), email address(es), etc.);
user account information (e.g., account number, age of account, username, user payment data (e.g., credit card information, payment service account information, etc.), etc.);
user transaction history (e.g., account use history, types of transactions, frequency of transactions, types of digital services, frequency of use of the digital services, fraud history with other digital services, payment history, nature of payments, how many years user has been using digital services, etc.);
user computer habit information (e.g., beacon information regarding the user's computer habit information. The habits include one or more of key stroke pattern, key stroke pressure, web page navigation trends, use of shift keys, use of shortcuts, experience level with current web site, computer proficiency, frequency of pasting information, frequency of typing out information, frequency and/or use of auto-fill information, typing speed, frequency of type-o's, manner in which type-o's are corrected (fix immediately, wait, delete word and start over, edit word, etc.), etc.);

For information regarding each of the source's computing devices, the fraud detection computing system 16 gathers one of more of the following:
device identification (e.g., device serial number, device age, device service record, operating system(s), browser applications, number and types of CPUs, memory capabilities, device use-sleep patterns (e.g., typically in sleep mode from 8 PM to 6 AM), CPU loading patterns (e.g., typically run light, run heavy, varies), etc.);
device type (e.g., server, computer, laptop, cell phone, tablet, game console, has the device been modified (e.g., indicates a more sophisticated user), is it a stock device, etc.); and
user-device affiliation (e.g., device registration information, account registration information (e.g., was this the device used to set up the account, edit the account, etc.), purchase information (e.g., amount, date, location, etc.), public Wi-Fi use, etc.).

For each network affiliation per computing device of the user, the fraud detection computing system 16 gathers one or more of:
network identifier (e.g., network address, network name, etc.);
network type (e.g., LAN, WLAN, WAN, WWAN, cellular, internet, etc.);
user-network affiliation information (e.g., service provider, account name, username, payment information, age of account, data rate services, internet use tendencies, cell phone use tendencies, type of service, etc.);
device-network affiliation information (e.g., device ID linked to IP address, phone number, etc.); and
media layer information (e.g., physical layer, data link layer, and network layer).

In addition to gathering information regarding the source, destination, and transaction, the fraud detection computing system 16 gathers service provider information that includes one or more of, but is not limited to:
bad actor traits and tendencies (e.g., flooding a system with requests, fake IP addresses, etc.);
bad actor tools (e.g., many hacker tools leave a small digital trace);
bad actor history (e.g., history of fraud attacks on system, current level of fraud of system, etc.);
types of fraud (e.g., account take over, false user information, false payment information, stolen payment information, etc.); and
system behavior anomalies (e.g., use patterns that are outside of the norm, etc.).

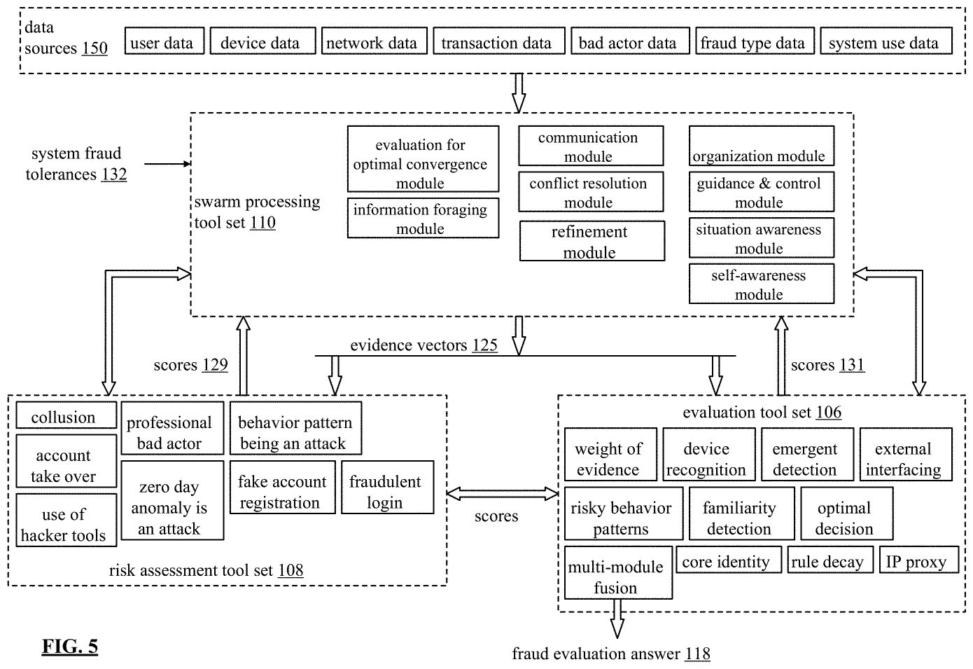

FIG. 5 is a functional block diagram of an embodiment of transactional data and tools of the fraud detection computing system 16 for generating a fraud evaluation answer for a transaction. In this example, the fraud detection computing system 16 processes the data from the data sources 150 via an evaluation tool set (or pool of tools) 106, a risk assessment tool set 108, and a swarm processing tool set 110 to generate the fraud evaluation answer 118. The data obtained from the data sources 150 is as discussed with reference to FIG. 4 and includes one or more of user data, device data, network data, transaction data, bad actor data, fraud type data, and system use data. Note that the delineation of tools into tool sets is for convenience of discussion and any tool may be in a different tool set or may be a stand-alone tool that is not part of a tool set.

The tools (e.g., AI modules, or BOTs) of the evaluation tool set include:
A Core Identity of Individual (ID) AI module that determines who the buyer is, as opposed to who the buyer claims to be. Who is this, actually? Does the system recognize this buyer? Is this the legitimate buyer they claim to be, or is this a bad player to be tracked?
A Familiarity Detection (FD) AI module that determines whether the buyer appear to be familiar with the marketplace? A “new” user should not exhibit extreme familiarity.
A Detecting Risky Behavioral Patterns (RB) AI module that interprets behavioral patterns as indicative of profitable customers, while other behavioral patterns are correlated with revenue loss, with any and everything in between.
A Device Recognition (DR) AI module that determines whether the current buyer's device (web, mobile, etc.) is something the system has seen before? With this buyer?
A Univariate Predictor Variable Computation (weight of evidence—WoE) AI module that transforms categories, counts, determines financial amounts, time-spans, etc. and produces therefrom a calculable risk likelihood, which can be used by other tools as inputs.
An IP-Proxy Piercing (IP) AI module that looks at whether the apparent IP-address of the buyer is not necessarily its real IP-address. The apparent IP-address can be feigned through the use of relay-proxy. This AI module determines whether a proxy is involved in the online interaction with the online buyer, or not. And if a proxy is involved, it determines the geo-location of the real IP-address.
A Rule Decay over Time (RD) AI module that relies on a mixture of machine-learned math models and propositional logic (rules). Some rules are valuable for a long time. That stable logic migrates into the math models with future model updates. Other logic outlives its usefulness and this AI module depreciates the importance of those transient logic patterns over time.
A Detection and Recognition of Emergent Entity (ER) AI module that detects new phenomena, both good and bad, emerge over time (from time to time). This AI module is an acronym for Entity Recognition and detects the appearance of newly emergent phenomena and forms formal entities around them.
A system and method for Multi-Model Fusion (MMF) AI module that integrates multiple opinions, based on historical accuracy in context. The risk assessment tools are differentially accurate under a variety of circumstances termed context. This AI module compares different opinions from different risk assessment tools and determines how much credibility should be given to those various opinions, based on current context, and then resolves to a single opinion based on fusion mathematics.
A Making the Optimal Decision (DS) AI module that attempts to make the best decision between the range of decision choices available, given a system's accurate profiles & transaction (TXN) risk score, with differential bias in favor of the goals of the enterprise.
An Interfacing with external service providers (AS) AI module that brokers and integrates with outside data source service providers, flexibly and dynamically. This AI module includes a single generic launcher, controller, and interface for simplifying the management of multiple service providers.
The tools (e.g., AI modules, or BOTs) of the risk assessment tool set include:
A Recognizing Account Takeover (ATO-RB) AI module that estimates the likelihood that the current buyer is not the legitimate account holder they claim to be.
A Detecting Fake Account Registration (REG-RB) AI module that estimates the likelihood that the current registration attempt in progress is creating a fake account.
An Advanced AI module that detects the presence or likely presence of extremely skilled Fraud criminals. Highly skilled bad actors are often well-organized individuals or gangs or groups with access to the best deception technology available from the Dark Web marketplaces.
A Collusion (Buyer-Seller & Multi-Buyer) (COL) AI module that estimates the likelihood that the buyer is fake, and is colluding with possibly one or more other fake or real buyers and/or fake secondary market sellers as confederates.
A Detecting and Evaluating Anomalous Behavioral Patterns (ZD) AI module, where ZD is an acronym for zero-day exploit, a new exploit or attack vector that has never been seen before today. Machine-learned models rely on actuarial or historical data. Such systems are vulnerable to ZD exploits because, by definition, examples do not exist in the historical data. This AI module compares dynamically observed patterns to “normal” patterns. Within a degree of tolerance, misfits are determined to be anomalous. Some anomalies, good anomalies are due to new legitimate behavioral trends in the good customer population. Those are good to know about. Some anomalies are operational, due to some change in hardware or software that is having unexpected side-effects. Those are also good to know about. And some anomalies, bad anomalies, are due to innovative changes on the part of fraud buyers in their ongoing attempt to defeat fraud defenses. Those are really good to know about if one wants to stop or minimize fraud loss sooner rather than later. This AI module alerts on significant change, and classifies the change in terms of the three outcomes just mentioned.
A Detecting and Evaluating Risky Behavioral Patterns (RB) AI module that detects behavioral patterns that are correlated with risk of TXN fraud such as Web Site Traversal Patterns (Path Analytic, Temporal Analytic) or Gift-Card Selection Behavior, etc.
A Detecting Fraudulent Login Attempts (LOGIN) AI Module that estimates the likelihood that the buyer is faking credentials, attempting to fraudulently login as a legitimate account holder, by using stolen email and password information (credential stuffing).
A Detecting and Recognizing Signs of Hacker-Tool use (HTR) AI module, where HTR is an acronym for Hacker Tool Recognition. This AI module estimates the likelihood that the buy attempt is being controlled by, or that the attempt was wholly or partially crafted with the help of Hacker Tools available on the Dark Web marketplace. Hacker Tools all leave a fingerprint, like the striations on a spent bullet from a gun barrel.

The tools (e.g., AI modules, or BOTs) of the swarm processing tool set, perform the administrative functions of the system 16, include:
A Squad Organization AI module that provides for static structure and allows for or constrains dynamic structure emergence to keep a team organized and effective.
A Communication AI module that enable Bot2Bot communication, BotNet2Outside communication, and communication within the system 16.
A Guidance & Control AI module to guide, assist, and/or control many of the valuable abilities of an emerging swarming community. The variable abilities are not declaratively pre-specified and thus, at times, the model created by the system 16 needs a degree of guidance and control in order to align with domain-specific goals. This AI module ensures that the resulting outcomes align with policy, initiatives, and needs (i.e., the system fraud tolerances).
A Conflict Resolution (B2B, B2Self, B2C) AI module that resolves what is the best path forward when two or more trusted subsystems (e.g., a group of AI modules) are in conflict. This AI module also resolves conflict between two or more AI modules, between AI modules and Control AI modules, and also resolves internal logic inconsistencies, contradictory within a single AI module.
A Situation Awareness AI module that, at any given moment, the system 16 needs to know what is happening in its operational environment. In an adversarial domain, it is importance to know, for instance, that the system is under attack. This AI module dispels the fog of war through accurate situation assessment (situation awareness).
A Swarming AI module, where swarming is an emergent behavior that needs to not only converge but to converge on an optimal solution. This AI module monitors the results of dynamic swarming to determine the value of the swarmed solutions, and enhance accordingly.
A Data Foraging AI module that, when the best direction for optimal performance is not entirely obvious, this AI module engages in exploratory foraging behavior to find new paths to success.
A Self-Awareness AI module, where AI modules need to have a clear understanding of their own state, their own state changes, their own dynamics, and their own performance. This AI module helps other AI modules that make up the cooperative community, to understand themselves in such a way that they can change their performance for the better.

The organization AI module processes the data from the data sources to provide evidence vectors for the AI modules (e.g., tools) of the other tool sets. The organization module creates a unique evidence vector for each tool that generates a score. For example, the organization module creates a unique evidence vector for each of at least some of:
The Core Identity of Individual (ID) AI module;
The Familiarity Detection (FD) AI module;
The Detecting Risky Behavioral Patterns (RB) AI module;
The Device Recognition (DR) AI module;
The Univariate Predictor Variable Computation (weight of evidence—WoE) AI module;
The IP-Proxy Piercing (IP) AI module;
The Rule Decay over Time (RD) AI module;
the Detection and Recognition of Emergent Entity (ER) AI module;
The Recognizing Account Takeover (ATO-RB) AI module;
The Detecting Fake Account Registration (REG-RB) AI module;
The Advanced AI module;
The Collusion AI module;
The Detecting and Evaluating Anomalous Behavioral Patterns (ZD) AI module;
The Detecting and Evaluating Risky Behavioral Patterns (RB) AI module;
The Detecting Fraudulent Login Attempts (LOGIN) AI Module; and
The Detecting and Recognizing Signs of Hacker-Tool use (HTR) AI module.

As a specific example, the organization module generates an evidence vector 125 for the core identity AI module. This evidence vector includes information that enables the core identity AI module to determine who the buyer is, as opposed to who the buyer claims to be. Who is this, actually? Does the system recognize this buyer? Is this the legitimate buyer they claim to be, or is this a bad player to be tracked? As such, evidence vector includes user information, account information, device information, user history information, and other data as the organization module deems important.

Each AI module that receives an evidence vector generates a score 129 or 131 therefrom. In an example, the scores range from −1 to +1, where −1 is representative of a high likelihood of fraud; +1 is representative of a low likelihood of fraud; and 0 is representative of “don't know”. A “don't know” answer typically results when there is insufficient data to produce a score and/or when a bad actor has manipulated data to create a don't know answer for one or more of the tools (e.g., bots).

The fraud detection computing system 16, typically via the organization module, evaluates the scores from the other modules in a multi-layered manner. In a first layer, the organization module reviews the individual scores of the modules in light of the current transaction, where each module is looking at the transaction from its individual perspective (e.g., legit-account abuse (promo abuse), legit-account takeover (ATO), ransomware, collusion, money-laundering, created-account-fraud, friendly-family fraud, login-evidence, registration-evidence).

As a specific example, when a module returns a score near “1”, the module has a high degree of confidence that, from its perspective (e.g., account take over), the transaction is not fraudulent. As another specific example, when a module returns a score near “−1”, the module has a high degree of confidence that, from its perspective (e.g., account abuse), the transaction is fraudulent. As yet another specific example, when a module returns a score near “0”, the module has no degree of confidence whether, from its perspective (e.g., create account fraud), is fraudulent or not.

As a next level of review, the fraud detection computing system employs one or more of the organization module, the optimal decision module, the weight of evidence module, the organization module, and the multi-mode module to generate an initial fraud evaluation answer. In the next level of review, the module(s) interpret the scores from the other modules, including the score near zero, in light of previous transaction data to produce an initial fraud evaluation score. For example, the scores for the current transaction are evaluated in light of previous transaction data of the transaction source, of the transaction destination, and/or of the transaction subject matter. The module(s) process the initial fraud evaluation score to produce an initial fraud evaluation answer of “accept”, “reject”, or “further review”. As a specific example, if the initial fraud evaluation score is 0.75 and the fraud tolerance is 0.72, then the initial fraud evaluation answer accepts the transaction.

As another specific example, if the initial fraud evaluation score is −0.75 and the fraud tolerance 132 is −0.72, then the initial fraud evaluation answer is “reject the transaction”. As yet another specific example, if the initial fraud evaluation score is greater than −0.72 and less than 0.72, then the initial fraud evaluation answer is “further review”.

FIG. 6 is a logic diagram of an example of a method executed by a computing entity of the fraud detection computing system for generating a fraud evaluation answer for a transaction. As used herein, a computing entity includes one or more of a processing core of a computing device, a computing device, a plurality of computing device, and a plurality of cloud-based processing resources (e.g., processing cores, memory, co-processing, etc.). The method begins at step 160 where the computing entity receives a transaction for fraud evaluation. The transaction is between a first computing device (e.g., a source device) of the data transactional network and a second computing device (e.g., a destination device) of the data transactional network regarding transactional subject matter (e.g., a digital service).

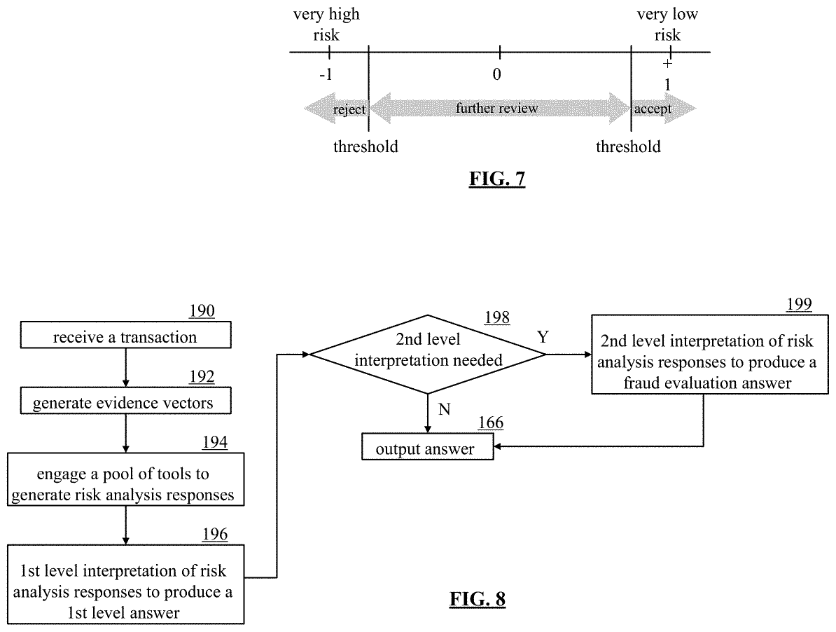

The method continues at step 162 where the computing entity sets up and executes an initial fraud evaluation model to produce an initial fraud evaluation answer. The initial fraud evaluation answer is low risk of fraud (e.g., accept), high risk of fraud (e.g., reject), or further analysis is required (e.g., further review). The setting up and executing the initial fraud evaluation module will be discussed in greater detail with at least reference to FIG. 8. Note that fraud evaluation answer and fraud evaluation answer mean substantially the same thing.

The method continues at step 164 where the computing entity determines whether the initial fraud evaluation answer is “further analysis”. When the initial fraud evaluation answer is not further analysis, the method continues to step 166, where the fraud detection computing system outputs the initial fraud evaluation answer (e.g., accept or reject) as the fraud evaluation answer.

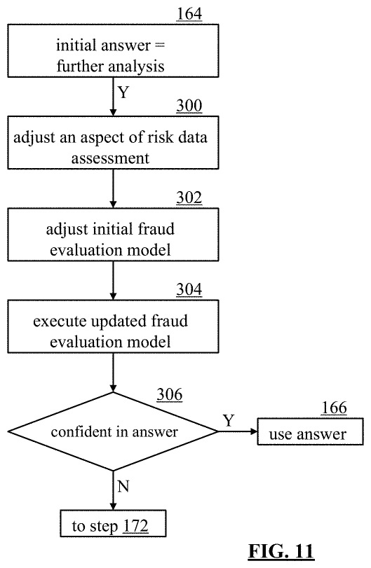

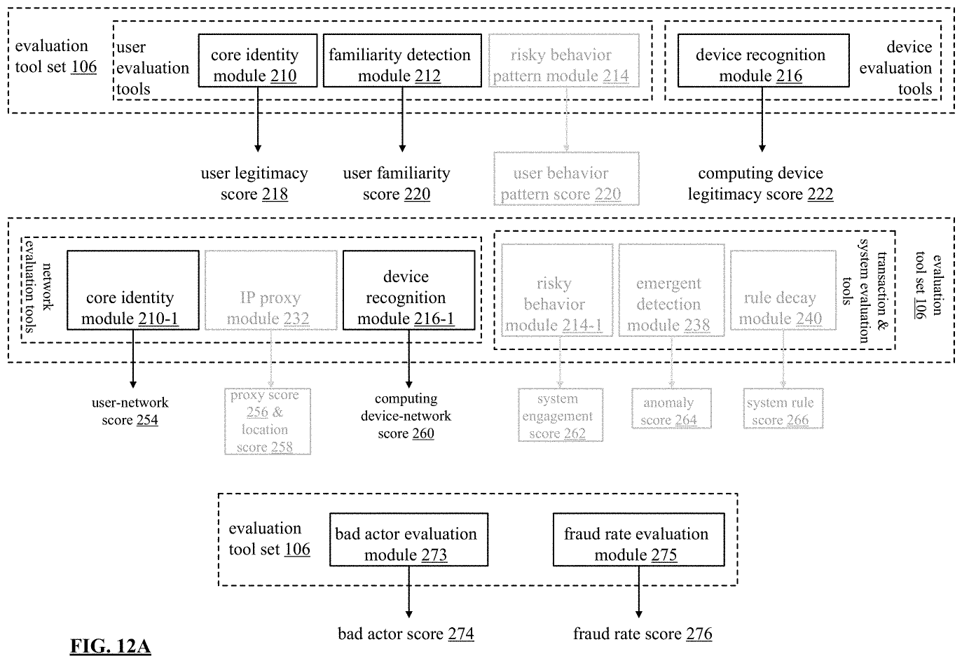

When the initial fraud evaluation answer is that further analysis is required, the method continues at step 168 where the computing entity executes a swarm process model to generate an updated fraud evaluation answer. The execution of the swarm process model will be described in greater detail with reference to at least FIG. 11. The method continues at step 170 where the computing entity determines whether the updated assessment answer is reliable.

The reliability of the updated assessment answer may be determined in a variety of ways. For example, the computing entity establishes a confidence factor for the updated fraud evaluation answer (e.g., a score of the fraud evaluation module, where the closer to 0 the answer is, the less confidence it is correct; the closer the score is to −1 or to +1, the higher the confidence factor). The computing entity then compares the confidence factor with a confidence threshold (which is based on the system fraud tolerances). When the confidence factor compares favorably with the confidence threshold, the computing entity indicates that the updated fraud evaluation answer is reliable. When the updated fraud evaluation answer is reliable, the method continues at step 166, where the answer is used.

When the updated assessment answer is unreliable, the method continues at step 172 where the computing entity determines whether the updated fraud evaluation answer is a divergent answer. The computing entity determines whether the answer is divergent by interpreting answers of tools of the swarm process model to form a first group of answers that favor a low-risk answer and a second group of answers that favor a high-risk answer. When the two groups exist, indicating, by the computing entity, that the updated fraud evaluation answer is a divergent answer. If only one group exists, then the answer is not divergent.

When the updated assessment answer is unreliable and when the updated fraud evaluation answer is not a divergent answer, the method continues to step 180 where the computing entity generates an answer of agent review and queues the transaction for agent review. When the updated fraud evaluation answer is a divergent answer, the method continues at step 174 where the computing entity executes a conflict resolution model to generate a single answer at step 176.

In an embodiment, the executing of the conflict resolution model includes determining whether the swarm process model is optimal for the transaction. This may be done in a variety of ways. For example, the swarm processing model is initially deemed to be optimal. As another example, the swarm processing module is initially deemed to be non-optimal. As yet another example, the level of divergence in light of the system fraud tolerances is used to determine whether the swarm processing module is optimal or not.

In some embodiments, whether a decision is considered optimal can be determined on the basis of a type of decision errors. Types of decision errors include false positives, false negatives, and recommending human agent review. For example, if an organization relies on small margin, high volume transactions, and customer retention would be adversely affected by a large number of transactions that were erroneously classified as fraudulent, that organization may consider false positives errors to be less optimal than false negative errors. Conversely, if another organization evaluates fewer transactions having very high value, such that false positives may be more acceptable, and that organization might consider false negative errors to less damaging than false positive errors. If speed of transaction approval is the biggest concern for an organization, then delays caused by predictions recommending human agent review might be considered less optimal either false positives or false negatives.

When the swarm process model is optimal, the computing entity identifies a first set of tools of the swarm process model that generated the first group of answers and identifies a second set of tools of the swarm process model that generated the second group of answers. The computing entity then adjusts a weight factor of a first set of weight factors (e.g., relating to integrity of input data, tool being used, integrity of response, use different data, use different parameters, etc.) associated with the first set of tools or of a second set of weight factors associated with the second set of tools. The computing entity determines the type and amount of adjustment in light of the system fraud tolerances and current system activities (e.g., percentage of current fraud activities) to produce an adjusted weight factor. The computing entity then executes the swarm process model using the adjusted weight factor to generate the reliable fraud evaluation answer.

The method continues at step 178 where the computing entity determines whether the updated fraud evaluation answer compares favorably to a threshold. When it does, the answer is used at step 166. When the answer compares unfavorably to the threshold, the method continues at step 180 where the transaction is queued for agent review.

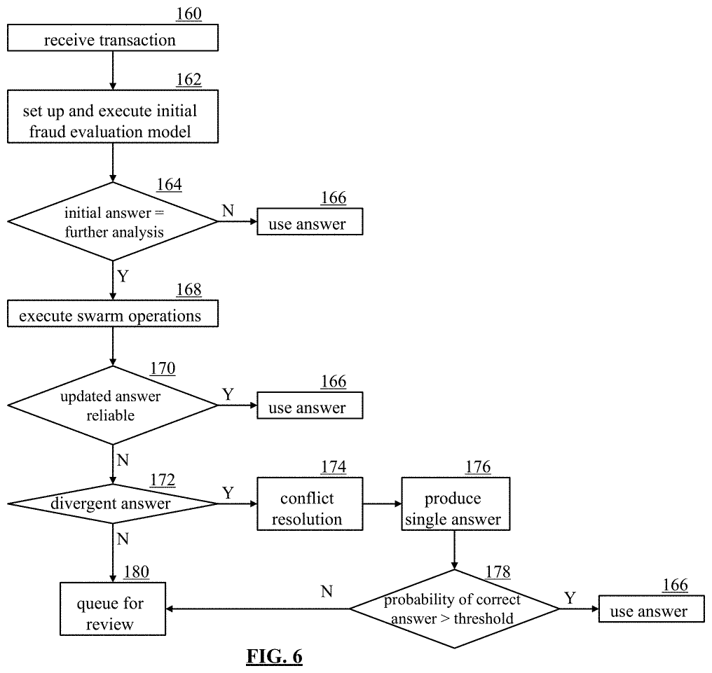

FIG. 7 is a functional diagram of an example of a fraud evaluation answer that ranges from −1 to +1. The example further includes thresholds for a high risk of fraud answer and a low risk of fraud answer. The thresholds are set based on the system fraud tolerances and may be uneven. For example, a high threshold is set for rejecting a transaction based on the likelihood of it be fraudulent. As another example, a lower threshold is use for accepting a transaction based on the likelihood of it not being fraudulent. A score in the middle equates to a further review answer. Note that any scale may be used for the answer range.

FIG. 8 is a logic diagram of an example of a method executed by a computing entity of a fraud detection computing system for generating an initial fraud evaluation answer for a transaction, which corresponds to step 162 of FIG. 6. This method begins at step 190 where the computing entity receives a transaction for fraud evaluation. The transaction is between a first computing device (e.g., a source) and a second computing device (e.g., a destination) regarding transactional subject matter (e.g., a digital service) that is transmitted via the data transaction network. In addition, the computing entity receives data from data sources 120 and/or from the user information database 18.

The method continues at step 192 where the computing entity generates evidence vectors regarding the transaction. As an example, an evidence vector is a piece of information regarding a topic, or portion of a topic, from a list of topics. The list includes:
user information regarding a user associated with the first computing device;
information regarding the first computing device;
information regarding network affiliations of the user;
anomaly information regarding one or more of the first computing device, the second computing device, and the data transaction network; and
information regarding network affiliations of the first computing device.

As another example, a second evidence vector is a second piece of information regarding one of:
second user information regarding a second user associated with the second computing device;
information regarding the second computing device;
information regarding network affiliations of the second user; and
information regarding network affiliations of the second computing device.

The method continues at step 194 where the computing entity engages tools (e.g., AI modules) to generate risk analysis responses based on the evidence vectors. The tools are selected from a variety of sets of tools that include a set of risk assessment tools, a set of evidentiary tools, and a set of swarm processing tools.

The method continues at step 196 where the computing entity performs a first level interpretation of the risk analysis responses from the pool of tools to produce a first level answer. The method continues at step 198 where the computing entity determines whether a second level interpretation is needed. For example, when the individual scores of the tools all have a high confidence factor (e.g., compare favorably to the system fraud tolerances), a second level interpretation is not needed, but still may be performed to add to the confidence of the analysis. As another example, when the individual scores include indeterminate scores (e.g., near zero), include scores that don't compare favorably to the system fraud tolerances, and/or are conflicting (e.g., one score has a high confidence factor of fraud and a second score has a high confidence factor of non-fraud), then the second level interpretation is needed. If the second level interpretation is not needed, then the answer is outputted at step 166.

When the second level of interpretation is needed, the method continues at step 199 where the computing entity performs the second level interpretation. For example, the computing entity interpret the scores, including the score near zero, in light of previous transaction data to produce an initial fraud evaluation score. For example, the scores for the current transaction are evaluated in light of previous transaction data of the transaction source, of the transaction destination, and/or of the transaction subject matter. The computing entity processes the initial fraud evaluation score to produce an initial fraud evaluation answer of “accept”, “reject”, or “further review”, which is outputted at step 166.

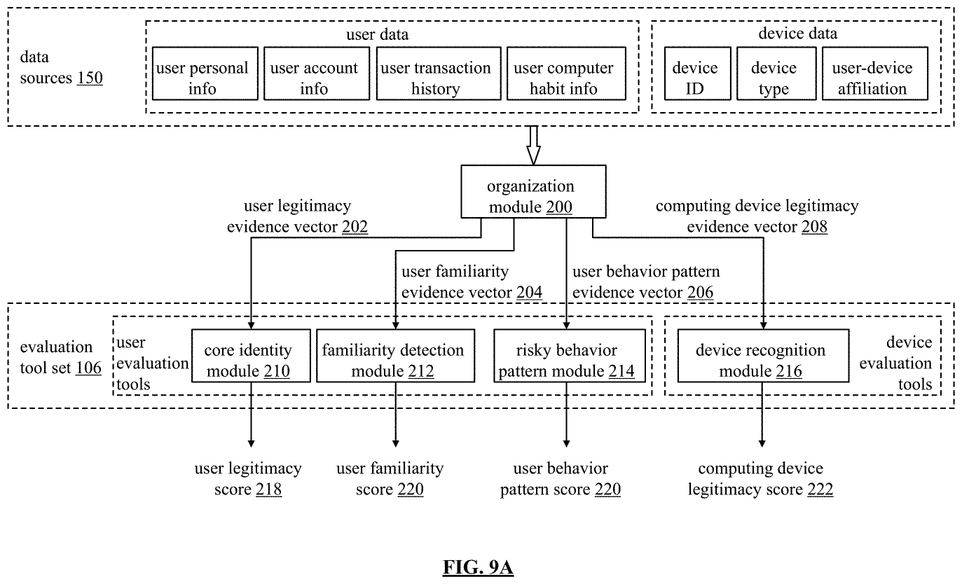

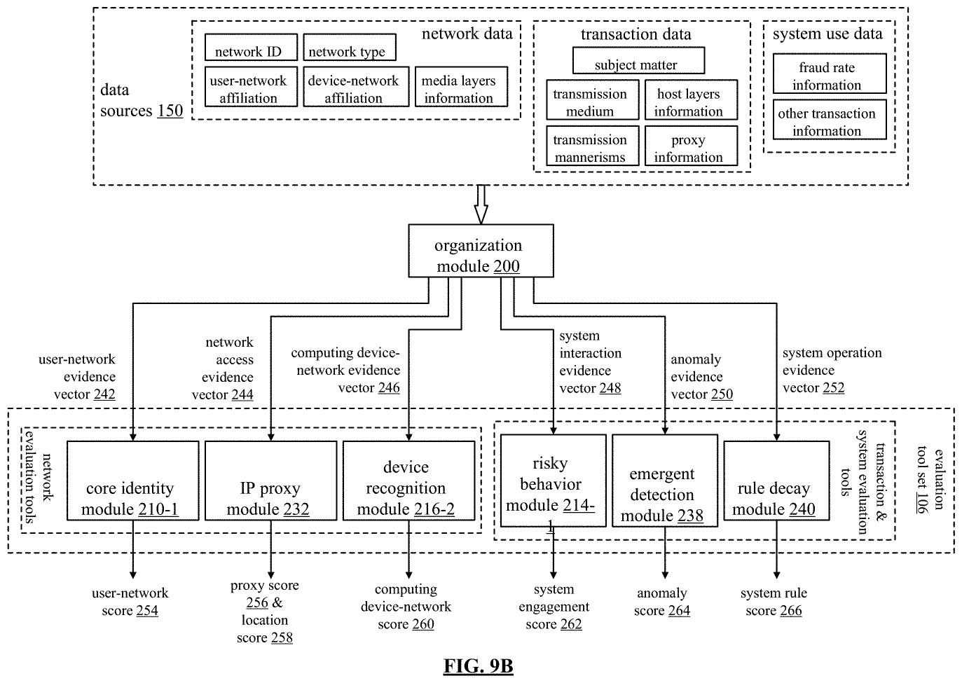

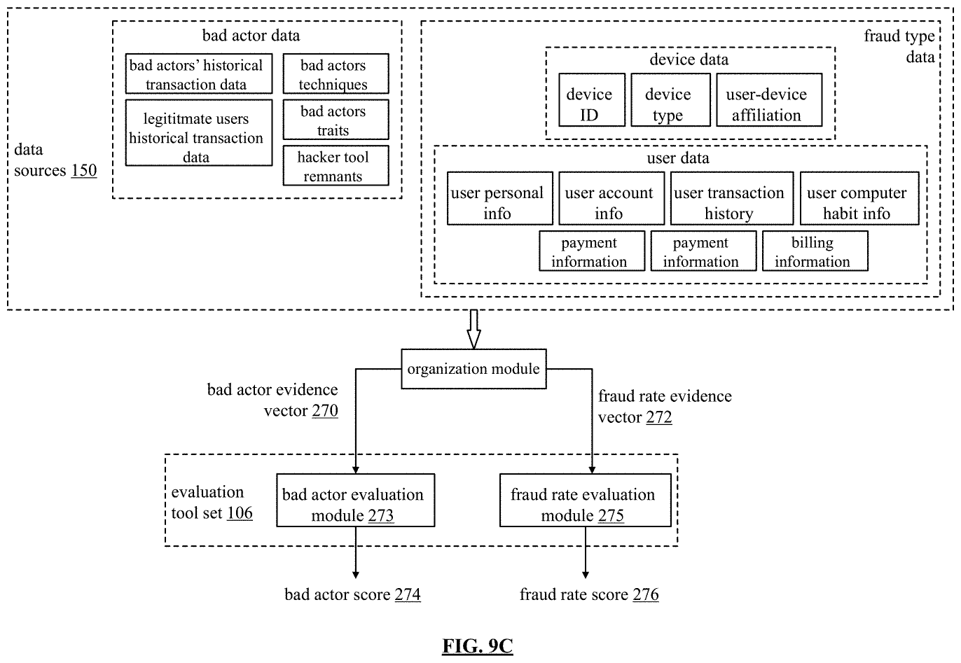

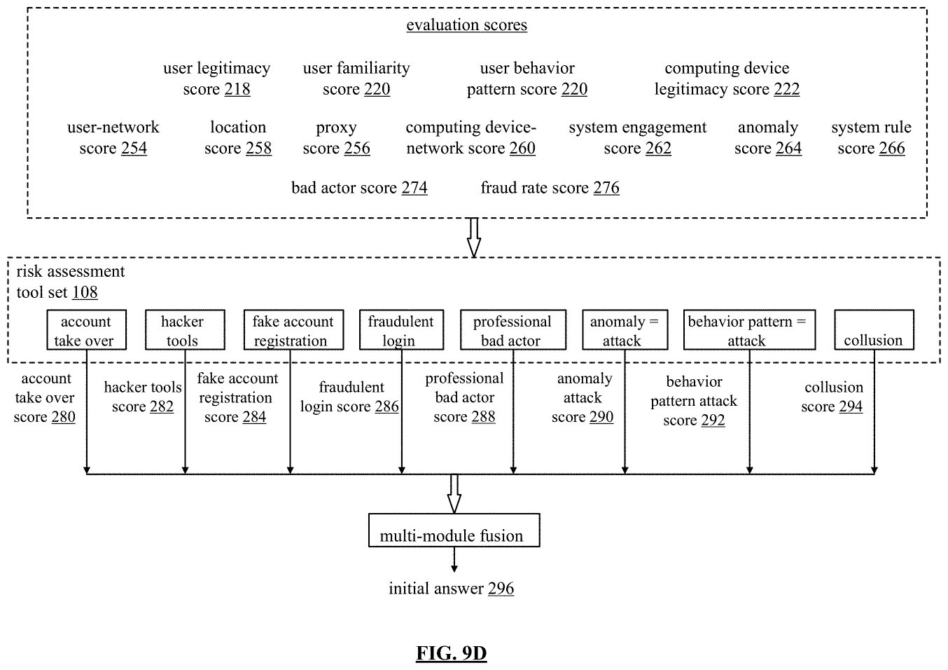

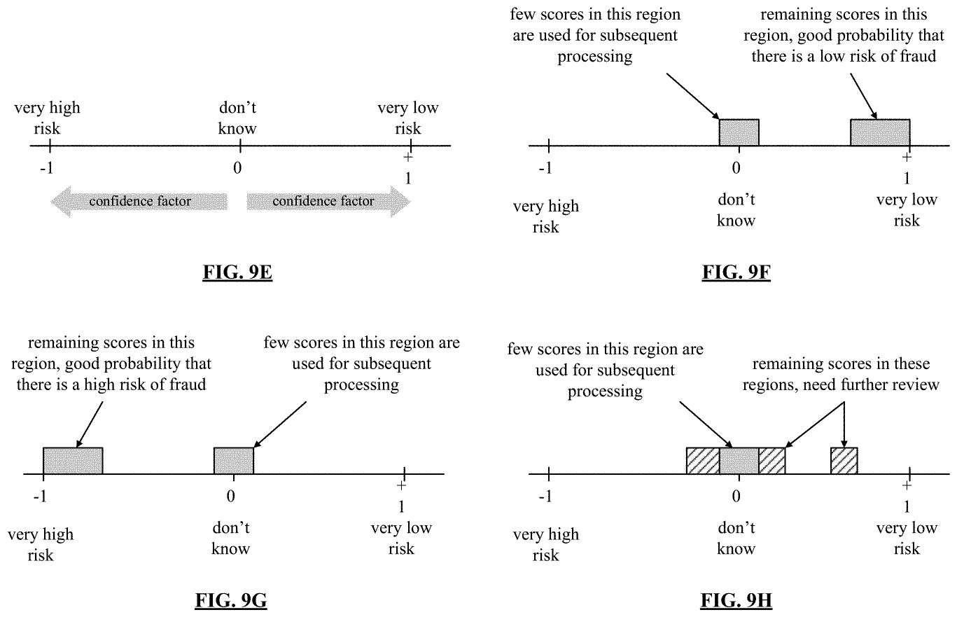

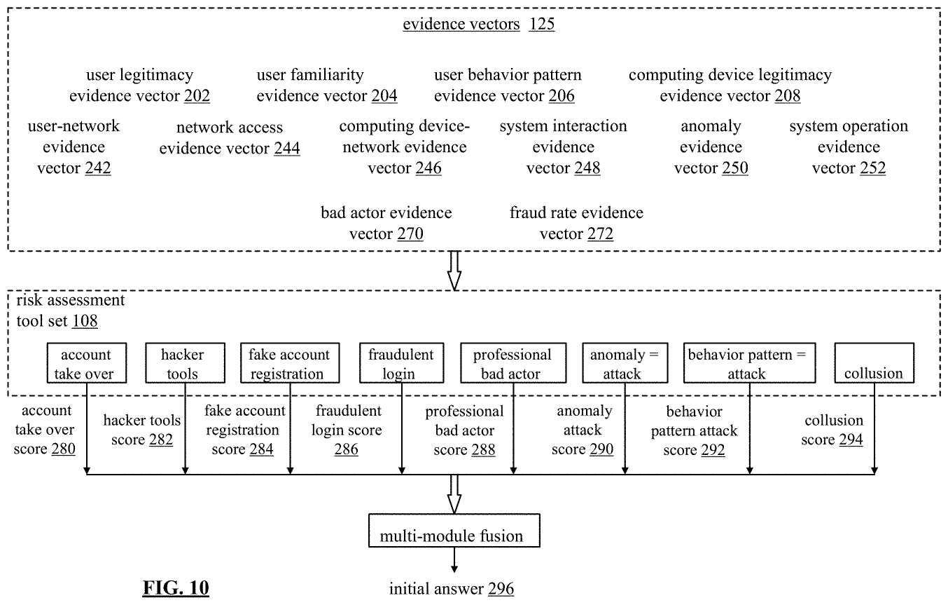

FIGS. 9A-9H are functional block diagrams of an example of generating a fraud evaluation answer for a transaction of by a fraud detection computing system. FIG. 9A illustrates an organization module 200 (e.g., a swarm processing tool) receiving user data and device data from data sources 150 and creating evidence vectors 202-208 therefrom. In this example, the user data includes user personal information, user account information regarding one or more services provided via the data transactional network, user transaction history, and/or user computer habit information as previously defined. The device data includes device information, device type, and/or user-device affiliation information as previously defined. Note that the data gathered is per user and per device.

During an initial analysis, the fraud detection computing system 16 engages some, if not all, of the evaluation tools and/or risk assessment tools to obtain initial responses from the tools and create an initial fraud evaluation answer therefrom. In this example, the core identity module 210, the familiarity detection module 212, the risky behavior pattern module 214, and the device recognition module 216 are engaged. Accordingly, the organization module 200 generates a user legitimacy evidence vector 202 for the core identity module 210; a user familiarity evidence vector 204 for the familiarity detection module 212; a user behavior pattern evidence vector 206 for the risky behavior pattern module 214, and a computing device legitimacy evidence vector 208 for the device recognition module 216.

Each of the modules 210-216 process their corresponding evidence vectors 202-208 to detect a hint of an abnormality that might be suggestive of fraud (e.g., a bad actor impersonating a good actor or an actor doing a bad thing). For example, the core identity module 210 determines a user legitimacy score 218 as to whether there are any abnormalities with the user's information and the manner which the user logged in. As another example, the familiarity detection module 212 determines a user familiarity score 220 as to whether the exhibited navigation skills of the destinations website to initiate the transactions is commensurate with the user's level of familiarity with the web site (e.g., a new user should take more time to get to where he/she wants to go in comparison to a more familiar user).

As yet another example, the risky behavior pattern module determines a user behavior pattern score 220 as to whether the exhibited interaction between the user and his/her computing device is different than expected for this user (e.g., different typing speed, different level of type-o's, different use of cut and paste, etc.). As a further example, the device recognition module 216 determines a computing device legitimacy score 222 as to whether this is a device that has interacted with the system before and that it has been typically affiliated with a known valid user.

FIG. 9B illustrates the organization module 200 receiving network data, transaction data, and system use data from data sources 150 and creating evidence vectors 242-252 therefrom. In this example, the network data includes (per user, per device, and/or per network) a network identifier, network type, user-network affiliation information, device-network affiliation information, and/or media layer information as previously defined. The transaction data includes, per transaction, information regarding the transactional subject matter, transmission medium information regarding transmission of a request for the transaction from the first computing device to the second computing device, host layer information, and/or proxy information as previously defined. The system use data includes fraud rate information (e.g., historical and current) and information regarding other transactions of the system (e.g., both fraudulent and non-fraudulent transactions).

In this example, the core identity module 210-1, the IP module 232, the device recognition module 216-1, the risky behavior pattern module 214-1, the emergent detection module 238, and the rule decay module 240 and are engaged. Accordingly, the organization module 200 generates a user-network evidence vector 242 for the core identity module 210-1; a network access evidence vector 244 for the IP proxy module 232; a computing device-network evidence vector 246 for the device recognition module 216-1, a system interaction evidence vector 248 for the risky behavior module 214-1, an anomaly evidence vector 250 for the emergent detection module 238, and a system operation evidence vector 252 for the rule decay module 240.

Each of the modules 210-1, 232, 216-1, 214-1, 238, and 240 process their corresponding evidence vectors 242-252 to detect a hint of an abnormality that might be suggestive of fraud (e.g., a bad actor impersonating a good actor or an actor doing a bad thing). For example, the core identity module 210-1 (e.g., a different module or an extension of the core identity module 210) determines a user-network score 254 as to whether there are any abnormalities with the user's network information and/or the manner in which the user used the network to access the destination of the transaction. As another example, the IP proxy module 212 determines a proxy score 256 and/or a location score as to whether the user, via its computing device, used an IP proxy and, if so, determines the true location of the user's computing device.

As yet another example, the device recognition module 216-1 (e.g., a different module or an extension of the device recognition module 216) determines a computing device-network score 260 as to whether this is a device-network interaction and/or network access to the system is consistent with prior device-network interactions and/or network access to the system for the user and its computing device. As a further example, the risky behavior pattern module 214-1 (e.g., an extension of module 214 or a different module) determines a system engagement score 262 as to whether the exhibited interaction between the user and the system is different than expected for this user (e.g., transaction subject matter, different quantities for an order, different price points, etc.).

As a still further example, the emergent detection module 238 determines an anomaly score 264 as to whether deviations from normal use of the system are indicative of a fraudulent attack. As an even further example, the rule decay module 240 determines a system rule score 266, per rule or for a group of rules, regarding the decaying value, accuracy, and/or usefulness of the rule.

FIG. 9C illustrates the organization module 200 receiving bad actor data and fraud type data from data sources 150 and creating evidence vectors 270 and 272 therefrom. In this example, the bad actor data includes bad actors' historical transaction data, legitimate users' transactional data, bad actor techniques, bad actor traits, and hacker tool remnants, as previously defined. The fraud type data includes data regarding account take over, fake account information, fraudulent login, fraud attempt rate, and/or multiple user collusion, which can be ascertained from device data and/or user data.

In this example, the bad actor evaluation module 273 and the fraud rate module 275 and are engaged. Accordingly, the organization module 200 generates a bad actor evidence vector 270 for the bad actor evaluation module 273 and a fraud rate evidence vector 252 for the rule decay module 240.

The bad actor evaluation module 273 determines a bad actor score 274 as to whether there are indications that the user may not be the actual user. As another example, the fraud rate module 275 determines a fraud rate score 256 as to rate of fraud currently active in the system, rate of fraud in the past, rate of fraud surrounding this source, rate of fraud surrounding this destination, rate of fraud regarding the digital service of the transaction.

FIG. 9D illustrates the risk assessment tools 108 generating risk scores 280-294 from the evaluation scores 218-222, 254-266, 274, and 276. For example, the account take over risk module interprets one or more of the user legitimacy score 218, the user familiarity score 220, the user behavior pattern score 220, the computing device legitimacy score 222, the user-network score 254, the computing device-network score 260, and the system rule score 266 to render an account take over score 280. As another example, the hacker tool risk module interprets one or more of the user legitimacy score 218, the user familiarity score 220, the user behavior pattern score 220, the computing device legitimacy score 222, the user-network score 254, the proxy score 256, the location score 258, the computing device-network score 260, and the system rule score 266 to render a hacker tools score 282.

As another example, the fake account risk module interprets one or more of the user legitimacy score 218, the user familiarity score 220, the computing device legitimacy score 222, the user-network score 254, the proxy score 256, the location score 258, and the system rule score 266 to render a fake account registration score 284. As a further example, the fraudulent login risk module interprets one or more of the user legitimacy score 218, the user familiarity score 220, the computing device legitimacy score 222, the user-network score 254, the proxy score 256, the location score 258, the computing device-network score 260, and the system rule score 266 to render a fraudulent login score 286.

As a still further example, the professional bad actor risk module interprets one or more of the user legitimacy score 218, the user familiarity score 220, the user behavior pattern score 220, the computing device legitimacy score 222, the user-network score 254, the proxy score 256, the location score 258, the computing device-network score 260, the system engagement score 262, the anomaly score 264, and the system rule score 266 to render a professional bad actor score 288. As an even further example, the anomaly attack risk module interprets one or more of the system engagement score 262, the anomaly score 264, and the system rule score 266 to render an anomaly attack score 290.

As yet another example, the behavior pattern risk module interprets one or more of the user familiarity score 220, the user behavior pattern score 220, the computing device legitimacy score 222, the proxy score 256, the location score 258, the system engagement score 262, the anomaly score 264, and the system rule score 266 to render a behavior attack score 292. As yet another example, the collusion risk module interprets one or more of the user legitimacy score 218, the user familiarity score 220, the user behavior pattern score 220, the computing device legitimacy score 222, the user-network score 254, the proxy score 256, the location score 258, the computing device-network score 260, the system engagement score 262, the anomaly score 264, and the system rule score 266 to render a collusion score 294. The multi-module fusion interprets the risk scores 280-294 to render an initial fraud evaluation answer 296.

FIG. 9E illustrates an example of processing an evaluation score and/or a risk score. In this example, the score ranges from −1 to +1, where −1 is indicative of a very high risk of fraud and a +1 is indicative of a very low risk of fraud. A score near 0 is indicative of “don't know” answer due to insufficient data, no data, or potentially fraudulent data to evaluation. For the scores that are near zero, they are used in the second level interpretation of the scores and may or may not be used in the first level interpretation of the scores.

FIG. 9F illustrates an example of scores being grouped in two areas: some around 0 and some around +1. The scores around zero, are used in the second level interpretation and the scores around +1 are used in both the first and second levels to render the initial fraud analysis answer. In this example, the answer would be low risk of fraud, or accept the transaction assuming the scores near zero are based on no data or insufficient data and not based on fraudulent data.

FIG. 9G illustrates an example of scores being grouped in two areas: some around 0 and some around −1. The scores around zero, are used in the second level interpretation and the scores around +1 are used in both the first and second levels to render the initial fraud analysis answer. In this example, the answer would be high risk of fraud, or reject the transaction regardless of whether the scores near zero are based on no data, insufficient data, or fraudulent data.

FIG. 9H illustrates an example of scores being grouped in four areas: some around zero, some in the low negative range, some in the low positive range, and some in the higher positive range but less than +1. The scores around zero, are used in the second level interpretation and the remaining scores are used in both levels to render the initial fraud analysis answer. In this example, there is no clear indication of fraud and no clear indication that there is no fraud. As such, the answer would be further analysis is required.

FIG. 10 is a functional block diagram of another example of generating an initial fraud evaluation answer for a transaction of by a fraud detection computing 16. In this example, the evidence vectors are provided directly to the risk assessment tools 108. In comparison with FIGS. 9A-9H, the evaluation tools are skipped, their functionality is integrated into the risk assessment tools, or their functionality is implemented by the organization module and accounted for in the evidence vectors.

FIG. 11 is a logic diagram of a further example of a method executed by a computing entity of a fraud detection computing system for updating an initial fraud evaluation answer, which corresponds to step 168 of FIG. 6. The method begins at step 164 where the computing entity determines that an initial fraud evaluation model did not produce a reliable fraud evaluation answer as evidenced by the initial answer being “further analysis”.

The method continues at step 300 wherein the computing entity adjusts an aspect of risk assessment data, the evaluation data, and/or of the initial fraud evaluation model. This may be done in a variety of ways. For example, the parameters of an evaluation tool or a risk assessment tool are adjusted to “loosen” or “tighten” its respective functionality, where loosen refers to being less stringent in analysis and tighten refers to being more stringent in analysis. As another example, data is added to or subtracted from an evidence vector. As a further example, scores from some evaluation tools as used as additional inputs to other evaluation tools. As a still further example, weighting of scores is changed. As an even further example, new tools are created and/or tools are modified.

The method continues at step 302 where the computing entity adjusts the initial fraud evaluation model based on the adjusted aspect of the risk assessment data to produce an updated fraud evaluation model. The method continues at step 304 where the computing entity executes the updated fraud evaluation model to produce an updated fraud evaluation answer and a corresponding confidence level.

The method continues at step 306 where the computing entity compares the confidence level with a confidence threshold. If the confidence level compares favorably with the confidence threshold, the method continues at step 166 where the answer is outputted. If, however, the confidence level compares unfavorably with the confidence threshold, the method continues at step 172 of FIG. 6.

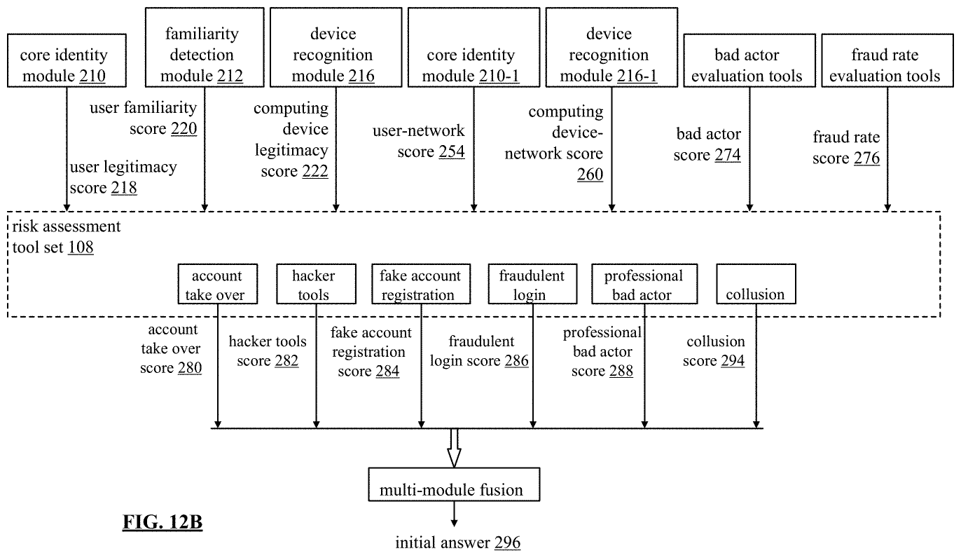

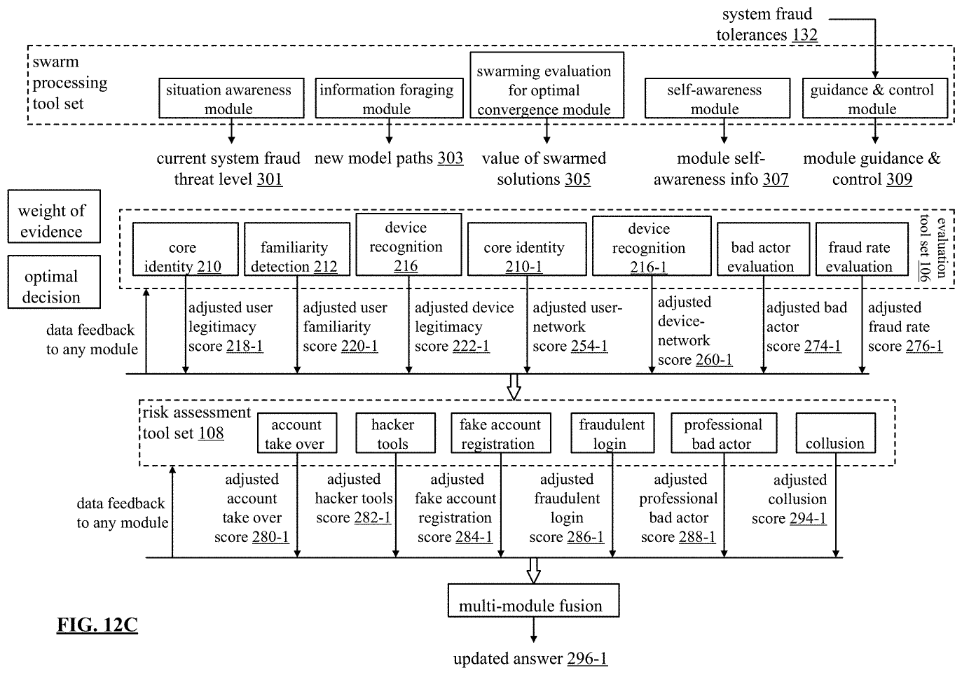

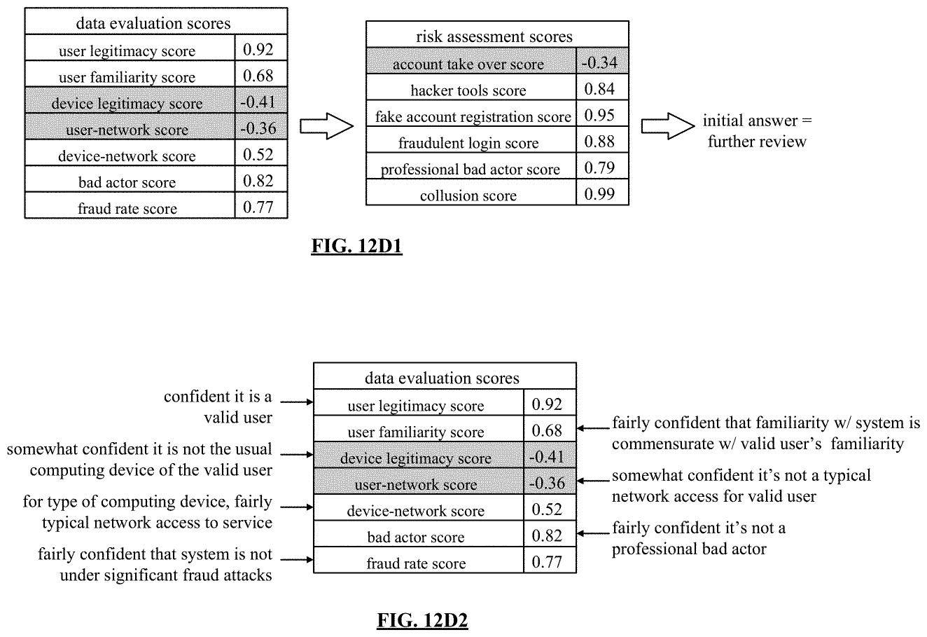

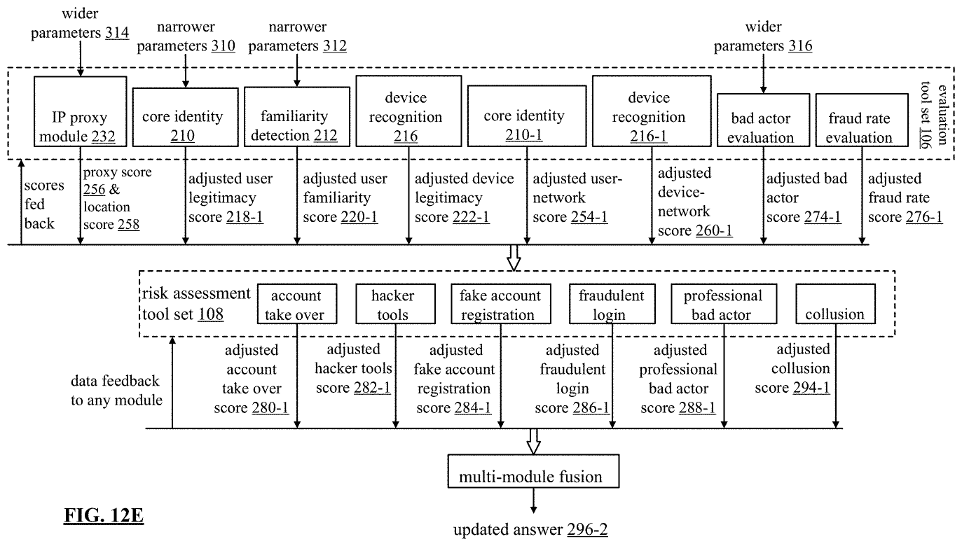

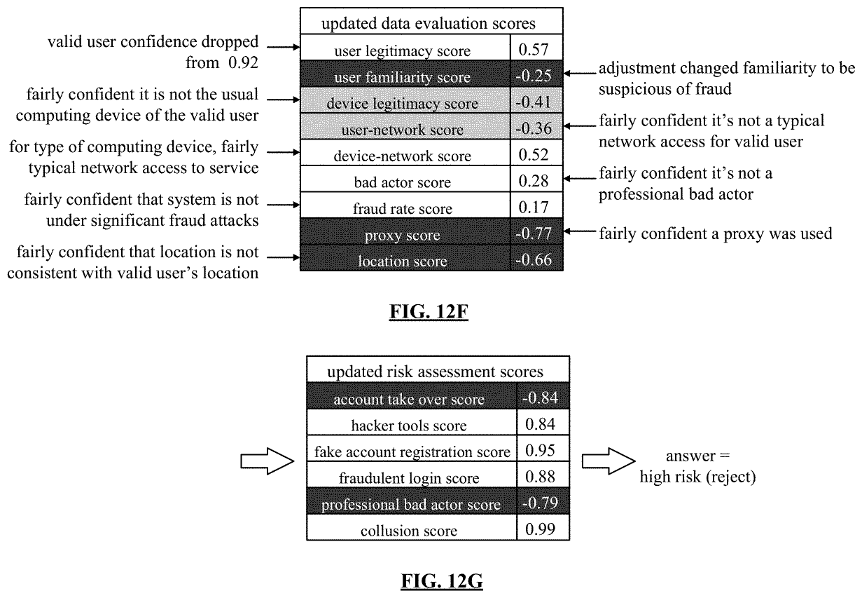

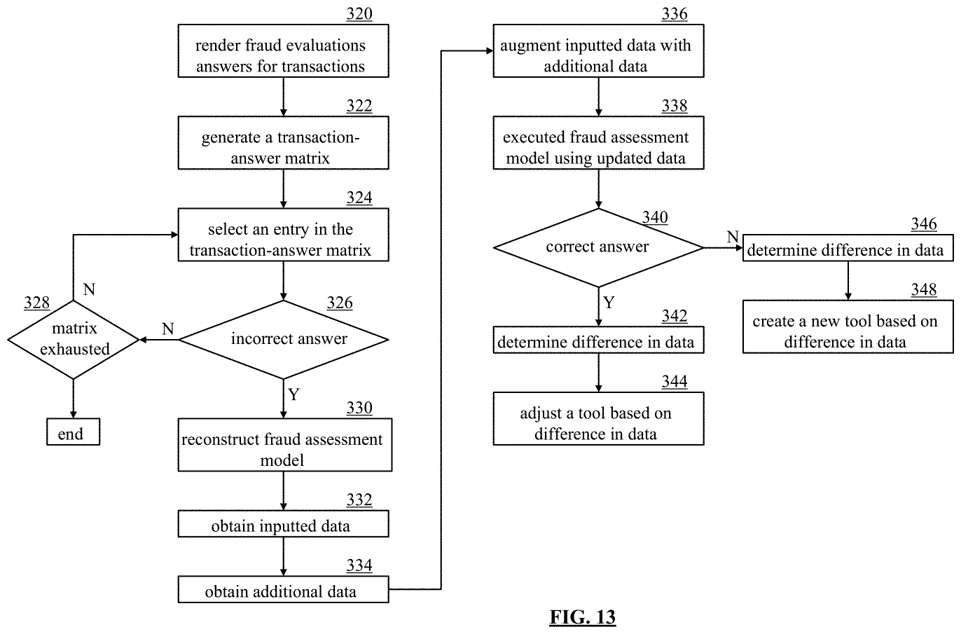

FIGS. 12A-12G are functional block diagrams of another example of generating a fraud evaluation answer for a transaction by the fraud detection computing system. FIG. 12A illustrates an example of generating an initial fraud analysis model based on the scores produced by the various modules. In this example, the modules that are included in the initial fraud analysis model are in black outlined boxes with black text and the modules that are being excluded from the initial fraud analysis model are in light grey outlined boxes with light grey text.

Thus, for this example, the initial fraud analysis model includes the core identity module 210, the familiarity detection module 212, the device recognition module 216, the core identity module 210-1, the device recognition module 216-1, the bad actor evaluation module 273, and the fraud rate evaluation module 275 are used in the updated model. The evaluation tools that produced “don't care” scores and are being used in the second level interpretation but are not used in the first. Such tools include the initial fraud analysis model are the risky behavior pattern module 214, the IP proxy module 232, the risky behavior module 214-1, the emergent detection module 238, and the rule decay module 240.

FIG. 12B illustrates an example of the initial fraud analysis model established by the fraud detection computing system 16. The initial model includes the core identity module 210, the familiarity detection module 212, the device recognition module 216, the core identity module 210-1, the device recognition module 216-1, the bad actor evaluation module 273, and the fraud rate evaluation module 275. The first interpretation level model further includes the account take over risk module, the hacker tool risk module, the fake account registration risk module, the fraudulent login risk module, the professional bad actor risk module, and the collusion risk module. The multi-module fusion tool processes the risk scores 280-288 and 294 in accordance with the first level interpretation. If a second level interpretation is needed, the multi-module fusion tool uses the scores of the modules (including the don't know answer) shown in FIGS. 12A-12B to render the initial answer.

FIG. 12C illustrates an example of an updated fraud detection model, which the fraud detection computing system 16 created after the initial fraud detection model rendered an answer of “further review”. In this example, the risk and evaluation tools of FIG. 12B are augmented with modules of the swarm processing tool set. For example, the situation awareness module generates data regarding the current system fraud threat level 301 (e.g., a percentage of transactions are currently suspected to be fraudulent).

As another example, the information foraging module generates new model paths 303 based on finding new data and/or interpreting data differently. As a further example, the swarming evaluation for optimal convergence module generates data regarding the value of swarmed solutions 305 (e.g., how reliable are the tools converging to a single trustworthy answer?). As a still further example, the self-awareness module generates self-awareness information 307 for one or more of the evaluation tools and/or of the risk assessment tools. As an even further example, the guidance and control module generates guidance and control data 309 for one more tools of the evaluation tool set and/or of the risk assessment tool set based on the system fraud tolerances 132.

The data produced by the swarm processing tools affects one or more other tools. For example, the various evaluation tools receive feedback data from one or more other evaluation tools to produce adjusted scores 218-1 through 222-1, 254-1, 260-1, 274-1, and 276-1. The adjusted scores are provided to the risk assessment tools, which produce adjusted risk scores 280-1 through 288-1 and 294-1. The multi-module fusion tool renders an updated answer 296-1 based on the adjusted risk scores.

FIG. 12D1 further illustrates example scores produced by the fraud analysis model of FIG. 12B. The scores are in the range of −1 to +1 as discussed with reference to FIG. 9E. For example, the user legitimacy score, user familiarity score, the device-network score, the bad actor score, and the fraud rate score are collectively indicative that the transaction is not fraudulent. However, the device legitimacy score and the user-network score are collectively indicative that the transaction is potentially fraudulent.

From the evaluation scores, the risk assessment tools generate their respective scores. For example, the account takeover score is suggestive, but not dispositive, that the user's account has been taken over. The remaining risk assessment scores are suggestive that the transaction is not fraudulent. Since the account take over score is suggestive of fraud and the remaining scores are not, the current answer is “further review”.

FIG. 12D2 shows the data evaluation scores in further review. As shown, the user legitimacy score is a 0.92 on a scale of −1 to +1. As such, the fraud detection computing system is fairly confident that the user is the legitimate user. The user familiarity score is 0.68, which is indicative of the system 16 being fairly confident that the familiarity of the transaction is commensurate with the valid user's familiarity with the system. The device legitimacy score is −0.41, which is indicative of the system 16 being somewhat confident that the computing device used for the transaction is not usual computing device used by the valid user.

The user-network score is −0.36, which is indicative of the system 16 being somewhat confident that the network access used for this transaction is not the typical network access used by the valid user. The device-network score is 0.52, which is indicative of the system 16 being fairly confident that, for the type of computing device, the network work access is fairly typical. The bad actor score is 0.82, which is indicative of the system 16 being fairly confident that the transaction does not involve a professional bad actor. The fraud rate score is 0.77, which is indicative of the system 16 being fairly confident that the system is not currently experiencing a significant fraud attack.

From the current scores, there are two plausible answers for the difference in answer. (1) The valid user has a new computing device that it is using to access the system; or (2) An imposter has taken over the valid user's account using the imposter's computing device. The fraud detection computing system 16 makes changes to obtain a correct answer regarding the difference and factoring that into the final fraud evaluation answer.

FIG. 12E illustrates the fraud detection computing system 16 making changes to the fraud evaluation model. In this example, the system makes adjustments to substantially prove that the user's account has been taken over. With this decision made, the system 16 adds the IP proxy module to the model and provides wider parameters 314 and 316 to the IP proxy module 232 and to the bad actor module and provide narrower parameters 310 and 312 to the core identity module 210 and the familiarity detection module 212. The wider parameters include more data to review, changing data evaluation filtering levels (e.g., letting more or less through), and/or changing how the data is interpreted (e.g., biased in one director or another).

Based on these parameter changes, the evaluation tools generate updated scores. The risk assessment tools also generate updated data scores that are fed to the multi-module fusion tool, which renders another updated answer 299-2. For this example, the updated answer is “high risk of fraud” or reject the transaction.

FIG. 12F shows update data evaluation scores in further review. As shown, the user legitimacy score dropped from 0.92 to 0.57, which reduces the system's confidence that this is a valid user. The user familiarity score is now −0.25, which is indicative of the system 16 being fairly confident that the familiarity of the transaction is not commensurate with the valid user's familiarity with the system. The device legitimacy score, the user-network score, and the device-network score remained the same.

The bad actor score dropped from 0.82 to 0.28, which is indicative of the system 16 is much less confident that the transaction does not involve a professional bad actor. The fraud rate score dropped from 0.77 to 0.17, which is indicative of the system 16 being much less confident that the system is not currently experiencing a significant fraud attack. The proxy score is −0.77, which is indicative of a high probability that a proxy address is being used. The location score is −0.66, which is indicative of a high probability that the user's location is not consistent with one of the valid user's typical locations.

FIG. 12G shows the updated fraud scores. In this example, the updated account takeover score is −0.84 and the professional bad actor score is 0.79. Given the strong possibility that the account has been taken over by a bad actor, the answer is updated to be “high risk of fraud” or reject the transaction.

FIG. 13 is a logic diagram of an example of a method executed by a computing entity of a fraud detection computing system for updating fraud evaluation and risk tools. The method begins at step 320 where the computing entity renders fraud evaluation answers regarding transactions as previously discussed.

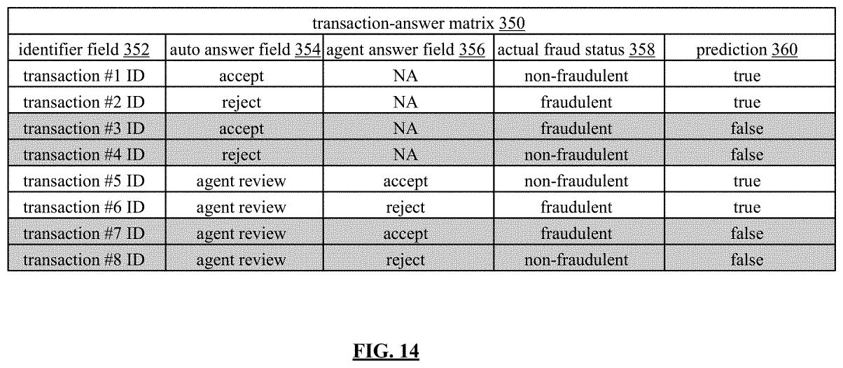

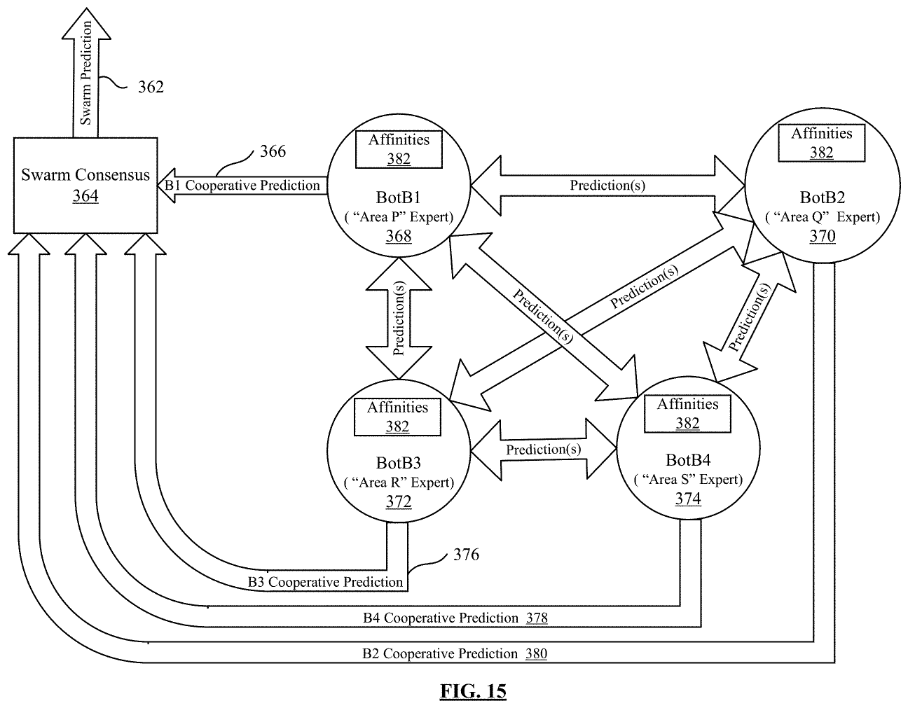

The method continues at step 322 where the computing entity generates a transaction-answer matrix regarding the transactions and the corresponding answers. For example, the computing entity obtains charge back reports (e.g., charges back to accounts for fraudulent transactions, which may occur months after the transaction errantly approved). The computing entity further obtains probability reports (e.g., reports regarding agent answers and their correctness, which is generally received within days after the transaction occurred). The computing entity then updates the transaction-answer matrix with data from the charge back reports and with data from the probability reports. An example of a transaction-answer matrix will be discussed in greater detail with reference to FIG. 14.

The method continues at step 324 where the computing entity selects an entry from the transaction-answer matrix for evaluation. The method continues to step 326 where the computing entity determines whether the answer rendered (e.g., automated by the system or the agent's answer) of the selected entry was correct. If it was correct, the method continues at step 328 where the computing entity determines whether the matrix has been exhausted (e.g., all the entries reviewed). If yes, the method ends. If not, the method repeats at step 324.

When the answer is incorrect or inaccurate, the method continues at step 330 where the computing entity reconstructs the fraud assessment model for the transaction. The fraud assessment model includes a set of evaluation tools, a set of risk assessment tools, and a set of swarm processing tools. The method continues at step 332 where the computing entity obtains inputted data that was used by the fraud assessment model to produce the corresponding fraud evaluation answer. The method continues at step 334 where the computing entity obtains additional data regarding the transaction. The additional data includes additional source data regarding a source of the transaction, additional destination data regarding a destination of the transaction, additional network data regarding a network that supported the transaction, additional bad actor data, additional transaction data regarding the transaction, and/or additional fraud type data.

The method continues at step 336 where the computing entity augments the inputted data with the additional data to produce updated data. The method continues at step 338 where the computing entity executes the fraud assessment model using the updated data to generate an updated fraud evaluation answer. The method continues at step 340 where the computing entity determines whether the updated fraud evaluation answer is correct.

When the updated fraud evaluation answer compares favorably to the actual fraudulent or non-fraudulent indication, the method continues at step 342 where the computing entity determines differences in the inputted data and the additional data to produce difference data. The method continues at step 344 where the computing entity adjusts a tool of the fraud assessment model based on the difference data.

When the updated fraud evaluation answer compares unfavorably to the actual fraudulent or non-fraudulent indication, the method continues at step 346 where the computing entity determines differences in the inputted data and the additional data to produce difference data. The method continues at step 348 where the computing entity creates a new tool for inclusion in the fraud assessment model based on the difference data.

FIG. 14 is a functional diagram of an example of a transaction-matrix 350 that includes a plurality of entries. Each entry includes an identifier field 352, an auto answer field 354, an agent answer field 356, an actual fraud status field 358, and a prediction accuracy field 360. The identifier field stores an identity of the transaction; the automated answer field stores a corresponding fraud evaluation answer; the agent answer field stores an agent answer when the corresponding fraud evaluation answer is agent review; actual fraud status stores whether transaction was actually fraudulent or not; and the predicted accuracy field stores an indication as to whether the answer was correct or not.

In this example, the first entry has the auto answer of “accept”, which turned out to be true (i.e., correct). The second entry has the auto answer of “reject”, which turned out to be true (i.e., correct). The third entry has the auto answer of “accept”, which turned out to be false (i.e., incorrect or inaccurate). The fourth entry has the auto answer of “reject”, which turned out to be false (i.e., incorrect or inaccurate). The fifth entry has the auto answer of “agent review” and an agent answer of “accept”, which turned out to be true (i.e., correct or accurate). The sixth entry has the auto answer of “agent review” and an agent answer of “reject”, which turned out to be true (i.e., correct or accurate). The seventh entry has the auto answer of “agent review” and an agent answer of “accept”, which turned out to be false (i.e., incorrect). The eighth entry has the auto answer of “agent review” and an agent answer of “reject”, which turned out to be false (i.e., incorrect).

From the transaction-answer matrix, the computing entity of the fraud detection computing system 16 would review the fraud determination process for entries 3, 4, 7, and 8. Depending on the nature of why the answer was wrong, the computing entity creates a new tool, or tools, and/or modifies one or more existing tools.

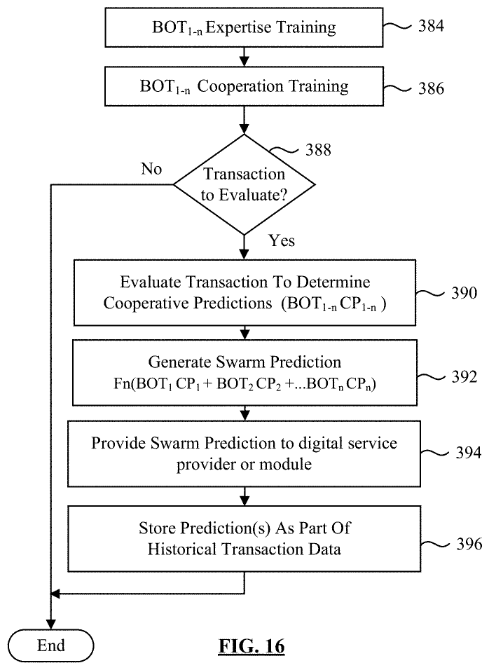

Referring next to FIG. 15, a schematic diagram illustrating interactive relationships between swarm members will be discussed in accordance with embodiments of the present invention. Swarm members are shown as AI modules, and are designated as BotB1 368, BotB2 370, BotB3 372, and BotB4 374. A Bot, or AI module, can be a module included in the risk assessment toolset 108 or evaluation toolset 106, as illustrated in FIG. 5. For example, a fraud evaluation module can include a Fake account registration module from risk assessment toolset 108, a risky behavior patterns module from evaluation toolset 106, or the like. Each Bot, or AI module is executed on one or more computing entities. A computing entity refers to one or more computing devices, such as computing device 25, shown in FIG. 2. The computing entities may include distributed computing devices, such as those used in cloud computing and cloud storage.

Each of the swarm members is aware of the other swarm members, and interacts with them via affinities. As used herein, the term “affinity,” and derivative terms, refers to an amount of influence one swarm member has on cooperative decisions made by another swarm member. For example, BotB1 368 has an affinity to BotB2 370, BotB3 372, and BotB4 374, meaning that when BotB1 368 makes a cooperative decision, such as a cooperative prediction regarding a transaction, BotB1 368 takes into account the cooperative decisions made by each of the other members of the swarm, in this example BotB2 370, BotB3 372, and BotB4 374. Similarly, BotB2 370, takes into account the cooperative decisions made by BotB1 368, BotB3 372, and BotB4 374; BotB3 372, takes into account the cooperative decisions made by BotB1 368, BotB2 370, and BotB4 374; and BotB4 374, takes into account the cooperative decisions made by BotB1 368, BotB2 370, and BotB3 372. As used herein, the terms “cooperative decision” and “cooperative prediction” refer to interactive decisions or predictions regarding a transaction in which one swarm member takes into account decisions or predictions made by one or more other swarm members regarding that same transaction.

As a matter of convention within this document, the affinity of one swarm member to another will be represented by “Affinity_{BOTF-BOTS}” to designate the influence a first swarm member (BOTF) grants to decisions made by a second swarm member (BOTS). Conversely, the influence granted by the second swarm member (BOTS) to decisions made by the first swarm member (BOTF) will be designated Affinity_{BOTS-BOTF}.

The affinities between two swarm members may be the same or different. For example, Affinity_{BOT2-BOTB1} may be assigned a value of 0.01, while Affinity_{BOTB2-BOTB1} may be assigned a value of −0.2. In this example, an affinity value of 0.01 reflects an assessment by BotB1 368 that its prediction regarding a particular transaction should be slightly altered to more closely match the prediction generated by BotB2 370. An affinity value of −0.2 reflects an assessment by BotB2 370 that its prediction regarding a particular transaction should be adjusted to deviate from the prediction generated by BOTB1 368.

Various different affinity scales and protocols can be used consistent with the present invention, but at least one embodiment employs an affinity scale ranging from −1.0 to +1.0. In at least one embodiment, a highly positive affinity rating, e.g. Affinity_{BOT2-BOTB1}=1, means that a decision or prediction made by BotB1 368 is more likely to be accurate if BotB1 368 cooperates with BotB2 370. A slightly positive affinity value indicates that cooperation with BotB2 370 has a positive effect on the accuracy of predictions and decisions made by BotB1 368, but not as much as a highly positive affinity. A negative affinity indicates that when BotB1 368 cooperates with BotB2 370, the decision or prediction made by BOTB1 is less likely to be correct than if BotB1 368 made the same prediction or decision independent of BotB2 370.

The scale used to indicate the correlation between cooperation and accuracy can be applied as a weighting factor. Consider the following example, in which BotB1 368 makes an independent prediction that a particular transaction is 87.4 percent likely to be fraudulent. If Affinity_{BOT2-BOTB1}2=0.3, and BotB2 370 makes a prediction that the same transaction is 97 percent likely to be fraudulent, BotB1 368 can adjust its prediction as follows: 0.874*0.7+0.97*0.3=0.9028, yielding a cooperative prediction by BotB1 368 that the transaction is 90.28 percent likely to be fraudulent. Note that in this example, the weighting applied to the prediction of BotB1 368 (0.7) plus the affinity weighting of BotB2 370 (0.3) totals 1, which prevents the cooperative prediction from yielding a result that exceeds 100 percent.

Decisions made by any swarm member having a negative affinity with BotB1 368 are ignored by BotB1 368, because cooperation with swarm members having negative affinities is less likely to assist BotB1 368 in reaching an accurate decision. However, in other implementations, BotB1 368 can adjust its prediction to account for the likelihood that cooperation with the other swarm member would lessen the accuracy of a prediction made by BotB1 368. Consider the following example, in which BotB1 368 again makes an independent prediction that a particular transaction is 87.4 percent likely to be fraudulent. But now Affinity_{BOTB1-BOTB2}=−0.3, and BotB2 370 makes a prediction that the same transaction is 97 percent likely to be fraudulent, BotB1 368 can adjust its prediction as follows: 0.874*1.3-0.97*(−0.3)=0.9028, yielding a cooperative prediction by BotB1 368 that the transaction is 84.52 percent likely to be fraudulent. Again, the weighting applied to the prediction of BotB1 368 (1.3) plus the affinity weighting of BotB2 370 (−0.3) totals 1.

In some implementations, Affinity_{BOTB1-BOTB2} is based on how certain BotB1 is that predictions made by BotB2 are reliable. For example, Affinity_{BOTB1-BOTB2} may have a maximum affinity value of 0.5 when BOTB1 is between 70% and 85% certain that a prediction provided by BOTB2 is reliable, but have a maximum affinity value of 0.8 when BOTB1 is 99% certain that a prediction provided by BOTB2 is reliable. Taking certainty into account can be used to weight the swarm consensus more heavily in favor of a particular expert Bot when that Bot is almost certain that it is correct in its own area of expertise.

The above example is only one way of adjusting predictions based on affinity values to provide interactivity among swarm members. In other embodiments, affinity values can be applied using various other combinatorial functions, some of which are more complex. For example, best-fit curve analysis or other statistical evaluation techniques or functions can be used to allow one swarm member to take into account decisions made by other swarm members. This is especially true when taking into account multiple different affinities to multiple different swarm members.

In some implementations, for example, a sum of the weighted effects of all the affinity values can be combined into a single value, and then added to a base prediction generated by BotB1 368 in a manner similar to the example given above, so that a single modification is made to the base prediction. In other implementations, BotB1 368 can apply affinities to other swarm members in a particular order. For example, Affinity_{BOTB1-BOTB2} is applied first, and the cooperative prediction resulting from application of Affinity_{BOTB1-BOTB2} is used as a new “base” prediction, and Affinity_{BOTB1-BOTB3} is applied to that new base prediction, and so on. In other embodiments, BotB1 368 can generate predictions based on its affinity for each swarm member independently, and then apply a mean function to the independent values to generate a prediction having a likely accuracy equal to the mean of the independent values. As illustrated in FIG. 15, each of the swarm members BotB1 368, BotB2 370, BotB3 372, and BotB4 374 has been trained as an “expert” in a particular area. For example, BotB1 368 may be trained as an expert in recognizing account takeover attacks, BotB2 370 may be trained as an expert in recognizing fraudulent logins, BotB3 372 may be trained as an expert in recognizing bad actors based on patterns of user interactions with a website, and BotB4 374 may be trained as an expert in recognizing devices that have been compromised by malware. Each of the swarm members is tasked with making predictions regarding a transaction, and sending those predictions to a swarm consensus module 364, which combines the predictions made by the swarm members to generate a swarm prediction indicating whether the transaction being evaluated is fraudulent, not fraudulent, or requires further evaluation. A swarm prediction indicating how the transaction is to be processed is referred to herein as a disposition decision. for example, a swarm prediction indicating that a transaction is fraudulent can serve as a disposition decision indicating that the transaction should be blocked. Similarly, a swarm prediction indicating that a transaction is not fraudulent can serve as a disposition decision indicating that the transaction should be processed. A swarm a swarm prediction indicating that a transaction requires further evaluation can serve as a disposition decision indicating that the transaction should be forwarded to a human agent.

As used herein, the term “transaction” includes, but is not limited to, new account requests, purchase requests, sales requests, file and data access requests, payment validation requests, and the like. In at least one embodiment, transactions are evaluated prior to the transaction being approved. Thus, if a transaction is evaluated to determine whether it is fraudulent prior to the transaction being completed. In some instances, a transaction can begin being processed prior to a final result of the evaluation being completed, but will be cancelled prior to completion if the transaction is determined to be fraudulent. In other instances, an evaluation of the transaction is completed prior to any portion of the transaction being processed.

In some implementations, a transaction may be processed even though evaluation of the transaction indicates that the transaction is likely to be fraudulent. In such cases, the context of suspected or known fraudulent transactions can be used to help identify future fraudulent transactions. For example, if a particular user is identified as a bad actor during evaluation of a transaction, but other aspects of the transaction indicate a valid transaction, actions taken by the bad actor can be used to aid in identifying new types of fraudulent activity. Allowing some transactions to be processed despite the likelihood that they are fraudulent, can be useful in helping to prevent a bad actor from accurately reverse-engineering the evaluation process, and thereby make it more difficult for the bad actor to identify changes that might avoid detection.

The predictions provided by the individual swarm members to swarm consensus module 364 can be cooperative predictions, which already account for Bot-to-Bot affinities, or expert predictions, which have not yet been adjusted to account for affinities. In implementations where the swarm members provide cooperative predictions, swarm consensus module 364 applies the cooperative predictions of each swarm member using the techniques described in FIGS. 1-14 to arrive at a swarm prediction 362 regarding the transaction under consideration. The term “consensus prediction” should be understood to be synonymous with the term “swarm prediction,” unless otherwise required by the context. In implementations where some or all of the individual swarm members provide expert predictions that have not yet been adjusted based on Bot-to-Bot affinities, some or all of the Bot-To-Bot affinities can be provided to swarm consensus module 364, which will take those affinities into account in generating the swarm prediction.

In at least one implementation of embodiments illustrated in FIG. 15, each swarm member is aware of other swarm members, and is also aware of its own affinities to those other swarm members. For example, BOTB1 has access to Affinity_{BOTB1-BOTB2}, Affinity_{BOTB1-BOTB3}, and Affinity_{BOTB1-BOTB4}, and uses those affinities to generate B1 Cooperative Prediction 366. Similarly, BOTB2 uses Affinity_{BOTB2-BOTB1}, Affinity_{BOTB2-BOTB3}, and Affinity_{BOTB2-BOTB4}, to generate B2 Cooperative Prediction 380; BOTB3 uses Affinity_{BOTB3-BOTB1}, Affinity_{BOTB3-BOTB2}, and Affinity_{BOTB3-BOTB4}, to generate B3 Cooperative Prediction 376; and BOTB4 uses Affinity_{BOTB4-BOTB1}, Affinity_{BOTB4-BOTB2}, and Affinity_{BOTB4-BOTB3}, to generate B4 Cooperative Prediction 378.

In addition to being aware of affinities for each of the other swarm members, a swarm member uses the predictions and decisions of the other swarm members to generate its cooperative decision. Thus, BotB1 368 will need to be able to obtain decisions regarding the transaction under consideration generated by BotB2 370, BotB3 372, and BotB4 374. To exchange information and interact with the other swarm members, the swarm members can communicate, either directly or indirectly, with other swarm members. For example, the swarm members may be arranged to communicate using a mesh-type system, in which communications can be put into the mesh and forwarded to any other swarm member as needed. In other implementations, a hub-and-spoke system can be used, in which decisions are forwarded to a central location, and distributed to the individual members. Information can be transmitted between swarm members using a query-response technique, using a push technique, or using another suitable communications protocol. For example, each swarm member may push information concerning a transaction being evaluated, including in some cases its own expert prediction and/or its own cooperative prediction.

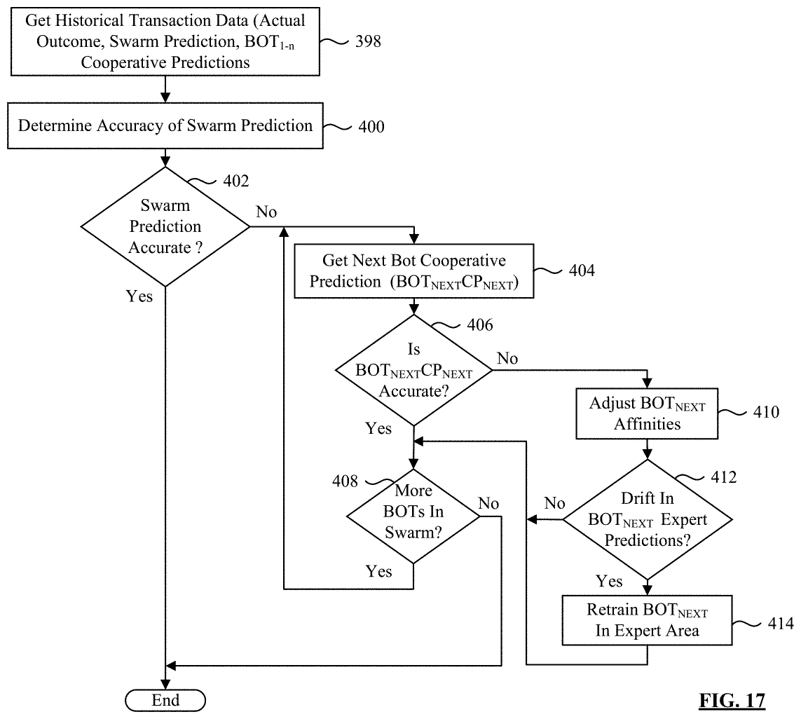

Referring next to FIG. 16, a functional block diagram illustrating a method of interactive swarm prediction, will be discussed in accordance with various embodiments of the present invention. As illustrated by block 384, each BOT₁₋ₙ, is trained in its respective area of expertise. In general, expert training includes obtaining historical data about completed transactions, providing the historical data to the BOT being trained, tasking the BOT with generating a prediction, comparing the prediction with the already-known outcome of the completed transaction, adjusting various parameters and/or functions used by the BOT as necessary, and tasking the BOT to evaluate another completed transaction using the adjusted parameters and/or functions. This process is repeated until the accuracy of the BOT's predictions fall within an acceptable threshold level. This iterative training process is described in greater detail by FIGS. 1-14 and their accompanying descriptions.

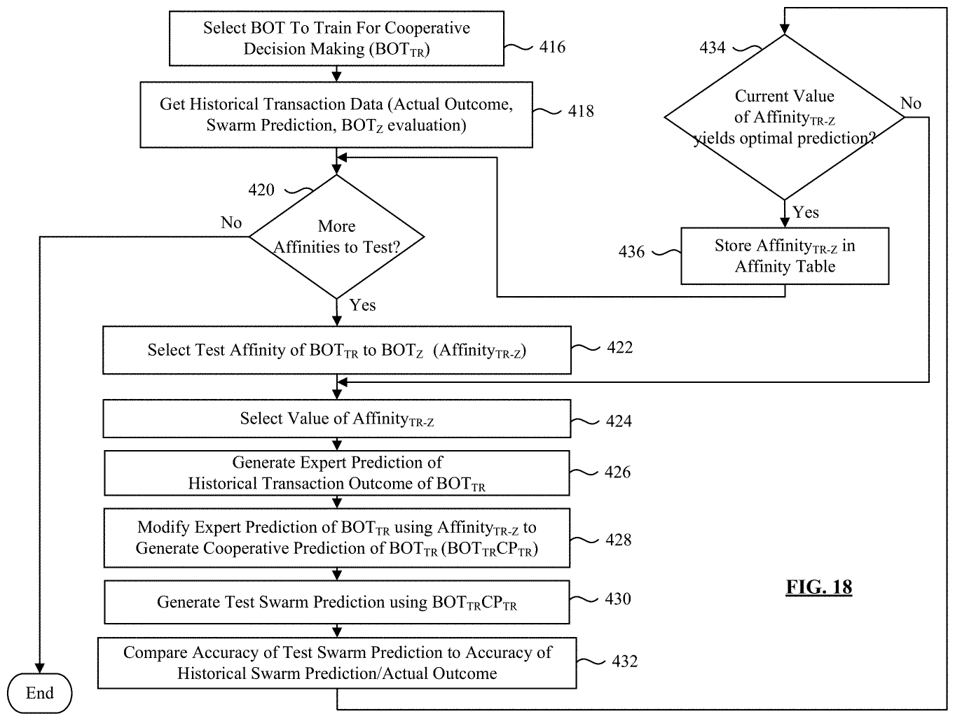

As illustrated by block 386, once each BOT₁₋ₙ, are trained in its respective area of expertise, each Bot receives cooperative training, which allows each BOT₁₋ₙ to make interactive decisions that take into account decisions made by other Bots. Cooperative Training will be discussed in greater detail with respect to FIG. 18. In general, cooperative training uses affinities to improve decisions and predictions made by each BOT₁₋ₙ.

As illustrated by block 388, once BOT₁₋ₙ, are trained as experts in their respective areas, and are trained to make predictions in cooperation with other Bots, BOT₁₋ₙ are placed in service, and wait until they are called upon by one or more of the computing systems included in data transactional networks to evaluate an actual transaction. In various embodiments, transaction evaluation requests can be received at one of fraud detection computing system 16, malicious content detection system 15, or route determination system 17 from a member of data transactional network, e.g. digital service provider computing system 16.

When BOT₁₋ₙ, are called upon to evaluate a transaction, each of the Bots generates a cooperative prediction regarding the transaction, as illustrated by block 390. The cooperative predictions are represented as BOT₁₋ₙ CP₁₋ₙ. Cooperative predictions generated by each Bot are based on predictions reflecting each Bot's own expertise, but modified based on each Bot's affinity to other Bots participating in the transaction evaluation.

As illustrated by block 392, the cooperative predictions of each of the Bots is used to generate a swarm prediction, which is represented as Fn(BOT₁ CP₁+BOT₂ CP₂+ . . . BOTₙ CPₙ), where the particular function applied can be a suitable statistical and/or combinatorial function determined empirically or otherwise, and implemented by swarm consensus module 364, as part of swarm processing tool set 110.

As illustrated by block 394, the swarm prediction 362 are provided to a system requesting analysis of the transaction, e.g. digital service provider computing system 14, or another computing system in data transactional network 10. If the swarm prediction 362 is generated by fraud detection computing system 16, the swarm prediction can be fraud evaluation answer 118. Similarly, if the swarm prediction is provided by malicious content detection system 15, the swarm prediction may represent a final determination indicating the absence, or presence, of malicious content in a message being processed by digital service provider computing system 14. If the swarm prediction is provided by route determination system 17, the swarm prediction can represent a go/no decision, a suggested path, or a likelihood of successful transmission via a particular network path through network 20.

In various embodiments, the swarm prediction can be provided to the requesting system, or to a target system identified by the requesting system. For example, if digital service provider 14 is using fraud detection system 16 to analyze a transaction on behalf of user computing device verification service 24, digital service provider 14 may instruct fraud detection computing system 16 to provide the swarm prediction to user computing device verification service 24 instead of, or in addition to, providing the swarm prediction 362 to digital service provider computing system 14. In other embodiments, the swarm prediction 362 can be used as input to another module or tool, e.g., a risk assessment tool set 108 or evaluation tool set 106.

As illustrated by block 396, historical transaction data related to the transaction is stored in data transaction network 10. In at least one embodiment, some or all of the historical transaction data can be stored by swarm consensus module in a memory accessible to computing device 25, such as cloud memory 98, SS memory 96, HD memory 94, or flash memory 92. Some or all of the historical transaction data can be stored in a pool of data sources 120, in data sources 150, in computing system 14, in route determination system 17, in malicious content detection system 15, in computing system 22, in computing system 24, or in some combination thereof. Initially, historical transaction data can include, but is not limited to, cooperative and/or expert predictions of each swarm member, swarm prediction 362, context information associated with the transaction, affinity information indicating a procedure by which one or more Bots arrived at their cooperative prediction. The historical transaction data can also include a transaction identifier that allows so that an actual result of the historical transaction can be added to the historical transaction after the actual result becomes known.

Referring next to FIG. 17, a method of adjusting affinity values will be discussed in accordance with embodiments of the present invention. In various embodiments, adjusting affinity values allows the swarm of Bots to converge on a single loss-minimizing coherent decision in a process referred to herein as “swarm to consensus.” The process of swarming to consensus allows a problem solution to emerge through the cooperative interaction of individual members of a group, even if each member of the group is evaluating activities that are only loosely coupled.

During the swarming to consensus process, an individual member of the group adjusts its own opinion concerning risk-likelihood toward and optimal convergence of opinion through induced movement. The individual member of the group, member of the swarm, references the opinions of other group members, based on a representation of historically successful-or-unsuccessful cooperative efforts with the other group members. Individual members keep track of past interactive decision activities, trending more toward the opinions of other group members with a statistical history of successful interactive dynamics with the individual, and shying away, moving away from the opinions of group members with which it has had less successful interaction in the past.

The opinions of group members with which the individual has cooperated in the past and trended toward loss-minimization induce movement toward the opinions of those group members. The opinions of group members with which the individual has cooperated in the past and resulted in loss-increase induce movement toward the opinions of those group members. Induced opinion movements are micro-movements, and convergence toward consensus occurs gradually over repetitive processing cycles. In this way, the risk-likelihood opinions of group members dynamically move from relative independence (dependent relativity) to relative inter-dependence (interdependent relativity), resulting in emergent consensus.

Convergence emerges based on concomitance, the simultaneous co-occurrence of a number of conditioning factors, primary of which are the risk-likelihood opinions of other members of the group, termed “neighbors”, group members with which successful collaboration, in context, has occurred in the past. If a similar set of factors has occurred in the past, associated with a known outcome, then a likely outcome is induced by the present factors, and the likelihood of that outcome magnetizes the emergent consensus, inducing movement (movement of opinion) toward consensus by the individual swarm members.

The method of claim 17 can be performed periodically, in response to alterations made to affinities or evaluation functions of one or more Bots in a swarm, in response to a change in observed accuracy of swarm or cooperative predictions associated with one or more Bots, in response to a raw number of inaccurate predictions exceeding a threshold value, in response to the number of “indeterminate,” or “further review needed” predictions falling outside of an acceptable range of values, or the like.

As illustrated by block 398, a computing system, e.g. fraud detection computing system 16, route determination system 17, or malicious content detection system 15, obtains historical transaction data, which can include an actual outcome of the transaction, the swarm prediction, and the cooperative predictions of the individual swarm members, transaction context, various transaction data elements and parameters, and the like.

As illustrated by block 400, the swarm prediction regarding the outcome of a transaction is compared to the actual outcome of the transaction to determine the accuracy of the swarm prediction. The actual outcome of the transaction is generally not known at the time the swarm prediction is made, except when historical data is used as the basis of the swarm prediction. In the illustrated example, the swarm prediction included in the historical data was made prior to the actual outcome being known, even though both the swarm prediction and the actual outcome are obtained from historical data. For example, a swarm prediction made contemporaneously with a financial transaction may indicate that the transaction is non-fraudulent, but later obtained information may prove to be fraudulent. In many instances, evaluation of the accuracy of a swarm prediction regarding a particular transaction may not be performed until after that transaction has been approved.

As illustrated by block 402, if the swarm prediction is accurate, no affinity adjustments will be made. In some implementations, a swarm prediction is deemed to be accurate if the swarm correctly predicts the actual outcome of a transaction. In other embodiments the accuracy of a swarm prediction is determined based on a certainty threshold. When applying a certainty threshold, a swarm prediction matching an actual outcome may not, by itself, sufficient for the swarm prediction to be considered accurate. Instead, a swarm prediction may be considered accurate only if a certainty level associated with the swarm prediction satisfies a certainty threshold.

Assume, for example, a range of certainty thresholds between 0 and 1, with 0 being completely indeterminate and 1 representing complete certainty 100. Also assume a certainty threshold of 75 percent. Because accuracy of a prediction is dependent on the certainly threshold, if the swarm predicted the transaction to be fraudulent, but only to a 62 percent certainty, the determination at block 402 would be “inaccurate,” even though the swarm correctly predicted the actual outcome of the transaction.

In some such embodiments, determining whether a swarm prediction is accurate is based on comparisons of swarm predictions to actual outcomes for multiple transactions. Thus, for example, block 402 may designate a swarm prediction as accurate only if the swarm correctly predicts more than 75 percent of the actual outcomes, or correctly predict at least 75 percent of the actual outcomes, with 90 percent of the correct predictions having a certainty threshold of 80 percent. Other criteria for defining accuracy can be selected.

If it is determined at block 402 that the swarm prediction was inaccurate, the individual components used to generate the swarm prediction, e.g. the cooperative predictions of the swarm members, can be evaluated to determine if affinity values need to be evaluated for potential modification. As illustrated by block 404, if affinity values are to be evaluated, a cooperative prediction of BOT_{NEXT}, which is obtained from the historical transaction data, is selected for evaluation. The cooperative prediction of BOT_{NEXT} is referred to herein using the convention: BOT_{NEXT}CP_{NEXT}.

As illustrated by block 406, if BOT_{NEXT}CP_{NEXT} is determined to be accurate, there is no need to adjust the affinities used to generate BOT_{NEXT}CP_{NEXT}. BOT_{NEXT}CP_{NEXT} can be considered to be accurate if BOT_{NEXT}CP_{NEXT} matches the actual outcome, if BOT_{NEXT}CP_{NEXT} matches the actual outcome to a threshold degree of certainty, or otherwise. Thus, for example, if BOT_{NEXT} is an expert in identifying fake account registrations, and the actual outcome indicates that the transaction implicated a fake account registration, BOT_{NEXT}CP_{NEXT} can be deemed accurate if BOT_{NEXT}CP_{NEXT} predicted that the transaction was fraudulent, or had a high probability of being fraudulent. Conversely, BOT_{NEXT}CP_{NEXT} will be deemed inaccurate if BOT_{NEXT}CP_{NEXT} predicted that the transaction was non-fraudulent, or had a low probability of being fraudulent.

As illustrated by block 408, if there are cooperative predictions associated with other BOTS in the swarm to evaluate, the method loops back to block 404 until cooperative predictions made by the other BOTs in the Swarm have been evaluated.

As illustrated by block 410, if BOT_{NEXT}CP_{NEXT} is inaccurate the affinities of BOT_{NEXT} are adjusted. Affinities can be adjusted by subjecting BOT_{NEXT} to cooperation training, or retraining, as discussed subsequently with reference to FIG. 18.

As illustrated by block 412, after affinities are adjusted, a check is made to determine if those adjustments caused BOT_{NEXT} to drift too far from its original area of expertise.

Checking for drift can provide the system an important balance, because adjusting the affinities of BOT_{NEXT} may result in BOT_{NEXT}CP_{NEXT} accurately matching the actual outcome of one transaction, but cause expert predictions related to other transactions to drift away from ideal. Because cooperative predictions made by BOT_{NEXT} are influenced by BOT_{NEXT}'s expert prediction, an erroneous expert prediction could propagate through to BOT_{NEXT}'s cooperative decision, which would then propagate through to cooperative decisions made by other swarm members with affinities to BOT_{NEXT}, and finally propagate through to swarm decisions.

In at least one embodiment, BOT_{NEXT} can be said to have drifted if BOT_{NEXT} makes more than a threshold number of inaccurate expert predictions, if the number of inaccurate expert predictions increases more than a threshold amount, if the number of inaccurate predictions exceeds an expert training threshold, or if a minimum confidence level is not achieved.

As illustrated by block 414, if adjusting affinities causes the expert predictions (e.g. non-cooperative predictions) of BOT_{NEXT} to be inaccurate, BOT_{NEXT} can be retrained in its area of expertise.

When affinity adjustments are used in the process of swarming to consensus, the opinion of a first Bot may change as the first Bot receives the predictions of second and third Bots. But since the predictions of the second and third Bots B and C also depend on prediction of the first Bot, when the first Bot changes its prediction, and the second and third Bots change their predictions, which in turn changes the prediction of the first Bot, and so on. This process can be carried on through a preset number of iterations, carried on for a preset time period, continued until a change in A's opinion based on affinity with other Bots changes by less than a predetermined threshold, or the like.

In some embodiments, when the first Bot changes its prediction, it locks out prediction changes from affecting its own prediction for a period of time, thereby allowing the first Bots prediction to propagate through all of the other Bots. Each Bot can give preference to its own opinion when determining an order in which to apply the affinities. In some implementations, predictions from other Bots can be applied in an order dependent on the strength of an affinities with those Bots. Thus, predictions of Bots with higher affinities can be applied before predictions of Bots with lower affinities.

Referring next to FIG. 18, a functional block diagram illustrating a method of cooperative-decision training will be discussed in accordance with embodiments of the present invention. As illustrated by block 416, BOT_{TR} is selected to be trained in cooperative decision making.

Historical transaction data for one or more transactions is obtained at block 418. In at least one embodiment, the historical transaction data can include, for each historical transaction, an actual outcome, a swarm prediction, transaction context, functions and transaction data used by swarm members to generate their predictions, affinities of BOT_{1-N}, and the like.

BOT_{TR} will, in most cases, have affinity values representing the affinity of BOT_{TR} to each of the other swarm members. For example, Affinity_{BOTTR-BOT1}, Affinity_{BOTTR-BOT2}, Affinity_{BOTTR-BOT3}, and so on. At block 420, a check is made to determine whether there are more affinities to be tested for the selected BOT_{TR}. If there are more, the next affinity is selected at block 422. In the illustrated example, the affinity of BOT_{TR} to BOT_{Z} (Affinity_{TR-Z}) is selected for testing.

As illustrated by block 424, a value of Affinity_{TR-Z} is selected. In at least one embodiment, the initial value of Affinity_{TR-Z} is set to the value included in the historical data, which represents the affinity of BOT_{TR} to BOT_{Z} used to arrive at the historical Swarm Prediction. If there is no value of Affinity_{TR-Z} included in the historical values, for example if BOT_{TR} is being added to the swarm, or is being trained for the first time, a default value can be used. For example, if the range of affinity values being used is −1 to +1 a default affinity value of 0, representing no affinity, can be selected as the initial value of Affinity_{TR-Z}.

As illustrated by block 426, BOT_{TR} generates an expert prediction using historical data associated with the transaction. BOT_{TR}'s expert prediction is made without foreknowledge of the swarm prediction in most cases, but can account for transaction contexts, parameters, and other historical data. BOT_{TR}'s expert prediction can be made in accordance with the techniques and disclosed herein, as discussed generally with respect to FIGS. 1-14.

As illustrated by block 428, BOT_{TR} modifies its expert prediction, using Affinity_{TR-Z} to generate a cooperative prediction, designated herein as BOT_{TR}CP_{TR}. Prediction BOT_{TR}CP_{TR} is dependent on a prediction generated by BOT_{Z} to an extent dictated, at least in part, by the affinity of BOT_{TR} to BOT_{Z} (Affinity_{TR-Z}). The prediction of BOT_{Z}, used by BOT_{TR} to generate BOT_{TR}CP_{TR} is a prediction made by BOT_{Z} based on the same historical data, and associated with the same historical transaction, used by BOT_{TR}. BOT_{Z}'s prediction can be a cooperative prediction or an expert prediction, and may be a historical prediction obtained from in historical data or a newly generated prediction based on the historical data.

As illustrated by block 430, a test swarm prediction is generated based on BOT_{TR}CP_{TR}. The test swarm prediction can be made using the same functions, context, data, and affinities used to make the historical swarm prediction, with only the value of BOT_{TR}CP_{TR} being varied.

As illustrated by block 432, the accuracy of the test swarm prediction is compared against the accuracy of the historical swarm prediction. In cases where the historical data reflects an actual transaction without an accompanying historical swarm prediction, the actual historical outcome of the transaction can be compared against the test swarm prediction. When there is no historical swarm prediction, there will be no accuracy component to be compared. Under those circumstances, the function performed by this block may reduce to simply matching the actual historical outcome to the predicted outcome. Assume for example, that a result of the comparison is defined as (x*Delta Outcome)+(y*Delta Accuracy), where x and y are weighting functions, the “y” weighting function can be set to zero when the actual historical outcome is used instead of a historical swarm prediction. Although this example uses simple weighting and addition functions, other suitable functions can be used.

As illustrated by block 434, a check is made to determine if the accuracy of the test swarm prediction generated using Affinity_{TR-Z} is optimal. Whether the accuracy of a particular test swarm prediction is optimal can involves multiple iterations through various portions of the method of FIG. 18. For example, twenty test predictions can be generated based on twenty different values of Affinity_{TR-Z}. The most accurate of those twenty test predictions can be selected as optimal. In embodiments employing multiple iterations using different affinities, the first iteration can be set to always yield a result indicating that the current value of Affinity_{TR-Z} is not yet optimal, which will force additional iterations to be performed. If the determination made at block 434 yields a decision that Affinity_{TR-Z} is not optimal, the method returns to block 424, where the next value of Affinity_{TR-Z} is selected.

In each iteration, the value of Affinity_{TR-Z} can be altered adjusted by a set amount from the value of Affinity_{TR-Z} used in a preceding iteration. Consider, for example, an implementation in which each iteration uses an affinity value that deviates from a given affinity value by +/−0.01. In this example, if a the affinity value used during a first iteration is 0.5, the second iteration may use an affinity value of 0.51 (0.5+0.01), and the third iteration uses an affinity value of 0.49 (0.5-0.01). In some embodiments, determining whether an affinity value is optimal can include choosing among test swarm predictions generated by the most recent three iterations. In this example, if the three iterations produce three results indicating an inflection point, i.e. the middle affinity value (0.5) is the most accurate, that middle affinity value can be selected as the optimal affinity value. If the values of the three iterations indicate a trend up or down, the affinity value producing the most accurate prediction of the three can be chosen as a potential optimum value. Further iterations can be performed until an inflection point is encountered, thereby indicating that an optimum affinity value has been identified.

In some instances, an inflection point may be interpreted as a potential optimal value. Evaluation of additional affinity values can be continued in an attempt to identify additional potential optimal values. If more than one potential optimal value is identified, the potential optimal values can be interpreted as local maxima, and further evaluated to identify a global maximum that produces the most accurate swarm prediction. Various statistical and mathematical constructs can be used to determine whether a search for multiple optimal values is complete, so that in some cases there is no need to evaluate the entire range of affinity values. For example, results from a range of different affinity values can be used as points in a best-fit curve analysis, which allows targeted selection of affinity values for evaluation.

As illustrated by block 436, an affinity value identified as optimal can be stored in one or more affinity tables, and the method returns to block 420, and begins evaluating other affinity values, if there are more affinity values to evaluate. For example, once an affinity value between BOT_{TR} and Bot_{Z} (Affinity_{TR-Z}) has been stored in an affinity table, the illustrated method can proceed to determine an affinity value between BOT_{TR} and other Bots in the swarm, such as Bot_{N} (AffinityT_{R-N}).

As indicated by block 420, once the affinities of BOT_{TR} have been determined and stored, so that there are no more affinities to test, the method ends.

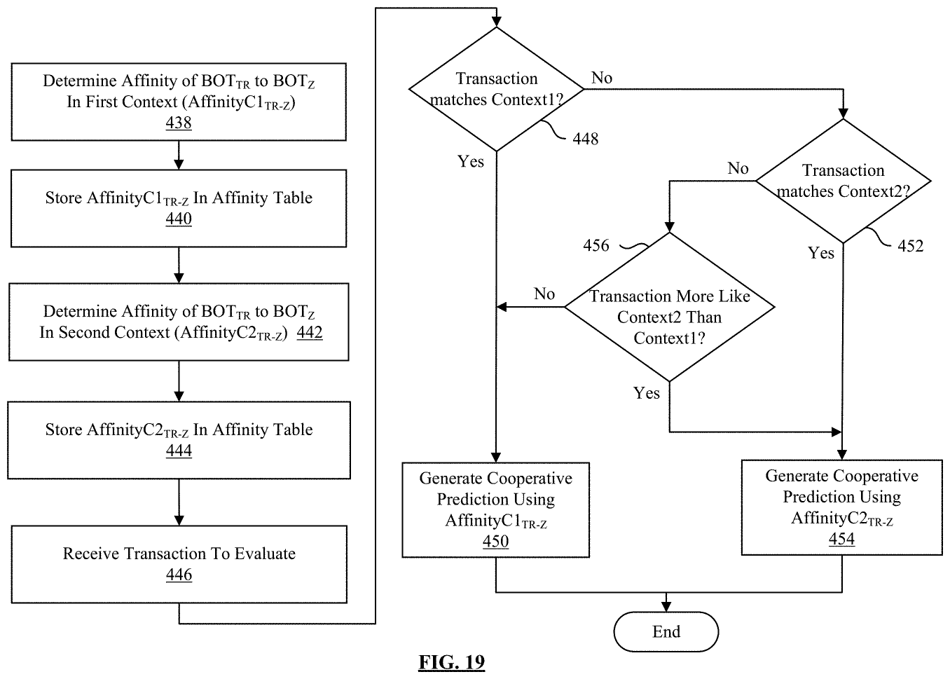

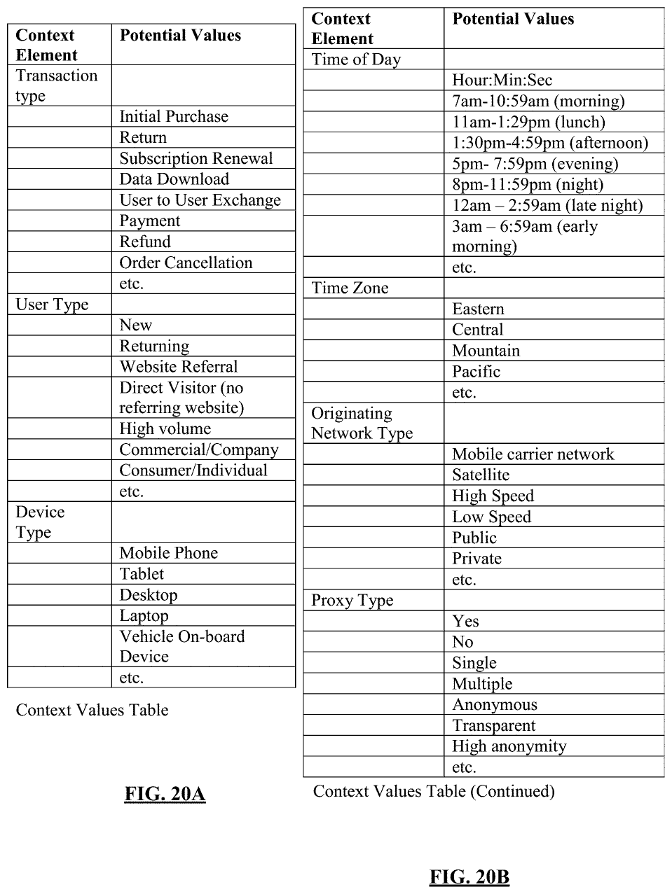

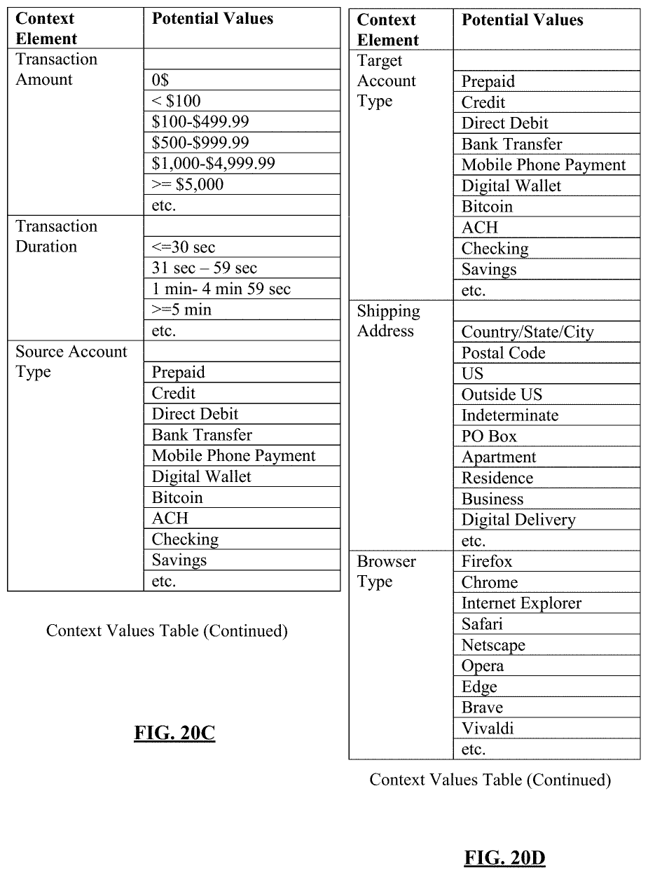

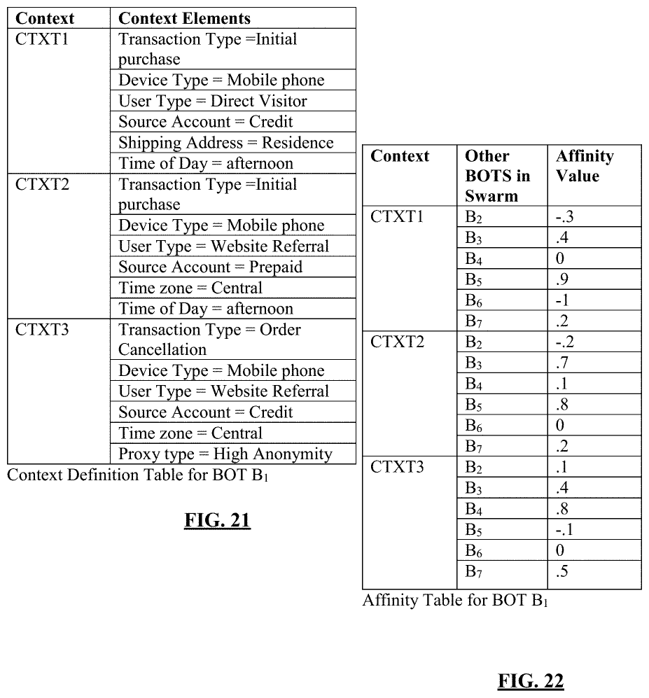

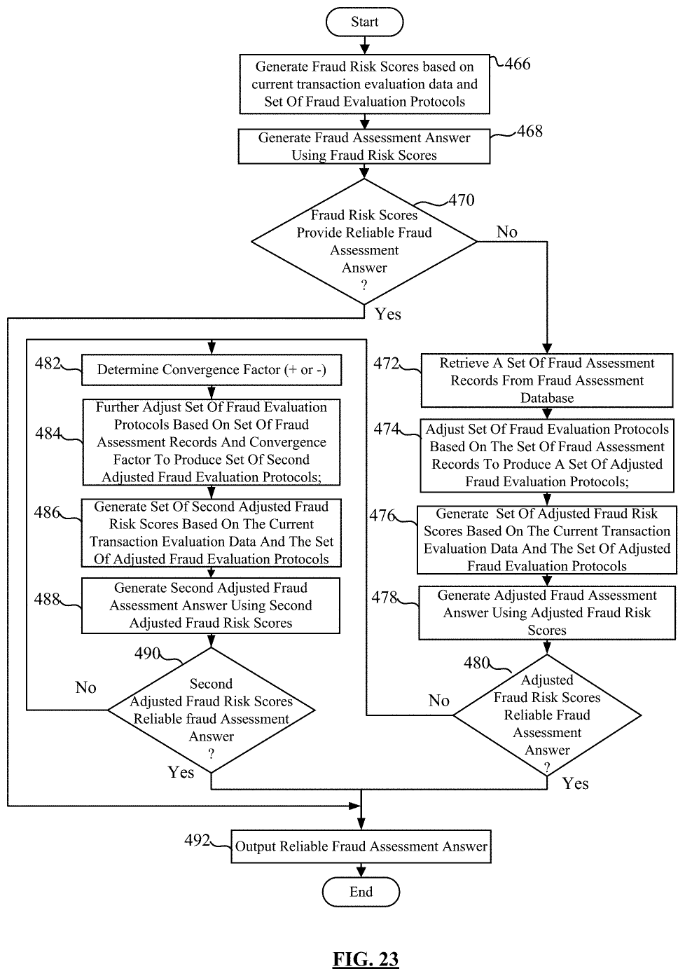

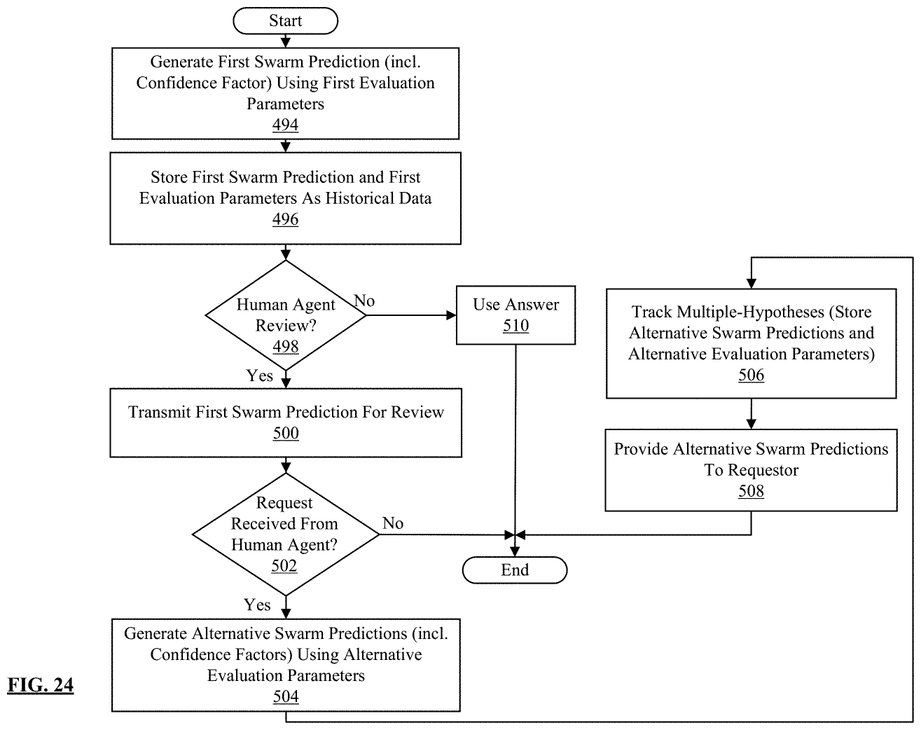

Referring next to FIG. 19 a functional block diagram illustrating a method employing context-based affinity for making predictions/decisions will be discussed in accordance with embodiments of the present invention. As discussed in greater detail below, an affinity of one Bot to another can vary depending on the context of a transaction. As used herein, the context of a transaction refers to the real-world circumstances associated with the transaction. Some examples of a transaction's context include the type of transaction being conducted, the type of user conducting the transaction, a time associated with the transaction, network parameters associated with the transaction, the hardware used to conduct the transaction, and the like. Specifics regarding transaction contexts can be obtained from context value tables and context definition tables, discussed in greater detail with respect to FIGS. 20 and 22. Information linking affinity values for particular swarm members to particular transactional contexts can be obtained from affinity tables, which are discussed in greater detail with respect to FIG. 21.

When evaluating a transaction using context based affinities, data associated with the transaction can be compared to data associated with multiple different contexts to select an affinity value to use based on the context which most closely correlates to the transaction data.

As illustrated by block 438, the affinity of BOT_{TR} to Bot_{Z} in a first context is determined. This affinity is designated as AffinityC1_{TR-Z}, and can be determined and stored in one or more affinity tables in accordance with the procedure described in FIG. 18. In at least one embodiment, each transaction will be associated with historical transaction data that defines the context of the transaction. But AffinityC1_{TR-Z} can also be determined by varying one or more pieces of historical transaction data to alter the actual context of the transaction. In this way BOT_{TR} can establish affinities for use with never-before-encountered contexts, to evaluate the effect of different contexts on affinity values used by BOT_{TR}, or to train BOT_{TR} to make predictions for transactions having a desired context.

As illustrated by block 440, AffinityC1_{TR-Z} can be stored in one or more affinity tables. An affinity table can be stored locally in a memory of a computing device 25 used to implement BOT_{TR}, in a swarm memory, such as one of the data sources 150, accessible to multiple swarm members, or in some combination thereof. In some embodiments, each swarm member maintains its own affinity table, while in other implementations one or more swarm members stores a primary affinity table for itself, and backup affinity table that contains affinity information used by other swarm members. When an affinity table stored by one swarm member includes information also stored in another swarm member's affinity table, the swarm members can periodically or occasionally synchronize their affinity tables, synchronize their affinity tables in conjunction with a training event or a transaction evaluation, or the like. In at least one embodiment, an affinity table maintained locally by a swarm member is designated as the master, and assumed to have the correct information. In other implementations a master affinity table is centrally maintained, and a locally stored affinity table is updated to match the master affinity table.

As illustrated by block 442, a second context is determined, and designated as AffinityC2_{TR-Z}. As illustrated by block 444, AffinityC2_{TR-Z} is stored in the affinity table. In some embodiments, AffinityC1_{TR-Z} and AffinityC2_{TR-Z} have been previously determined, and are already stored in one or more affinity tables. In such implementations, determining the affinities in context 1 and context 2 can be accomplished by simply reading AffinityC1_{TR-Z} and AffinityC2_{TR-Z} from an affinity table. The storing step can be bypassed.

As illustrated by block 446, a transaction to be evaluated is received. The transaction to be evaluated can be a financial transaction, a route determination transaction, a malicious content detection transaction, or some other service transaction. As illustrated by block 448, a check is made to determine if the transaction being evaluated matches the first context, designated as Context1. The transaction matches Context1 when data associated with the transaction indicates that the context of the transaction being evaluated matches Context1. For example, assume that Context1 having contextual conditions specifying an Internet purchase transaction of between $100 and $500 made on a mobile device between 6 pm on Thanksgiving and 11:59 the Friday following thanksgiving. Further assume that the transaction being evaluated is for a purchase of a gaming system costing $285, made using an iPhone, at 10 pm on Thanksgiving, the transaction is said to match Context1. If the purchase was for earbuds costing $89, the context of the transaction would not match Context1, and so the result of the evaluation at block 456 would be “No”.

As illustrated by block 450, if the transaction matches Context1, BOT_{TR} will use the affinity value associated with Context1 (AffinityC1_{TR-Z}) to make a cooperative prediction regarding an outcome of the transaction.

As illustrated by block 452, if the Transaction does not match Context1, a check is made to determine if the transaction matches Context2. The transaction matches Context2 when data associated with the transaction indicates that the context of the transaction being evaluated matches Context2. As illustrated by block 454, if the transaction matches Context2, BOT_{TR} will use the affinity value associated with Context2 (AffinityC2_{TR-Z}) to make a cooperative prediction regarding an outcome of the transaction.

As illustrated by block 456, if the transaction does not match either Context1 or Context 2, the affinity associated with the context that more nearly matches the context of the transaction can be used to make the cooperative prediction. The decision about which context is more similar to the transaction being evaluated can be made using various criteria. In some embodiments, the context having the greater number of matching characteristics can be selected as more like the transaction. For example, if the transaction being evaluated matches 3 context characteristics specified by Context1, but 4 context characteristics of Context2, the affinity value associated with Context2 will be used for generating the cooperative prediction.

In some embodiments weighting values can be used, so that weighted characteristic scores associated with Context1 and Context2 are compared to a weighted characteristic score of the transaction. Assume, for example, that both Context1 and Context2 match 3 out of 5 characteristics of the transaction. Further assume that Context1 matches transaction type, payment type, and originating network, and that Context2 matches payment type, originating network, and time zone. If, for purposes of the decision at block 456, the transaction type is assigned a weight of 0.8, payment type is assigned a weight of 0.7, originating network is assigned a weight of 0.3, and time zone is assigned a weight of 0.01, the combined weights assigned to the matching characteristics of Context1 yield a greater number than the combined weights of Context2, so the affinity value associated with Context1 will be selected for use in generating the cooperative prediction.

In some implementations, the decision about which context is more similar to the transaction being evaluated can be based at least in part on specified values of context characteristics. Assume, for example, that Context1 specifies the value of Source Account Type as “Credit Card,” Context2 specifies the value of Source Account Type as “Bank Transfer,” and the transaction being evaluated uses a debit card. The affinity associated with Context1 can be used for making the cooperative prediction in this example, because a debit card transaction is more similar to a credit card transaction than it is to a bank transfer. In at least one example, the similarity decision can be made based on predetermined similarity weightings stored in lookup tables, or the like.

In at least one embodiments, the interactive swarming techniques described herein can be used to decide which context is most like the context of the transaction being evaluated. This can be done by invoking a separate swarm to make the similarity decision.

In other embodiments, not specifically illustrated, if there is not matching context, rather than selecting to use an affinity value associated with one of the existing contexts, a new affinity value can be trained for a context that matches the context of the transaction being evaluated. Alternatively, if there is no matching context, a default affinity value AffinityDefault_{TR-Z} can be used instead of AffinityC1_{TR-Z} or AffinityC1_{TR-Z}.

In yet further embodiments, if there is no matching context, the evaluation can be repeated using broadened criteria. For example, if there is no available location information associated with a transaction, but the contexts specify various locations within the United States, the “Location” context can be ignored.

The techniques described in relationship to FIG. 19 can be expanded for use with any number of contexts. For example, n number of contexts can be evaluated to determine matches, and a most likely matching context can be selected from the n number of contexts.

FIGS. 20A-20D illustrate a Context Values Table in accordance with various embodiments. The Context Values Table that defines potential values for particular Context Elements. The Context Elements column lists transaction elements used to define contexts. The Potential Values column lists allowable values for each transaction element. The Context Values Table can be used in conjunction with a Context Definitions Table, such as the one illustrated in FIG. 21, to define contexts. The values illustrated in the Context Values Table are not exhaustive, and bots tasked with making different types of predictions may use different context elements, different numbers of context elements, and/or break down Context elements to different levels of granularity. For example, a bot tasked with making routing predictions would require more context regarding current and past network performance metrics than would a bot tasked with making decisions regarding malicious content detection. And bots tasked with malicious content detection might require more context related to file metadata parameters than would a bot tasked with deciding whether a transaction is fraudulent.

A copy of a Context Values Table can be stored at the swarm level, at the bot level, or both. Storing a Context Values Table at the swarm level, or at another centralized location accessible to each swarm member, can make it easier to make global changes, but storing the Context Values Table by each bot individually can reduce network traffic in some cases. In embodiments where the swarm members are part of a mesh network, changes can be easily propagated throughout the swarm.

FIG. 21 illustrates a Context-Definition Table for BOTB₁, in accordance with embodiments of the present invention. Context Definition Tables can be established on a per-bot basis to define Context Elements that make up particular contexts used by particular swarm members. Context Definition Tables can be used in conjunction with Affinity Tables, illustrated in FIG. 22, for selection of affinities used in making cooperative predictions.

Recall that BOTB₁ uses affinities of BOTB₁ to the other members of the swarm, e.g. BOTB₂-BOTB₇, when making cooperative predictions. Recall also that the affinity of BOTB₁ to other swarm members (Affinity_{B1-BN}) can vary according to the context of a transaction being evaluated, so there may be multiple different affinities between BOTB₁ and each of the other Bots in the swarm. Selecting the proper affinity can include using the Context Definition Table for BOTB₁ in conjunction with the Affinity Table for BOTB₁.

To select the proper affinity value using the Context Definition Table and Affinity Table for BOTB₁, the context of a transaction being evaluated by BOTB₁ is determined by comparing transaction data with the information in Context Definition Table for BOTB₁. Once the Context of the transaction is matched to a context included in the Context Definition Table, the Affinity Table for BOTB₁ is used to cross reference the Context with the affinity value linked to the appropriate swarm member.

Assume, for example, that the transaction being evaluated by BOTB₁ is determined to be a CTXT1 transaction based on the Context Elements listed in Context Definition Table for BOTB₁. Further assume that the affinity of interest is BOTB₁'s affinity to BOTB2, which is designated as Affinity_{B1-B2}. With this information the Affinity Table for BOTB₁ can be used to select an affinity value of −0.3 to use when generating BOTB₁'s cooperative prediction. Note that Affinity Table for BOTB₁ actually provides an entire set of affinity values for a particular context. So continuing with the present example, BOTB₁'s cooperative prediction will be made using the following affinity values: Affinity_{B1-B2}=−0.3; Affinity_{B1-B3}=0.4; Affinity_{B1-B4}=0; Affinity_{B1-B5}=0.9; Affinity_{B1-B6}=0.1; and Affinity_{B1-B7}=0.2.

If the context of the transaction matched CTXT2, the affinity values used by BOTB₁ for generating a cooperative prediction would be: Affinity_{B1-B2}=−0.2; Affinity_{B1-B3}=0.7; Affinity_{B1-B4}=0.1; Affinity_{B1-B5}=0.8; Affinity_{B1-B6}=0.0; and Affinity_{B1-B7}=0.2.

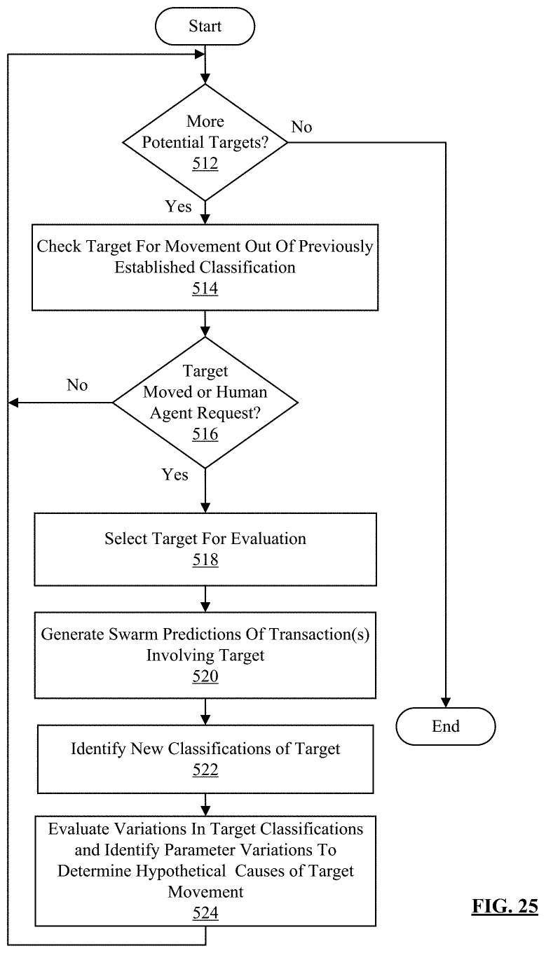

Referring next to FIG. 23, a method of evaluating a transaction request for fraud will be discussed in accordance with embodiments of the present invention.

As illustrated by block 466, a transaction is evaluated by fraud evaluation modules, which are part of fraud detection computing system 16, to generate multiple fraud risk scores associated with the transaction being evaluated. The fraud evaluation modules may be part of a swarm of Bots, such as the swarm illustrated in FIG. 15, and can generate scores independently, cooperatively, or both. The fraud evaluation modules can be executed on one or more computing entities. A computing entity is one or more computing devices, including distributed computing devices such as those used in cloud computing and cloud storage.

Each of the fraud evaluation modules evaluates the transaction us based on current transaction evaluation data associated with the transaction and a set of fraud evaluation protocols. Current transaction evaluation data includes, but is not limited to, any or all of the following: data illustrated in FIG. 4, such as per-user source information, per-user destination information, per device source information, per-device destination information, per-network-and-device source information, and per-network-and-device destination information; data indicating a context of the current transaction; information from data sources 150 (FIG. 5); evidence vectors produced by other fraud evaluation modules or other AI modules, e.g. evidence vectors 125 (FIG. 5) and 202, 204, 206, 208, 242, 244, 246, 248, 250, 252, 270, 272 (FIG. 10). Individual fraud evaluation modules may all use the same set of current transaction evaluation data, different sets of current transaction evaluation data, or overlapping sets of current transaction evaluation data.

A fraud evaluation protocol includes, but is not limited to, specific functions discussed with respect to FIG. 5. For example, any of the functions included in risk assessment toolset 108 and evaluation toolset 106 can be considered to be fraud evaluation protocols. Fraud evaluation protocols may be used globally by each fraud evaluation module, or different fraud evaluation modules may use different fraud evaluation protocols. For example, a first fraud evaluation module can execute a first fraud evaluation protocol using a first set of current transaction data, and a second fraud evaluation module can execute a second evaluation protocol using a second set of current transaction data.

Fraud Evaluation Protocols can, in some cases, specify various weighting factors to be applied to data associated with different data sources, evidence vectors, contexts, and the like. Fraud Evaluation Protocols can also specify which fraud evaluation modules to be included in a swarm decision or prediction, weighting values to be assigned to predictions of various fraud evaluation modules, and an amount of processing resources to dedicate to evaluating a particular transaction, transactions of a particular types, or transactions having particular contexts. Similarly, Fraud Evaluation Protocols can limit or specify an amount or type of network resources that will be used by fraud detection computing system 16 to evaluate particular transactions, transactions of a specified type, or transactions associated with one or more specified contexts. Resource allocations may be specified or limited on Bot-by-Bot basis, on swarm-by-swarm basis, on a system-wide basis, or some combination thereof. Various resource allocations can also be time, location, or requestor specific, and can be varied dynamically based on current or anticipated resource availability.

As illustrated by block 468, a fraud risk assessment answer is generated using the fraud risk scores. In at least one embodiment, fraud risk scores generated by individual bots are provided to a swarm consensus module 364 (FIG. 15), which generates a consensus prediction based on the individual Fraud Risk scores. This consensus prediction is sometimes referred to herein as a fraud evaluation answer, which in some embodiments is provided in the form of a swarm-level fraud risk score. In other embodiments, a fraud evaluation answer takes the form of a trinary decision indicating that the transaction being evaluated is 1) fraudulent, 2) non-fraudulent, or 3) requires further review.

As illustrated by block 470, a score evaluation module determines the reliability of the fraud evaluation answer using various techniques described herein. A swarming evaluation for optimal convergence module illustrated in FIG. 12c, is an example of a score evaluation module. In at least one embodiment, the fraud evaluation answer is evaluated using confidence factors, such as those discussed with respect to FIGS. 9e-9h. For example, if the fraud evaluation answer generated by the swarm consensus module 364 falls within a predetermined range of confidence values, the fraud evaluation answer is assumed to be unreliable, while a fraud evaluation answer falling outside of that predetermined range of confidence values is assumed to be reliable. Note that a fraud evaluation answer may be determined to be reliable, even though one or more individual fraud risk scores are determined to be unreliable, and vice-versa.

In some implementations, for example where the fraud evaluation answer is one of: 1) fraudulent, 2) non-fraudulent, or 3) further review needed, the fraud evaluation answer is considered to be reliable if all relevant scores match the fraud evaluation answer. Assume, for example, that the fraud evaluation answer indicates that the transaction being evaluated is non-fraudulent. Further assume that the fraud evaluation answer is based on the input from five different fraud evaluation modules. If all five relevant fraud evaluation modules generate Fraud Risk scores indicating that the transaction is non-fraudulent, the fraud evaluation answer is deemed reliable. Conversely, if one or more of the five relevant fraud evaluation modules generates a Fraud Risk score indicating that the transaction is fraudulent, a fraud evaluation answer of “non-fraudulent” will not be considered to be reliable.

In various implementations, relevant fraud assessment modules are limited to those modules generating Fraud Risk scores satisfying a threshold confidence level. Thus, in the above example, if the Fraud Risk scores of 5 fraud evaluation modules are used to generate the fraud evaluation answer, but only 4 of the fraud evaluation modules generate Fraud Risk scores that satisfy the threshold confidence level, only those four fraud evaluation modules are considered relevant for purposes of determining reliability. The threshold confidence level is, in at least one embodiment, based on system fraud tolerances 132 (FIG. 5).

If it is determined at block 470 that the fraud evaluation answer is reliable, then the method proceeds to block 492, where the reliable fraud evaluation answer is output. However, if the fraud evaluation answer is unreliable, a set of fraud evaluation modules retrieves a set of fraud assessment records from a fraud assessment database 19 (FIG. 3), as illustrated by block 472.

The set of fraud evaluation modules includes one or more fraud evaluation modules used to generate the fraud evaluation answer. The set of fraud assessment records includes one or more records stored in the fraud assessment database, and can include, but is not limited to, contextual information, historical evaluation results of one or more fraud evaluation modules, user data, device data, network data, bad actor data, fraud type data, system use data, evidence vectors, scores, historical cooperative or expert predictions associated with individual fraud evaluation modules, historical swarm predictions, affinity data, weighting factors, system tolerances, outcome data indicating historical transaction success or failure, reliability scores, and adjustment information indicating types and magnitudes of adjustments made to parameters and functions used to reach a current or historical fraud evaluation answers.

As illustrated by block 474, the set of fraud evaluation modules adjusts the set of fraud evaluation protocols used to reach the fraud assessment answer. Adjusting the set of protocols can include: adjusting one or more weighting factors that were applied to individual data items or to multiple data items based on the type of data item; selecting additional data items from consideration, removing data items from consideration; adding or removing one or more fraud evaluation modules included in the swarm used to generate the fraud assessment answer; altering affinity values; adjusting context parameters by increasing or decreasing the granularity of context associations; and using additional, fewer, or alternate data sources; selecting a predetermined secondary set of protocols, or some combination of these items.

The set of fraud evaluation modules can make the necessary decisions regarding which adjustments to make to the protocol and how those adjustments are to be implemented. The decisions can be made based on previous success or failure associated with each potential adjustment. In some embodiments, each individual fraud evaluation makes an independent decision, and self-adjusts its own protocols. In other embodiments, the entire set of fraud evaluation modules generates a consensus decision regarding adjustments, and the fraud evaluation modules, or a coordinating module associated with a swarm of fraud evaluation implement the consensus decision.

As illustrated by block 476, the set of fraud evaluation modules generates a set of adjusted fraud risk scores based on the set of current transaction evaluation data and the set of adjusted fraud evaluation protocols, and an adjusted fraud assessment answer is generated using the adjusted fraud risk scores, as shown by block 478.

As illustrated by block 480, the score evaluation module determines whether the adjusted fraud risk scores provide a reliable fraud evaluation answer. If so, the reliable fraud assessments answer is output at block 492. If, it is determined at block 480 that the second adjusted fraud risk scores do not provide a reliable fraud evaluation answer, the method moves on to block 482, where a score evaluation module determines a convergence factor. In at least one embodiment, the score evaluation module is a swarming evaluation for optimal convergence module (FIG. 12C), and the convergence factor is output by the swarming evaluation for optimal convergence module as a value of swarmed solutions 305 (FIG. 12C).

The convergence factor is an indication of whether the fraud assessment answer generated using the adjusted fraud risk scores is closer to being reliable (or farther from being reliable) than the fraud assessment answer generated using the original fraud risk scores. The convergence factor is used as an input to the set of fraud evaluation modules to aid them in making protocol adjustment decisions.

In various embodiments, a convergence factor can be a value between −1 and +1, where a convergence factor of −1 indicates that the fraud assessment answer is becoming less reliable, than the previous fraud assessment answer, and a convergence factor of +1 indicates that fraud assessment answer is becoming more reliable. In other embodiments, the convergence factor can be a value between 0 and 1, where a convergence factor of 0 indicates that the fraud assessment answer has close to a 0% probability of being reliable, while a convergence factor of 1 indicates a nearly 100% probability of being reliable.

As illustrated by block 484, the set of fraud evaluation modules further adjusts the set of fraud evaluation protocols based on set of fraud assessment records and the convergence factor to produce set of second adjusted fraud evaluation protocols. Further adjusting the set of protocols to produce the set of second adjusted fraud protocols can include: adjusting one or more weighting factors based on a value of the convergence factor; selecting data items or sources based on the convergence factor; selecting fraud evaluation modules based on a value of the convergence factor; altering affinity values based on a value of the convergence factor; adjusting context parameters based on a value of the convergence factor; and selecting a predetermined secondary set of protocols based on a value of the convergence factor.

In at least one embodiment, the convergence factor can be applied as a multiplier, or added to, one or more weighting factors. In other embodiments, a convergence factor table associating different convergence factors with different protocol adjustments is used. For example, a convergence factor of −0.9 may be associated with removal of a first fraud evaluation module, addition of a second fraud evaluation module, and modification of weighting factors associated with a type of data used by two other fraud evaluation modules. Similarly, a convergence factor of +0.2 might be associated with a protocol adjustment that requires use of on additional data source. When used as an additive factor, convergence values might be added to (or subtracted from) weighting factors used to make a previous protocol adjustment. When used as a multiplicative factor, one or more weighting factors could be multiplied by the convergence factor to arrive at a desired weighting factor.

As illustrated by block 486, the set of fraud evaluation modules generates a set of second adjusted fraud risk scores based on the set of current transaction evaluation data and the set of second adjusted fraud evaluation protocols. As shown by block 488, the second adjusted fraud assessment answer is generated using the second adjusted fraud risk scores.

As illustrated by block 490, the score evaluation module determines whether the second adjusted fraud risk scores provide a reliable fraud evaluation answer. If so, the reliable fraud assessments answer is output at block 492. If, it is determined at block 490 that the second adjusted fraud risk scores do not provide a reliable fraud evaluation answer, the method returns to block 482.

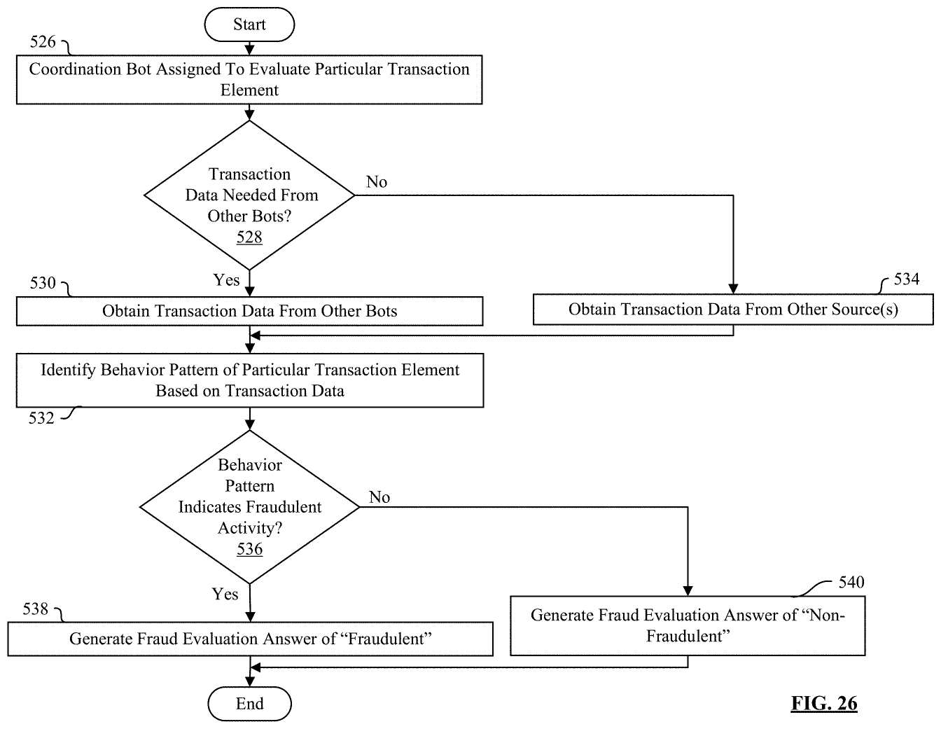

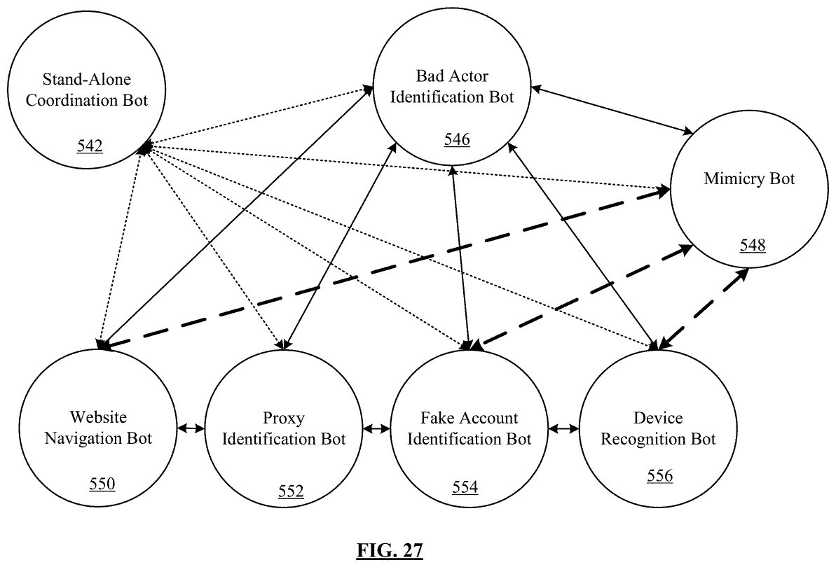

Referring next to FIGS. 24 and 25, multiple hypothesis tracking will be discussed in accordance with various embodiments of the present invention. Multiple hypothesis tracking can be used to improve the speed with which various systems disclosed herein produce a correct automated answer with respect to accepting transactions as non-fraudulent, or conversely rejecting transactions as fraudulent. Multiple hypothesis tracking can also improve the ability of systems disclosed herein to reduce, over time, the number of transactions requiring human agent review. Additionally, when review by a human agent is indicated by a swarm decision, multiple hypothesis tracking can provide a broader scope of data to help those human agents make more informed decisions.

In general, BOTs analyze a transaction first with a set of initial data points and then from one or more sets of adjusted data points. For example, if pointing at a target (e.g., a transaction participant, a data point, etc.) and the target's classification based on the first analysis is different from the target's classification based on the second analysis, the target can be said to have “moved.” When a target moves, the system can generate multiple hypotheses to determine where the target went, and why. Thus, if a transaction participant is classified as a bad actor during one evaluation, but during a second evaluation the target is not identified as a bad actor, longer classified as a bad actor, multiple hypothesis tracking might be used to determine that the bad actor has now been classified as a high-trust seller, and can help determine why the transaction participant has been classified differently by the two evaluations.

In some embodiments, movement of a target will trigger further review by a human agent, but will not change the actions taken by the system. Thus, if a transaction participant has moved from “bad actor,” to “legitimate actor,” but an evaluation of the transaction indicates that the transaction is otherwise legitimate, the transaction will be processed as legitimate, but will also be referred for human agent review. In other embodiments, movement of a target will override the swarm evaluation of the transaction, preventing completion of the transaction and forcing the transaction to be classified as “further review needed.”

Referring specifically to FIG. 24, a method of multiple hypothesis tracking will be discussed in accordance with embodiments of the present invention. As illustrated by block 494, a first swarm prediction and confidence factor, associated with a transaction being processed, are generated by a swarm implemented as part of a determination system, e.g. fraud determination system 16, (FIG. 1). In some embodiments the first swarm prediction inherently includes the confidence factor, while in other implementations the first swarm prediction and the confidence factor are separate items generated as part of the same process, or as part of separate processes. The first swarm prediction is generated using first evaluation parameters. First evaluation parameters can include, but are not limited to, particular data sources, data types, weighting factors, contexts, affinities, convergence factors, thresholds, evidence vectors, scores generated by other swarm members, and the like.

As illustrated by block 496, the first swarm prediction and the first evaluation parameters are stored as historical data in a database, for example in fraud assessment database 19 (FIG. 3). In some embodiments, each fraud evaluation module can store information directly into the database, while in other embodiments a coordinating bot stores information on behalf of the entire swarm, or on behalf of individual fraud assessment modules.

As illustrated by block 498, a check is made to determine if the swarm prediction needs to be reported to a human agent for further review or evaluation. In some embodiments, a swarm prediction of “further evaluation required” will trigger an automated notification to a human agent. In some implementations, determining that one or more target items involved in the transaction have moved will trigger human agent review. In some implementation, information obtained from a human review may indicate movement of the target. Movement of a target item will be discussed in greater detail with respect to FIG. 25.

If no human agent review is required, the method proceeds to block 510, where the swarm prediction (e.g. fraudulent or not fraudulent) is used to output an answer (e.g. accept or reject the transaction) to a requesting computer system, e.g. digital service provider computing system 14 (FIG. 1), which processes the transaction being evaluated in accordance with the answer.

As illustrated by block 500, if human agent review is determined to be necessary at block 498, the first swarm prediction is transmitted for further review by a human agent. In at least one embodiment, transmission of the first swarm prediction includes not only the first swarm prediction per se, but also a transaction identifier and an indication of why the first swarm prediction is being reported for further evaluation. Other information such as a link to one or more historical records storing the context, protocols, data sources, and any other information used to generate the first swarm prediction can also be transmitted in conjunction with the first swarm prediction.

As illustrated by block 502, the fraud detection computing system (or another computing system implementing the teachings set forth herein) may wait for a request for multiple hypothesis tracking from a human agent, or some other system. If no such request is received, the method ends. If, however, the fraud detection computing system receives a request for multiple hypothesis tracking from a human agent, the method proceeds to block 504.

As used herein, the term “multi-hypotheses tracking” refers to a process in which a first swarm prediction is monitored and adjusted to generate one or more alternative swarm predictions using information that may not have been considered when the first swarm prediction was made. In at least one embodiment, for example, a human reviewing a first swarm prediction may believe that the first swarm prediction, or one of the bot predictions used to generate the swarm prediction, is erroneous. In multi-hypothesis tracking, the prediction believed to be erroneous can be stored, and one or more alternative predictions can be generated using input from the human review.

One of the alternative predictions can be substituted for the first swarm prediction without discarding the first swarm prediction. If additional information or testing indicates that the first alternative prediction is not accurate, different information can be used to generate a second alternative prediction, which is substituted for the first alternative prediction, and so on. In some embodiments, the first alternative prediction can be restored if the first alternative prediction is not accurate, while in other embodiments a different alternative prediction can be selected.

As illustrated by block 504, the fraud detection computing system generates alternate swarm predictions using alternative evaluation parameters. Examples of selecting and using alternative evaluation parameters to generate alternative swarm predictions has been previously discussed with reference to FIG. 23. In some implementations, the alternative predictions can be generated based on the first swarm prediction, so that any errors introduced by the first alternative prediction are not carried forward and potentially amplified in any second and subsequent predictions. Thus, multiple alternative swarm predictions can be generated concurrently.

As illustrated by block 506, the fraud detection computing system tracks multiple hypotheses, which includes storing the alternative swarm predictions and the alternative evaluation parameters used to generate the alternative swarm predictions as historical data, for example in fraud assessment database 19.

As illustrated by block 508, the alternative swarm predictions are provided to the human agent or other system that requested the multiple hypothesis tracking. As with the first swarm predictions, providing the alternative swarm predictions includes providing the requestor with the protocols, data sources, contexts, and other information used to obtain the alternative swarm predictions.

The above discussion is focused on swarm predictions, but can also be applied to predictions, or decisions, made by individual Bots. For example, at block 498, a decision can be made to send a score or other output associated with a particular fraud evaluation module for human agent review, even if the overall swarm evaluation is not selected for human agent review. In those implementations, references to swarm predictions in the above disclosure can be understood to apply to predictions, scores, and other outputs generated by individual fraud evaluation modules.

Referring now to FIG. 25, a method of using multiple hypothesis tracking to evaluate changes in a target's classification will be discussed in accordance with embodiments of the present invention. In at least some embodiments, information obtained from human review can be assumed to be a “truth” by which an accuracy of a target's classification is judged.

As illustrated by block 512, a fraud detection computing system determines whether there are potential target items to be tracked. The fraud detection system can make the determination using any or all modules of the various swarm processing tool set 110, risk assessment tool set 108, evaluation tool set 106 (FIG. 5). In some implementations, the decision made at block 512 can be made by a set of fraud evaluation modules during evaluation of a transaction that involves a potential target item, such as during the course of making a decision regarding human agent review (block 498 of FIG. 3). In other instances, the determination can be made in response to a request from a human agent (block 502 of FIG. 3), where the request identifies a transaction, or one or more particular targets associated with the transaction.

When the determination of block 512 is being performed in conjunction with a transaction, it can be performed after a swarm evaluation of the transaction has generated a prediction, e.g. a fraud evaluation answer. Each actor, account, network, or other item evaluated by one or more fraud detection modules in the course of generating a fraud evaluation answer or evidence vector can be considered a potential target item to be tracked, and the method of FIG. 25 can be performed on each potential target item.

As illustrated by block 514, a potential target is checked for movement out of a previously established classification. Movement out of a previously established classification includes for example, a target item being classified as non-fraudulent during evaluation of a current transaction, when during a previous transaction the target item was classified as fraudulent. In at least some embodiments, movement out of a previously established classification includes changes in a target's behavior.

For example, consider a case in which historical data indicates that a particular source account has been classified as fraudulent with respect to multiple prior transactions. The classification as fraudulent may be a fraud evaluation answer that correctly identified the source account as fraudulent. In some implementations, the source account may have initially been incorrectly categorized as non-fraudulent, but changed to a fraudulent classification subsequent to the transaction being processed. In either case, in this example the source account has a history of being classified as fraudulent. If that same source account is predicted to be non-fraudulent by a swarm evaluating a current transaction, the source account's movement from a fraudulent classification to a non-fraudulent classification is an indicator that the source account may have been mis-classified during the current evaluation. Conversely, movement from non-fraudulent to fraudulent may also be an indicator that the current evaluation is erroneous.

As illustrated by block 516, if the target has not moved and evaluation has not been requested by a human agent, the method returns to block 512. If, however, the target has moved, or if a human agent has requested evaluation of the target, the method proceeds to block 518, where the potential target is selected for evaluation.

As illustrated by block 520, multiple swarm predictions of transactions involving the selected target are generated. In the case of predictions related to fraud, one or more fraud evaluation modules obtain historical data related to transactions involving the selected target from, for example, fraud assessment database 19. The historical data can include sets of fraud assessment records, evaluation protocols, contextual records associated with particular transactions, evidence vectors, previous target classifications, information provided by a human during human review, or the like.

The historical data is used by the set of fraud evaluation modules to generate predictions regarding classification of the target, although in some cases the historical classifications do not need to be re-created, but can simply be used. The parameters, protocols, evidence vectors, data sources, affinity values and other inputs. used to evaluate the target's classification with respect to the current transaction (i.e. the classification to which the target has moved) can be compared against the parameters, protocols, evidence vectors, data sources, affinity values, and other inputs. used to evaluate the target's classification with respect to a historical transaction (i.e. the classification from which the target has moved).

In some embodiments, multiple different transaction evaluations, or swarm predictions, are generated by varying a set of fraud evaluation protocols, parameters, and other inputs, in a manner similar to the technique for generating a reliable assessment answer as discussed with respect to FIG. 23. The inputs can be varied by, for example, sequentially varying one or more inputs to one or more swarm modules and recording the results, as well as the inputs, in a temporary cache or in longer term storage (e.g. fraud assessment database 19).

As illustrated by block 522, the new classifications of the target are identified for each of the multiple different transaction evaluations. Each of the new classifications may be the same as the classification from which the target moved, referred to herein is as the historical classification, the same as the classification to which the target moved, referred to herein as the current classification. The new classifications can be determined based on a prediction by one or more Bots included in the swarm of Bots evaluating the transaction.

Assume, for example, that the selected target is a user legitimacy score 218 generated by a core identity module 210 (FIG. 9A). The value of the user legitimacy score associated with one of the new transactions may cause core identity module 210 to the user associated with the user legitimacy score to be classified by a fraud detection computing system as “illegitimate”, while a second user legitimacy score associated with a different new transaction may cause the user to be classified as legitimate.

As illustrated by block 524, one or more modules of swarm processing tool set 110 evaluate parameter variations and variations in the new, historical, and current target classifications to determine one or more hypothetical causes to which the movement of the selected target is likely to be attributed.

Consider, with reference to FIG. 9A, the above example, where the selected target is a user legitimacy score. One of the inputs used by core identity module 210 to generate user legitimacy score 218 is user legitimacy evidence vector 202, which is generated by organization module. Inputs to organization module 200 uses information obtained from data sources 150 to generate user legitimacy evidence vector 202. Recall that the multiple swarm predictions generated at block 520 are generated by varying various parameters, protocols, thresholds, weighting factors, context elements, and the like. Assume, for purposes of this example, that when each historical transaction was evaluated, user data (in data sources 150) was obtained from a first provider, but when the current transaction was evaluated, user data was obtained from a second data provider, different from the first data provider.

In this example, comparing the parameters used in each of the historical transaction evaluations, to the parameters used in the current transaction evaluation, the difference in the provider acting as the source of the user data can be identified as a likely cause of the selected target moving from illegitimate to legitimate.

In at least one embodiment, a limited number of parameters are altered for each transaction evaluation, so that the likely cause of the selected target moving from one category to another can be more easily identified by the swarm processing toolset. Additionally, more than one likely cause of target movement can be identified. For example, if there are five parameters that are different, evaluation of each of those parameters individually and in combination may indicate that only variation of three of the five parameters could have caused the change, and that variation of a combination of two parameters is the most likely cause for movement of the selected target.

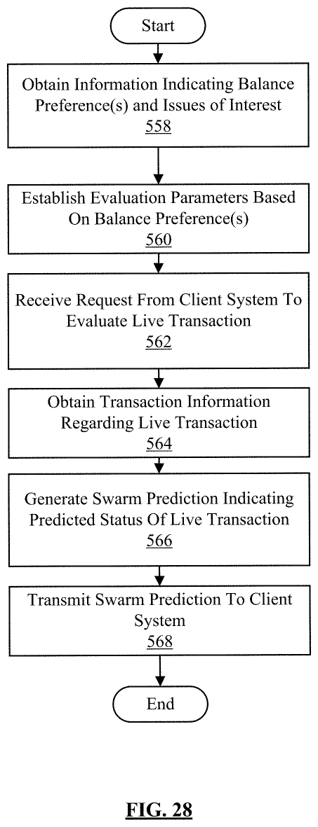

Referring next to FIGS. 26 and 27, generally, communications within a group for data mining and pattern recognition will be discussed. When evaluation transactions for potential fraud, automated recognition of behavior patterns differentiating bad actors and good actors can be important, but also difficult. Bad actors and good actors tend to operate in particular ways, and bad actors attempt to disguise their bad intentions by using software tools to emulate the actions of good actor. Bad actors attempt to disguise themselves by taking over good accounts, by setting up new accounts, etc. But the patterns of bad actors can be recognized over time, so they are constantly changing their patterns of action to remain undetected, or at least to delay detection.

In at least one embodiment, one or more BOTs tests for fraud in other BOTs accessing a system. The test for fraud is based, at least in part, on behavior patterns, rather than only on the location of computing devices (e.g., IP addresses). In various implementations, BOTs track behavior patterns of some to all users, and some to all transactions. Users will have a behavior pattern with respect to navigating a website, and tracking includes determining the timing of page accesses, content viewed on the accessed pages, etc.

In some embodiments, BOTs create a custom module (e.g. another Bot or set of Bots) specific to each user, so that the behavior patterns of each user can be tracked across multiple transactions. N-Gram analysis can be used to evaluate a per URL path to assist with behavior pattern recognition. In various embodiments, actions indicating a bad actor can include website navigation patterns inconsistent with the experience level of the user, for example, new and inexperienced users tend to navigate slowly, and jump between pages more, when compared to experienced users. Thus, if a new users has a website navigation pattern consistent with an experienced user, the Bot assigned to that user may use that pattern as evidence that the user is a bad actor. If a first user mimics behavior patterns of another user too closely in an attempt to blend in, it may be a sign that the first user is a bad actor. Likewise, a user jumping straight to a checkout page may be a sign that the user is a bad actor.

Referring next to FIG. 26, a method of intra-group communication will be discussed in accordance with embodiments of the present invention. As used herein, intra-group communication refers to the ability of individual Bots within a swarm to obtain data from other Bots within the swarm. For example, a first Bot in the swarm, conducting a first evaluation, may need information from a second Bot in the swarm to complete its evaluation. For example, a risky behavior patterns Bot in evaluation tool set 106 may need information from the use of hacker tools Bot in risk assessment tool set 108.

Various implementations use mesh communications for communications within a swarm. Mesh communication can be, but need not be used in conjunction with a coordination bot that functions as a gatekeeper and/or interface between the individual bots of a swarm and various data sources available outside of the swarm. In some embodiments, a “global visibility” technique is employed, in which data used by individual bots in a swarm is saved in a shared memory or other structure that allows access by each of the individual bots. Globally visible information can, in some instances, be visible to multiple different swarms, even if it is not visible to each of the individual bots within those different swarms. The use of global visibility can, but need not, be implemented in conjunction with the use of coordination bots.

As illustrated by block 526, a coordination Bot is assigned to evaluate a particular transactional element. In some implementations, the fraud detection computing system assigns one of the existing modules as the coordination Bot. For example, a bad actor evaluation module 273 (FIG. 9C) may be assigned by fraud detection computing system 16 to determine whether a particular user is a bad actor. In this example, the bad actor evaluation module continues to perform its primary function of generating a bad actor score 274 (FIG. 9C), and also performs coordination functions, including coordinating with other Bots in the swarm to obtain information needed to generate a bad actor score.

In other embodiments, the fraud detection computing system assigns a stand-alone Bot as the coordination Bot, which may be a specialized implementation of the organization module, or guidance and control module included in swarm processing tool set 110 (FIG. 5). In these embodiments, the coordination Bot arranges and coordinates information transfers among other swarm members, assigns tasks to swarm members, and collects and organizes outputs of other swarm members into a coherent prediction, result score, or evidence vector. In some implementations, multiple Bots, referred to herein as a coordination swarm, may be assigned the responsibility of functioning as a unified coordination Bot. Use of the term “coordination Bot” encompasses and includes a coordination swarm, unless otherwise required by the context.

As illustrated by block 528 the coordination Bot determines whether transaction data from other Bots is needed to evaluate the transaction element. This determination can be made based on evaluation protocols that specify inputs needed to evaluate the particular element. Evaluating a transaction element may require data from one or more data sources; scores, predictions, vectors, or other data generated by other Bots, or some combination thereof. In implementations where the coordination Bot is already an expert in evaluating the particular transaction element, the Bot may be pre-programmed with the relevant evaluation protocols, or may obtain the necessary protocols from internal storage, from external storage, from a fraud assessment database, or the like. For example, where bad actor evaluation module 273 is assigned as the coordination Bot, the bad actor evaluation module is already of aware of the relevant evaluation protocols, because it uses those protocols as a matter of course. In implementations where the coordination Bot is a stand-alone Bot, the evaluation protocols can be with obtained from internal storage, from external storage, from a fraud assessment database, or the like.

As illustrated by block 534, if transaction data from other Bots is not needed, to evaluate the particular transaction element, the transaction data is obtained from another source. For example, data can be obtained from any of the data sources 150 (FIG. 5), or data sources included in the pool of data sources 120 (FIG. 3), from a database such as fraud assessment database 19 or user info database 18, and the like.

As illustrated by block 530, if transaction data needs to be obtained from other Bots, the coordination Bot arranges to have the other Bots obtain and transfer it. Obtaining the transaction data can include determining which Bot or other source is able to provide the necessary data based on protocol information stored local to the coordination Bot, or in a memory device accessible to the coordination Bot.

Consider again the case where the coordination Bot is bad actor evaluation module, and is responsible for performing the evaluation of the transaction element. As shown in FIG. 9C, to evaluate an actor associated with a transaction (i.e. the transaction element) and generate bad actor score 274, the coordination Bot (i.e. the bad actor evaluation module) requires bad actor data from data sources 150. The bad actor evaluation module can communicate with organization module 200 to obtain a bad actor evidence vector constructed based on bad actor data from data sources 150. In various embodiments, bad actor evaluation module can send a request for information to organization module 200. The request can include specific data elements to include in the bad actor evidence vector. In other implementations, the organization module will return an evidence vector including preselected data, and the bad actor evaluation module can elect to use all or only a portion of the data included in the evidence vector. Optionally or additionally, bad actor evaluation module 273 can obtain some or all of the bad actor data directly from the data sources.

In embodiments where the coordination Bot is a stand-alone Bot, the coordination Bot can coordinate communications among other Bots by, for example, instructing organizational module 200 to obtain bad actor data, generate a bad actor evidence vector, and to transfer the bad actor evidence vector to bad actor evaluation module 273. Alternatively, the coordination Bot can instruct the bad actor evaluation module to request the bad actor evidence vector from the organization module, and to provide its output (the bad actor score 274) to a multi-mode fusion module (FIG. 9D). Rather than specifically instructing the bad actor evaluation module to request data from the organization module, the coordination Bot can simply instruct the bad actor evaluation module to evaluate a particular actor, causing the bad actor evaluation module to request the bad actor evidence vector from the organization module.

As illustrated by block 532, a behavior pattern of the particular transaction element is identified based on the transaction data. Various techniques for identifying behavior patterns include using multi-hypothesis tracking as discussed with reference to FIGS. 24 and 25, employing N-Gram analysis to evaluate per URL paths, tracking timing associated with web-page navigation, historical analysis and comparison of website navigation actions of one user to navigation actions of other users, and the like. In addition,

N-Gram analysis refers to a contiguous sequence of n items from a given sample, used to predict the next item in the sequence. Consider an example of N-Gram analysis from linguistics. When attempting to predict word missing from the following phrase, “Liberty and (missing word).” To perform an N-Gram analysis on this phrase, historical data indicating how often different phrases including those words are used. Based on a an Internet search of the phrase “Liberty and [blank]” 8 different possibilities or the “blank” were populated in the suggested search terms: justice, justice for all, security, freedom, justice for all essay, responsibility, the pursuit of happiness, the union flag. Using N-Gram analysis would result in selection of the word “justice” as the most likely missing word, because “justice” was the next word in 3 of the 8 prepopulated suggestions.

A similar technique can be used to identify, evaluate, and predict patterns in user behavior. For example, behaviors of any user accessing a particular Uniform Resource Locator (URL) can be recorded as historical data. This historical data can be used to establish a sequence of events that can be used for an N-Gram analysis of user behavior as it applies to that URL. N-Gram analysis can also be applied to timing of interactions of the URL, and to actions across multiple URLS.

As illustrated by block 536, a determination can be made regarding whether the behavior pattern indicates fraudulent activity. For example, a current user's website navigation actions can be compared to the website navigation actions of both known legitimate actors and known illegitimate actors. If N-Gram analysis of historical data indicates that legitimate actors are more likely to navigate from page A to page B, then from page B to page C, and illegitimate actors are more likely to navigate from page A to page B, then from page B to page D, the legitimacy of the current user can be inferred.

As illustrated by block 540, if the result of the determination at block 536 does not indicate fraudulent activity, a fraud evaluation answer of “non-fraudulent” is generated. In some embodiments, the fraud evaluation answer takes the form of a prediction from which a confidence factor can be derived, such as a value whose position within a range of values can be interpreted as a confidence factor. In other embodiments, the fraud evaluation answer includes a prediction plus a separate confidence factor.

As illustrated by block 538, if the result of the determination at block 536 does indicate fraudulent activity, a fraud evaluation answer of “fraudulent” is generated.

Referring next to FIG. 27 communication of data among Bots included in a swarm will be discussed in accordance with embodiments of the present invention. The communications discussed with respect to FIG. 27 can used to facilitate data mining and pattern recognition.

The swarm illustrated in FIG. 27 includes a stand-alone coordination Bot 542, a bad actor identification Bot 546, a mimicry Bot 548, a website navigation Bot 550, a proxy identification Bot 552, a fake account identification Bot 554, and a device recognition Bot 556. The swarm illustrated in FIG. 27 is presented by way of example, and additional or fewer Bots may be included. Furthermore, communication paths to outside data sources and other computational modules, devices, are not illustrated.

Each of the Bots can be implemented in a common computing device, so that all Bots in the swarm benefit from potentially shorter communication times, and the ability to move data quickly from one Bot to another via communication capabilities integrated in a single processor or processing device. In other embodiments, one or more Bots may be implemented on separate processors or processing devices, so that potentially limited computational resources may be distributed, allowing evaluations to be performed more efficiently, even if communications must be routed through various network or other communication interfaces linking the separate processors or processing devices

FIG. 27 illustrates use of a stand-alone coordination Bot 542, but the principles discussed herein can also be implemented when another of the illustrated Bots, for example the bad actor identification bot 546 is assigned as the coordination Bot.

In various embodiments, each Bot in the swarm can communicate directly with other Bots by pushing information, polling for information, or responding to queries. In some embodiments, information can be transferred from one Bot to another indirectly. For example, when the Bots are connected via a mesh network, data requests for data, and responses to requests for data can be transmitted by one Bot and forwarded to one or more Bots in the swarm. Thus, if bad actor identification Bot 546 requests data from web site navigation bot 550, the request can be broadcast to multiple Bots in the swarm, and one or more of those other Bots can forward the request to website navigation bot 550. Responses to requests can be similarly transmitted.

One or more of the bots may also communicate with other bots via stand-alone coordination Bot 542. In some implementations, requests for data, responses to requests for data, and the data itself can be transferred through stand-alone coordination Bot 542. Thus, if bad actor identification Bot 546 needs data from website navigation bot 550, the request can be transmitted to stand-alone coordination Bot 542, which will forward the request to navigation bot 550.

In some implementations, a Bot may know that it needs a particular item of data as input, but may not be aware of the source needed to obtain the data. In some such implementations, a request of the needed data is sent to stand-alone coordination Bot 542, which identifies a source from which the particular item of data can be obtained, and forwards the request to the appropriate Bot or external data source. For example, mimicry Bot 548 may need data associated with a current user's website navigation patterns and historical navigation patterns of other users. The mimicry Bot 548 can request the information from stand-alone coordination Bot 542. Stand-alone coordination Bot 542 can determine which Bots in the swarm are most likely to have the information requested—in this example website navigation Bot 550. Stand-alone coordination Bot 542 can forward the request for information to the website navigation Bot 550, and website navigation Bot 550 can obtain the information requested by mimicry Bot 548, and transmit it either directly or indirectly (e.g. via stand-alone coordination Bot 542) to mimicry Bot 548.

A coordination Bot may determine which Bots in the swarm have requested information by polling the other Bots in the swarm. When one of the Bots responds to the coordination Bot indicating that it can provide the information, the responding Bot can obtain the necessary information from outside data sources or from another Bot, and transmit that information to the bot originally requesting the data. If the requested information is not available from one of the Bots in the swarm, coordination Bot 542 can itself obtain the information from an outside data source based on a lookup table or based on evaluation parameters.

When determining which Bots to request data from, either the Bot requiring the data or the coordination Bot can select the appropriate Bot based on an affinity associated with the requesting Bot to other Bots in the swarm, based on a context of a transaction associated with the evaluation, based on the expertise of the other Bots, or the like.

Stand-alone coordination Bot 542 should not be confused with a central controller, which controls execution of all swarm functions. Instead, stand-alone coordination Bot 542 should be understood to be an expert facilitator Bot, which can establish or obtain coordination parameters (a type of evaluation parameter), and facilitate communications and data transfer to, from, between, and among swarm members.

In some embodiments, stand-alone coordination Bot 542 establishes an ad-hoc swarm of Bots, or selects a predefined group of Bots to use for evaluating transactions. For example, a fraud detection computing system may assign stand-alone coordination Bot 542 to coordinate an evaluation of a particular suspected bad actor. Based on the type of evaluation (bad actor), stand-alone coordination Bot 542 can select the group of Bots illustrated in FIG. 27, and coordinate their actions by providing each of the Bots information about swarm membership, evaluation parameters, available data sources, system tolerances, and the like.

In various embodiments, a fraud detection computing system can assign coordination Bots on a per-actor basis in addition to, or in place of, assigning coordination Bots on a per-transaction basis. In some such implementations, the coordination Bot can be provided user identification information that allows the Bot to properly coordinate obtaining information about the user across multiple different transactions.

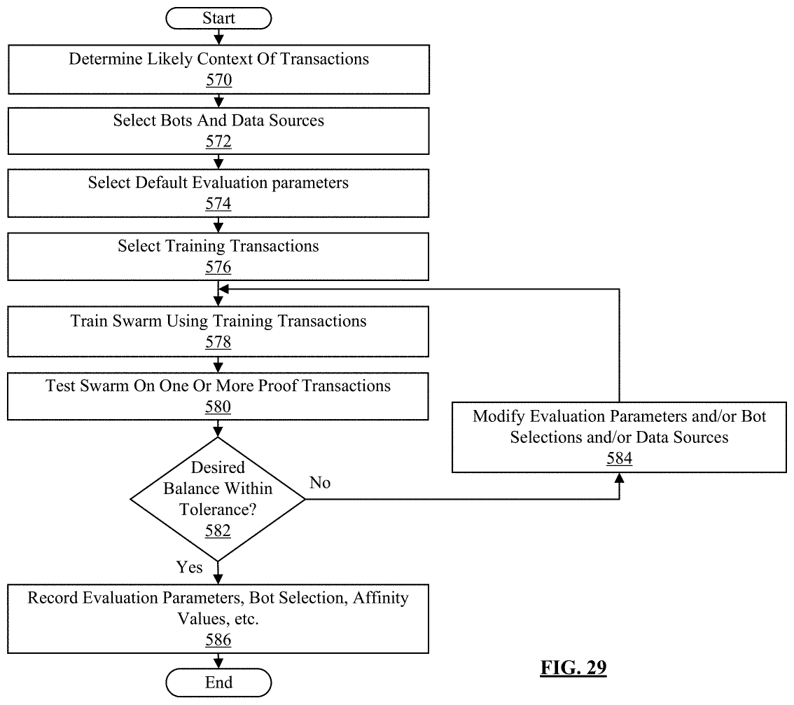

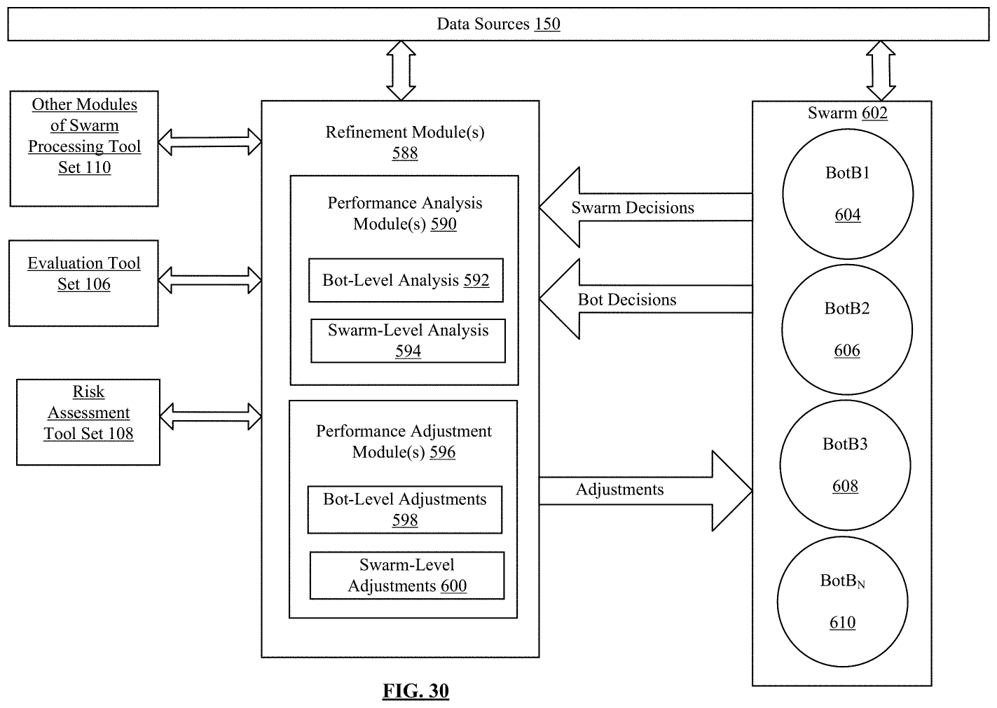

As discuss below with respect to FIGS. 28 and 29, the techniques described herein can be implemented as a fraud detection service. Consider, for example, that conventional fraud detection services used by many on-line-transaction-based companies are not as effective as they could be. For example, some fraud detection services have up to a 10% error rate in fraud detection. Too often those services misidentify bad transactions as acceptable, or acceptable transactions as fraudulent. Additionally, conventional systems are too often unable to reliably identify a transaction as fraudulent or non-fraudulent without further review by human agents. The fraud analysis systems disclosed herein can be interfaced securely with the client's systems, and customized to be commensurate with a client's fraud detection requirements to provide fraud detection services. Those services include, but are not limited to, three primary areas of fraud detection: automated detection of fraudulent account take overs; automated detection of account set up fraud; and automated detection of fraudulent payments. These three primary areas of fraud detection can occur on both sides of a transaction, e.g. buyer-seller, source-destination; initiator-target, etc.

FIG. 28 is a functional block diagram illustrating a method of implementing fraud detection as a service in accordance with embodiments of the present invention. As illustrated by block 558, a fraud detection computing system obtains information indicating a balance preference. As used herein, the term “balance preference” refers to a significance assigned by a user of the fraud detection service to Type 1 and Type 2 errors, relative to each other. Recall that a Type 1 error occurs when a good transaction is blocked, and that a Type 2 error occurs when a bad transaction is not blocked. The balance preference will indicate whether it is more important to ensure that non-fraudulent transactions are not blocked, or to ensure that fraudulent transactions are prevented from being processed.

In some embodiments, a balance preference also includes information indicating an acceptable portion of results indicating a need for human agent review. This acceptable portion of results can be used to establish ranges for positive and negative results that provide the appropriate balance among Type 1 errors, Type 2 errors, and results indicating a need for human review. In some embodiments, if

The fraud detection computer system can obtain the balance preference from a database, such as user information database 18 (FIG. 1), from another digital service, such as digital service 30 or 32 (FIG. 1), from a user computing device such as user computing device 12-1 or 12-2, from a service provider, such as user data verification service provider computing system 22 (FIG. 1) or user computing device verification service provider computing system 24 (FIG. 1). In at least one embodiment, when registering for the fraud detection service, a user will answer questions regarding the balance preference, and fraud detection computing system 16 will assign one or more balance preference values based on the user's answers. In at least one embodiment, answers to the questions provide insight into a user's susceptibility to one or more of the primary areas of fraud (e.g. account take over, account set up, account payment), and to which side of a transaction the user may be susceptible. The balance preference value can be stored in user information database 18.

Balance preferences can be established on a per-user basis, a per-system basis, a per-transaction type basis, a per-transaction basis, a per-context basis, a per-website basis, or the like, and associations with balance preferences can stored in accordance with the basis of the balance preference. In addition, balance preferences can be dependent on primary area of fraud. Thus, for example, a user may prefer to avoid Type 2 errors when evaluating fraudulent account takeovers, but prefer avoiding Type 1 errors when evaluating account set up transactions. Balance preferences may also be dependent on which side of a transaction is being evaluated. For example, a user may prefer to avoid Type 2 errors when evaluating the buyer-side of a transaction, but prefer avoiding Type 1 errors when evaluating the seller-side of a transaction. Balance preferences can also be dependent on multiple bases. For example, a user may prefer to avoid Type 2 errors when evaluating account payments on both the buyer and seller side for purchases of a product from a third party seller, prefer avoiding Type 1 errors when evaluating a transaction source involving media downloads, and have no preference when evaluating a transaction's destination involving media downloads. Other combinations are contemplated to be within the scope of this disclosure.

Balance preferences can affect, among other things, the value of fraud tolerances, fraud evaluation answers, certainty values, reliability values, scores, affinities, weighting factors, assignment of coordination bots, selection of Bots to include in a swarm, selection of data sources, and interpretation of these items. For example, a balance preference can be assigned a value between −1 and +1 with −1 indicating a strong preference for avoiding Type 1 errors, +1 indicating a strong preference for avoiding Type 2 errors, and 0 indicating that avoiding Type 1 errors is of equal importance to avoiding Type 2 errors.

In addition to obtaining a balance preference, fraud detection computing system 16 can also obtain information about issues of interest. As used herein, the term “issues of interest” are specific issues, identified by a user, related to potential fraud detection. Issues of interest can include, for example: logins of transaction actors such as buyers or sellers, and computing logins or devices associated with transaction actors; foraging, which is a technique by which bad actors try different fraud approaches once those actors begin being blocked; modeling techniques; phone number changes; actor registration; and the like.

Information about issues of interest refers to a user's desired approach to handling issues of interest. In general, the information about issues of interests can include instructions defining or limiting certain weighting factors, instructions specifying how particular situations are to be processed, instructions related to pattern recognition factors, instructions related to context, and the like. For example, where “actor login” is specified as an issue of interest, the information about issues of interest can include instructions to allow the login process to be completed for one or more actors, despite the fact that they have been identified as potential bad actors, but to mark those actors for special tracking or handling during later phases of a transaction. The information about actor logins can also instructions to block or allow one or more actors based on specific criteria that may otherwise not be considered in the fraud detection process.

In another example, where “foraging” is specified as an issue of interest, the information about issues of interest can include instructions to allow newly identified bad actions, or types of actions, to be partially or fully completed, and can be accompanied by instructions indicating various thresholds associated with foraging. The thresholds can include, for example, a maximum number of newly identified bad actions to be completed, a maximum percentage of transactions involving a newly identified bad action to be completed, a time period after which a newly identified bad action is no longer considered to be “new”, a transaction value threshold, or the like. Allowing one or more newly discovered bad actions to be processed can allow those actions to more easily and accurately detected in the future.

Where “modeling” is specified as an issue of interest, the information about issues of interest can include information specifying how modeling based on pseudo truths and actual truths are to be performed. As used herein, a pseudo truth refers to initial feedback from and agent based on agent's decision, and a verified truth refers to a verified result of agent's decision. Thus, when a prediction results in a transaction being referred to a human agent, the human agent's decision is a pseudo truth, because the agent's decision could be wrong. A verified truth refers to an agent's decision that has been proven to be correct or incorrect after a transaction has been completed. For example, the actual status of a transaction involving an account takeover may not be verified until a true owner of the account files a complaint.

Where “registration” is specified as an issue of interest, the information about issues of interest can include information specifying interaction parameters and thresholds related to the timing and pattern of actor interactions with a registration interface.

As illustrated by block 560, fraud detection computing system 16 can establish evaluation parameters based on the balance parameters and information about issues of interest. Evaluation parameters, which are used in performing fraud evaluations, can specify data sources, data types, weighting factors, contexts, affinities, convergence factors, thresholds, evidence vectors, scores generated by swarm members, models to be used for evaluating particular types of transactions, types of fraud evaluations to be performed, Bots to use for fraud evaluation, and the like. In general, evaluation parameters used to evaluation transactions for a particular client, or in particular circumstances, can be established by modifying default evaluation parameters in accordance with the balance parameters and information about issues of interest supplied by a user. In various implementations, the balance parameters and information about issues of interest are used to select or exclude particular Bots, used to train expert Bots, used to influence Bot affinities, used to interpret fraud predictions made by individual Bots, used to interpret a fraud evaluation answer, such as a swarm consensus prediction, used to override one or more Bot or swarm predictions, used to determine particular transaction elements to track, or the like. In various embodiments, the evaluation parameters can be previously established, and obtained from storage in, for example, user information database 18 or fraud assessment database (FIG. 3). Various techniques for establishing evaluation parameters will discussed in greater detail with respect to FIG. 29.

In some embodiments, fraud evaluation answers provide by a swarm take the form of a range of numbers from −1 to +1, where greater absolute values indicate greater certainty. In at least one embodiment, an evaluation parameter may indicate that a fraud evaluation answer is to be interpreted so that an answer falling in the range of −1 to −0.2 indicates a Type 1 error, an answer falling in the range of +0.3 to +1 indicates a Type 2 error, and an answer falling in the range of −0.19 to +0.29 indicates further review by human agents. To achieve the balance preference, the parameters can be adjusted to be larger or smaller so that more or fewer outcomes fall within particular ranges.

As illustrated by block 562, the fraud evaluation system receives a request from a client system to evaluate a live transaction, for example transaction 34, 36 or 38 illustrated in FIG. 1. As illustrated by block 564, the fraud evaluation system obtains transaction information regarding the live transaction. The transaction information can include information about actors involved in the transaction, accounts involved in the transaction, a transaction identifier, a transaction type or category, information about related transactions, historical information related to the actors or other elements of the transaction, the context of the transaction, a time threshold associated with the transaction, or the like.

As illustrated by block 566, the fraud evaluation system generates a swarm prediction indicating a status of the live transaction. And, as illustrated by block 568, fraud evaluation system transmits the swarm prediction, e.g. a fraud evaluation answer, to the client system requesting evaluation of the transaction. The client system can then allow or block the transaction in accordance with the fraud evaluation answer.

Referring next to FIG. 29, a method of establishing evaluation parameters will be discussed in accordance with embodiments of the present invention. Evaluation parameters are used by one or more swarms of Bots included in fraud detection computing system to evaluate transactions for fraud, and include but are not limited to, various weighting factors, thresholds, contexts, scores, models, affinities, and the like. Various embodiments discussed herein will pre-establish evaluation parameters for different transaction contexts, transactions for particular clients, and the like. These pre-established evaluation parameters are stored for later use in conjunction with the appropriate transaction. Note that the terms “evaluation protocol” and “evaluation parameter” are used interchangeably herein, and should be considered synonymous, unless otherwise required by context.

As illustrated by block 570, the likely context of a transaction is determined. In some embodiments, the likely context of a transaction is defined, at least in part by a human agent. For example, fraud detection computing system can present a human agent with a list of context elements. The human agent can define a context by selecting particular context elements. In at least some embodiments, the human agent does not need to select specific evaluation parameters for each contextual element, because the evaluation parameters of different context elements are interdependent, and selection of a particular group of, for example three context elements, can result in significantly different evaluation parameters if even one element of that group of three context elements is different. In other embodiments, a human agent can choose among default contexts presented in a list of default contexts. In yet other embodiments, the human agent can be given the ability to modify a default context to create a custom context. This can be especially useful in establishing per-client evaluation parameters or protocols.

In some embodiments, the fraud detection computer system can determine the likely context of a transaction by evaluating transaction information accompanying a transaction evaluation request. For example, fraud detection computer system can parse a request for evaluation to identify actor or actor type identifiers, accounts or account types, timestamps, communication addresses, device identifiers, and other elements of the transaction. The elements of the transaction can be compared to contextual elements included in a context value table, such as the one illustrated in FIGS. 20A-D.

As illustrated by block 572, the fraud evaluation system can select Bots and data resources to be used to evaluate transactions having the likely context determined at block 570. For example, if the likely context matches the context definition table of one or more Bots, those Bots can be selected to be included in the swarm of Bots. Refer back briefly to FIG. 21, which illustrates a context definition table for BotB₁. If the likely context determined at block 570 corresponds to CTXT1, then BotB₁ can be selected at block 572. The context tables of other Bots can also be used as a sort of reverse-lookup, in which Bots associated with contexts matching the likely context can be selected for inclusion in a swarm of Bots.

In some embodiments, the fraud evaluation system can select a coordination Bot, and the coordination Bot can select other Bots to be included in the swarm of Bots that will be used to perform the evaluation. The coordination Bot can be selected based on the type of transaction being evaluated, which is determined as part of the likely context, or selected from a pool of coordination Bots configured to facilitate and coordinate a swarm of bots without itself performing a fraud evaluation.

Data sources can be selected by the Bots chosen for inclusion in the swarm, based on historical data associated with transactions having matching or similar contexts, based on client preferences, or the like. In some embodiments, availability of a data source may be intermittent, and in such cases the coordination Bot, or another module included in fraud detection computing system, can query a data source for availability, data concurrency and completeness, or the like, before selecting that data source for use in the fraud evaluation process.

As illustrated by block 574, the fraud transactions system can select default evaluation parameters. Default evaluation parameters can be selected based on the likely context of a transaction, based on balance preferences and issues of interest, based on historical data associated with similar transactions, based on the Bots and data sources selected, and the like. For example, one Bots affinity to another Bot is an example of an evaluation parameter. Affinity values of each Bot are dependent on context, and can be determined using an affinity table associated with each Bot, such as the affinity table illustrated in FIG. 22. The affinity values of a particular Bot can be maintained by each Bot individually, so that selection of the Bots results in de-facto selection of affinity values. In other embodiments, a coordinating Bot can communicate to each selected Bot affinity values obtained from a database, such as fraud assessment database 19 (FIG. 3). In some embodiments, default evaluation parameters are selected from a lookup table linking particular contexts to particular parameters.

As illustrated by block 576, training transactions are selected. The training transactions can be selected from actual historical transactions similar to the likely context and stored in fraud assessment database 19. But training transactions can also include specially constructed transactions designed to focus on edge cases that might not otherwise be tested by actual transactions. In at least one embodiment, the test transactions include both actual historical transactions and specially constructed transactions. The specially constructed transactions can also be stored in the fraud assessment database 19, or they can be stored in another storage device accessible to the fraud detection computing system 16. In some embodiments, the training transactions can be selected by a coordination bot using a lookup table linking test transactions to particular likely contexts. Test transaction selection can be generated by each client's balance preferences and issues of interest, or even provided by the client in some instances.

As illustrated by block 578, the selected Bots, and the swarm made up of those Bots, are trained using the selected training transactions. Training the Bots will generally result in modification of the default evaluation parameters, as those Bots learn to work together. Examples of Bot training and adjustment of evaluation parameters to allow the swarm to converge on an optimal consensus are discussed with respect to FIG. 17.

As illustrated by block 580, once the swarm is trained, it is tested against one or more proof transactions. These proof transactions generally consist of actual historical transactions having verified outcomes. Ideally the proof transactions will have nearly identical contexts, but if no transactions with nearly identical contexts are available, transactions having the most closely matching contexts can be used. To use the proof transactions, a fraud analysis of the proof transaction by the selected Bots is performed, and the results compared to the known results of the proof transaction. The comparison can include comparing a fraud evaluation result and certainty value generated by the swarm being tested to the verified status of the proof transaction (e.g. fraudulent or non-fraudulent). In addition, the scores and other outputs of individual Bots within the swarm can be compared against the verified status of the proof transaction to evaluate the performance of individual bots.

In at least one embodiment, multiple proof transactions including different error types are used to test the swarm, so that a balance between Type 1 and Type 2 errors can be determined. Recall that a Type 1 error occurs when a good transaction is blocked, and that a Type 2 error occurs when a bad transaction is not blocked.

As illustrated by block 582, a check is made to determine whether an appropriate balance between Type 1 and Type 2 errors has been achieved. If not, as illustrated by block 584, different evaluation parameters, Bots, and/or data sources are selected, and the method returns to block 578. A Bot may be added or removed from the swarm based on that Bot's contribution to the swarm's consensus decision. For example, if multiple Bots have a negative affinity to the Bot in question, i.e. if the Bot in question is not trusted by the other Bots in the swarm to give a correct answer, that Bot can be removed in some cases.

In other cases, a Bot arriving at an incorrect answer may be essential to swarm's consensus. For example, an account takeover Bot cannot be simply removed if the proof transaction was fraudulent due to an account takeover, even if the other Bots in the swarm do not trust the account takeover Bot, or if the account takeover Bot reached the wrong decision. In such circumstances, Bot affinities can be adjusted, different data sources can be used, or the account takeover Bot can be individually retrained in its area of expertise, before retraining the swarm at block 578. In other instances, adding a bad actor Bot, if one is not already present, might improve the swarm's ability to detect account takeover fraud if a user involved in the proof transaction is a known bad actor.

As illustrated by block 586, if the check at block 582 indicates that a desired balance has been achieved, the evaluation parameters, Bot selection, affinity values, etc. can be saved, e.g. in a fraud assessment database for future use evaluating live transactions. Various evaluation parameters can be stored in other locations in addition to, or in place of, storing them in a fraud assessment database. For example, some or all evaluation parameters can be stored local to a coordination Bot, so when that coordination Bot is selected in the future for evaluating a live transaction or for training, it can use that information to perform the evaluation or improve the default parameters selected for training. As another example, the likely context of the transaction, affinities, and identities of other Bots in the swarm can be stored by one or more individual Bots in the swarm, including the coordination Bot.

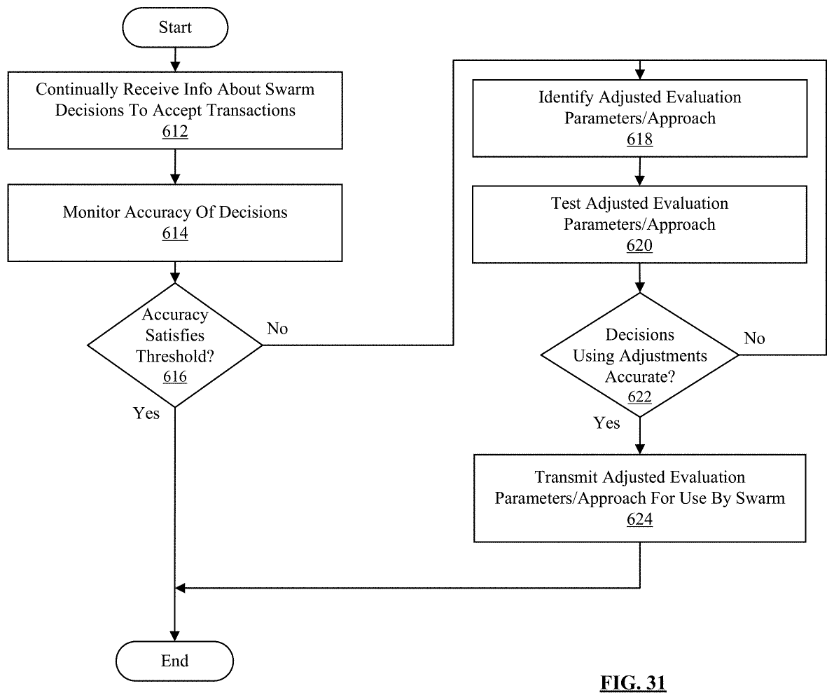

As discussed with respect to FIGS. 30 and 31, various embodiments continually refine evaluation parameters to improve the correctness of auto generated transaction answers and to minimize the number of indeterminant transactions requiring human review. To do this, answers, a fraud detection computing system monitors predictions, scores, and outputs of individual Bots and swarms, and makes adjustments to further improve auto answer accuracy.

In various a performance module analyzer monitors a BOT's accuracy in rendering scores for the auto answer of accept/reject a transaction. If a BOT's accuracy is unsatisfactory, then the BOT's evaluation parameters and/or approach can be updated. A Bot's “approach” refers to the fraud evaluation model or methodology used By a Bot to perform its evaluation. Different models or methodologies can include use of different weighting factors, affinities, thresholds, and the like. In some cases, the model or methodology refers to a type of analysis, such as N-gram analysis, statistical regression, data matching, clustering and classification, gap analysis, or the like.

Additionally, as new data becomes available, such as the discovery of new methods of avoiding fraud detection, the new data can be used to adjust a BOT's evaluation parameters and/or approach. In various embodiments, changes can be made and tested using past decisions known to be accurate.

FIG. 30 is a refinement module will be discussed in accordance with embodiments of the present invention. Refinement module 588 can be part of a swarm processing tool set 110, as illustrated by FIG. 5. Refinement module 588 includes a performance analysis module 590 and a performance adjustment module 596. Performance analysis module 590 includes a bot-level analysis module 592 and a swarm-level analysis module 594. Performance adjustment module 596 includes a bot-level adjustments module 598 and a swarm-level adjustments module 600.

Refinement module 588 can obtain and provide information to data sources 150, other modules of swarm processing toolset 110, evaluation tool set 106, and risk assessment tool set 108. Additionally, refinement module 588 receives swarm decisions from swarm 602; bot decisions generated by BotB1 604, BotB2 606, BotB3 608, and BotB_{N} 610. Adjustments determined by refinement module 588 are delivered to swarm 602 and BotB1 604, BotB2 606, BotB3 608, and BotB_{N} 610.

In operation, refinement module 588 uses swarm-level analysis module 594 to monitor swarm decisions, and Bot-level analysis module 592 to monitor bot decisions. The decisions are monitored to determine whether decisional outcomes are accurate, and to determine if a level of confidence associated with those decisional outcomes satisfies a confidence threshold. For example, swarm-level analysis module 594 is used to determine if swarm decisions are converging on optimal outcomes, and to determine whether the swarm decisions are being made at a high level of confidence.

For a swarm-level decision regarding a transaction to be optimal, the decision should be accurate-in-fact. To monitor accuracy-in-fact of swarm decisions, refinement module 588 obtains swarm decisions from swarm 602, and stores them in a database of historical transaction data, such as fraud assessment database 19 (FIG. 3), or in some other data source 150, in addition to performing additional processing on the swarm decisions using swarm-level analysis module 594.

In some embodiments, refinement module 588 may save an identifier associated with one or more swarm decisions, and periodically query data sources 150 to determine whether a verified transaction result associated with the identifier has been recorded in the historical data, and if so retrieves the verified transaction result. Refinement module 588 uses swarm-level analysis module 594 to compare the swarm decision to the verified transaction result, and marks the swarm decision as accurate-in fact if they match. In some embodiments, refinement module 588 can send one or more data sources a batch query to retrieve verified transaction results for multiple transactions. In other embodiments one or more data sources may push information to refinement modules. Refinement module 588 can also request information from data sources 150 in response to a human agent evaluation request, or in response to a request from another element of swarm processing tool set 110, evaluation tool set 106, or risk assessment tool set 108.

For a swarm-level decision to be optimal, the decision should not only be accurate, but should have a high confidence level, and satisfy balance preferences and issues of interest. For example, if a decision barely satisfies a threshold confidence level, it may be considered to be non-optimal. Thus, in some embodiments a minimum confidence level can be used by the swarm in making its predictions, but a stricter confidence level may be used by refinement module 588 in deciding whether the decision is optimal.

To decide whether swarm decisions generated by swarm 602 satisfy balance preferences and issues of interest, multiple swarm decisions must be evaluated to determine if the proportion of decisions that represent Type 1 errors, Type 2 errors, and human agent review decisions is correct. If the swarm decisions generated by swarm 602 are optimal, no retraining at the swarm level is needed. If, however, the swarm decisions are less than optimal, refinement module 588 can use swarm-level adjustments module 600 to make swarm level adjustments.

Bot-level analysis module 592 can determine whether Bot decisions are accurate in a manner similar to that used by swarm-level analysis module 594 to determine the accuracy of swarm decisions. Inaccurate bot decisions, or bot decisions with low confidence levels, can trigger refinement module 588 to perform bot-level adjustments using bot-level adjustments module 598.

Bot decisions can be incorrect or be associated with low confidence levels, even when swarm decisions are optimal. In some such cases, as long as the swarm decisions are optimal, individual bot decisions may be ignored, or be evaluated using less stringent thresholds. However, in at least one embodiment, bot-level adjustments are made to any bot that issues incorrect decisions, or decisions with low confidence levels.

Performance adjustment module 596 can determine either or both bot-level adjustments and swarm-level adjustments, and deliver the adjustments to swarm 602 and one or more bots included in swarm 602. In at least one embodiment, a coordination bot can serve as an interface between each of the bots in swarm 602, and refinement module 588. In that case, adjusted evaluation parameters for both the swarm and the individual bots can be transmitted to the coordination bot, which then distributes the adjusted evaluation parameters as needed with swarm 602. In other implementations, refinement module 588 provides adjusted evaluation parameters directly to the individual bots within swarm 602.

Referring next to FIG. 31, a method of refining predictions is discussed in accordance with embodiments of the present invention. As illustrated by block 612, a refinement module continually receives information about swarm predictions related to transaction acceptance. The information can be pushed to the refinement module, sent to the refinement module in response to a query, or otherwise. In addition to, or in place of, receiving information directly from a swarm, the information can be stored in temporary or long term storage by one or more data sources, which can then provide the information to the refinement module.

As illustrated by block 614, the information obtained by the refinement module is used to monitor the accuracy of individual swarm predictions, individual bot predictions, or both. In at least one embodiment, the accuracy of a swarm prediction can be determined by comparing a swarm prediction to a verified transaction result obtained from a data source storing historical transaction data. In addition to prediction accuracy, swarm predictions can also be evaluated collectively to determine if the decisions are optimal.

As illustrated by block 616, a determination is made regarding whether or not the swarm predictions satisfy an accuracy threshold. The accuracy threshold can be set based on how many swarm predictions are accurate, based on how many swarm predictions are inaccurate, based on how many swarm predictions require further review by a human agent, based on a confidence level of one or more swarm predictions, based on whether a set of swarm predictions satisfies balance preferences, based on whether one or more swarm predictions are consistent with issues of interest, human agent input, or some combination thereof. In at least one embodiment, an accuracy threshold of 99% or greater is used.

Data used to determine the accuracy can include decisions from individual bots, user data, device data, network data, bad actor data, fraud type data, system use data confidence levels associated with predictions, balance preferences and issues of interest supplied by a user or client, and the like.

As illustrated by block 618, adjusted evaluation parameters and/or an adjusted evaluation approach are identified. Adjusted evaluation parameters and approaches can be identified by adjusting one or more evaluation parameters by a set percentage up or down, by selecting individual or sets of evaluation parameters and/or approaches from similar transactions that are more accurate, or by adjusting one or more evaluation parameters based on convergence factors, as discussed with respect to FIG. 23.

As illustrated by block 620, the adjusted evaluation parameters and approach are tested against one or more proof transactions, as discussed with reference to FIG. 29. In some cases, the proof transaction can include the original transaction. Evaluating the same transaction with both the adjusted evaluation parameters and the original evaluation parameters can provide insight into the effects of particular evaluation parameter changes. Note that in some embodiments, a limited number of evaluation parameters can be changed to make it easier to identify the most effective parameter and/or approach adjustments.

As illustrated by block 622, if the adjusted evaluation parameters do not produce a prediction that satisfies the accuracy threshold, the method returns to block 618, where further parameter adjustments are identified.

As illustrated by block 624, if the adjusted evaluation parameters produce a result that satisfies the accuracy threshold, the adjusted evaluation parameters and/or approaches can be transmitted for use by a swarm in generating swarm predictions.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for evaluating a transaction request for fraud, the method comprises:
generating, by a plurality of fraud evaluation modules, a plurality of fraud risk scores based on current transaction evaluation data of the transaction, wherein a first fraud evaluation module of the plurality of fraud evaluation modules executes a first fraud evaluation protocol utilizing a first set of the current transaction evaluation data to produce a first fraud risk score of the plurality of fraud risk scores;
determining, by a score evaluation module, whether the plurality of fraud risk scores provide a reliable fraud evaluation answer;
when the plurality of fraud risk scores does not provide a reliable fraud evaluation answer:
accessing, by a set of fraud evaluation modules of the plurality of fraud evaluation modules, a fraud assessment database to retrieve a set of fraud assessment records;
adjusting, by the set of fraud evaluation modules, a set of fraud evaluation protocols based on the set of fraud assessment records to produce a set of adjusted fraud evaluation protocols;
generating, by the set of fraud evaluation modules, a set of adjusted fraud risk scores based on the current transaction evaluation data and the set of adjusted fraud evaluation protocols;
determining, by the score evaluation module, whether the set of adjusted fraud risk scores provides the reliable fraud evaluation answer; and
when the set of adjusted fraud risk scores provides the reliable fraud evaluation answer, outputting, by the score evaluation module, the reliable fraud evaluation answer.

2. The method of claim 1, wherein the accessing the fraud assessment database further comprises:
generating, by the set of fraud evaluation modules, a set of queries based on the current transaction evaluation data; and
executing, by the set of fraud evaluation modules, the set of queries to retrieve a set of related fraud assessment records.

3. The method of claim 2 further comprises:
extracting, by the first fraud evaluation module, a first set of relevant data of the current transaction evaluation data in accordance with the first fraud evaluation protocol or an adjusted first fraud evaluation protocol;
generating, by the first fraud evaluation module, a first query of the set of queries based on the first set of relevant data; and
executing, by the first fraud evaluation module, the first query to produce a first sub-set of the set of related fraud assessment records.

4. The method of claim 1 further comprises:
when the set of adjusted fraud risk scores does not provide a reliable fraud evaluation answer:
determining, by the score evaluation module, whether the set of adjusted fraud risk scores has a positive or negative convergence factor;
adjusting, by the set of fraud evaluation modules, the set of adjusted fraud evaluation protocols based on the set of fraud assessment records and the positive or negative convergence factor to produce a set of second adjusted fraud evaluation protocols;
generating, by the set of fraud evaluation modules, a set of second adjusted fraud risk scores based on the current transaction evaluation data and the set of second adjusted fraud evaluation protocols;
determining, by the score evaluation module, whether the set of second adjusted fraud risk scores provides the reliable fraud evaluation answer; and
when the set of second adjusted fraud risk scores provides the reliable fraud evaluation answer, outputting, by the score evaluation module, the reliable fraud evaluation answer.

5. The method of claim 1 further comprises:
executing, by a second fraud evaluation module of the plurality of fraud evaluation modules, a second fraud evaluation protocol utilizing a second set of the current transaction evaluation data to produce a second fraud risk score of the plurality of fraud risk scores.

6. The method of claim 1, wherein the determining whether the plurality of fraud risk scores provides the reliable fraud evaluation answer comprises:
receiving, by the score evaluation module, the plurality of fraud risk scores;
filtering, by the score evaluation module, the plurality of fraud risk scores to produce a set of relevant fraud risk scores; and
performing, by the score evaluation module, a convergence function on the set of relevant fraud risk scores to determine whether the plurality of fraud risk scores provides the reliable fraud evaluation answer.

7. The method of claim 1, wherein the executing the first fraud evaluation protocol comprises executing at least one of the following protocols to generate the first fraud risk score:
an account-take-over protocol, a collusion protocol, a professional-bad-actor protocol, a behavior-pattern-being-an-attack protocol, a use-of-hacker-tools protocol, a zero-day-anomaly-is-an-attack protocol, a fake-account-registration protocol, a fraudulent-login-protocol, a weight-of-evidence protocol, a device-recognition protocol, an emergent-detection protocol, an external-interfacing protocol, a risky-behavior-patterns-protocol, a familiarity-detection protocol, an optimal-decision protocol, a multi-module-fusion protocol, a core-identity protocol, a rule-decay protocol, or an IP-proxy protocol.

8. The method of claim 1, wherein the adjusting the set of fraud evaluation protocols comprises:
adjusting, by the first fraud evaluation module, the first fraud evaluation protocol based on a first sub-set of the set of fraud assessment records to produce a first adjusted fraud evaluation protocol wherein the first fraud evaluation module is in the set of fraud evaluation modules.

9. The method of claim 8 further comprises:
analyzing the first sub-set of the set of fraud assessment records for fact patterns similar to a fact pattern of the current transaction evaluation data to produce prioritized relevant fraud assessment records;
determining accuracy classifications of prioritized relevant fraud assessment records;
determining a plurality of sets of fraud risk scores from the prioritized relevant fraud assessment records;
comparing the plurality of sets of fraud risk scores with the plurality of fraud risk scores to produce a plurality of fraud risk score differences;
scaling the plurality of fraud risk score differences based on the accuracy classifications to produce a plurality of scaled fraud risk score differences; and
adjusting the first fraud evaluation protocol based on the plurality of scaled fraud risk score differences.

10. A computer readable storage device comprises:
a first memory section that stores operational instructions that, when executed by a computing entity of a data transactional network, causes the computing entity to:
generate, by a plurality of fraud evaluation modules, a plurality of fraud risk scores based on current transaction evaluation data of the transaction, wherein a first fraud evaluation module of the plurality of fraud evaluation modules executes a first fraud evaluation protocol utilizing a first set of the current transaction evaluation data to produce a first fraud risk score of the plurality of fraud risk scores;
a second memory section that stores operational instructions that, when executed by a computing entity of a data transactional network, causes the computing entity to:
determine, by a score evaluation module, whether the plurality of fraud risk scores provide a reliable fraud evaluation answer;
the first memory section further storing operational instructions that, when executed by a computing entity of a data transactional network, causes the computing entity to:
when the plurality of fraud risk scores does not provide a reliable fraud evaluation answer:
access, by a set of fraud evaluation modules of the plurality of fraud evaluation modules, a fraud assessment database to retrieve a set of fraud assessment records;
adjust, by the set of fraud evaluation modules, a set of fraud evaluation protocols based on the set of fraud assessment records to produce a set of adjusted fraud evaluation protocols;
generate, by the set of fraud evaluation modules, a set of adjusted fraud risk scores based on the current transaction evaluation data and the set of adjusted fraud evaluation protocols;
the second memory section further storing operational instructions that, when executed by a computing entity of a data transactional network, causes the computing entity to:
determine, by the score evaluation module, whether the set of adjusted fraud risk scores provides the reliable fraud evaluation answer; and
the first memory section further storing operational instructions that, when executed by a computing entity of a data transactional network, causes the computing entity to:
when the set of adjusted fraud risk scores provides the reliable fraud evaluation answer, outputting, by a score evaluation module, the reliable fraud evaluation answer.

11. The computer readable storage device of claim 10, wherein the first memory section further stores operational instructions that, when executed by a computing entity of a data transactional network, causes the computing entity to:
generate, by the set of fraud evaluation modules, a set of queries based on the current transaction evaluation data; and
execute, by the set of fraud evaluation modules, the set of queries to retrieve a set of related fraud assessment records.

12. The computer readable storage device of claim 11, wherein the first memory section further stores operational instructions that, when executed by a computing entity of a data transactional network, causes the computing entity to:
extract, by the first fraud evaluation module, a first set of relevant data of the current transaction evaluation data in accordance with the first fraud evaluation protocol or an adjusted first fraud evaluation protocol;
generate, by the first fraud evaluation module, a first query of the set of queries based on the first set of relevant data; and
execute, by the first fraud evaluation module, the first query to produce a first sub-set of the set of related fraud assessment records.

13. The computer readable storage device of claim 10 further comprises:
when the set of adjusted fraud risk scores does not provide a reliable fraud evaluation answer:
the second memory section further stores operational instructions that, when executed by a computing entity of a data transactional network, causes the computing entity to:
determine, by the score evaluation module, whether the set of adjusted fraud risk scores has a positive or negative convergence factor;
the first memory section further stores operational instructions that, when executed by a computing entity of a data transactional network, causes the computing entity to:
adjust, by the set of fraud evaluation modules, the set of adjusted fraud evaluation protocols based on the set of fraud assessment records and the positive or negative convergence factor to produce a set of second adjusted fraud evaluation protocols;
generate, by the set of fraud evaluation modules, a set of second adjusted fraud risk scores based on the current transaction evaluation data and the set of second adjusted fraud evaluation protocols;
the second memory section further stores operational instructions that, when executed by a computing entity of a data transactional network, causes the computing entity to:
determine, by the score evaluation module, whether the set of second adjusted fraud risk scores provides the reliable fraud evaluation answer; and
when the set of second adjusted fraud risk scores provides the reliable fraud evaluation answer, the second memory section further stores operational instructions that, when executed by a computing entity of a data transactional network, causes the computing entity to output, by the score evaluation module, the reliable fraud evaluation answer.

14. The computer readable storage device of claim 10, further comprising:
a third memory section storing operational instructions that, when executed by a computing entity of a data transactional network, causes the computing entity to:
execute, by a second fraud evaluation module of the plurality of fraud evaluation modules, a second fraud evaluation protocol utilizing a second set of the current transaction evaluation data to produce a second fraud risk score of the plurality of fraud risk scores.

15. The computer readable storage device of claim 10, wherein the second memory section further stores operational instructions that, when executed by a computing entity of a data transactional network, causes the computing entity to:
receive, by the score evaluation module, the plurality of fraud risk scores;
filter, by the score evaluation module, the plurality of fraud risk scores to produce a set of relevant fraud risk scores; and
perform, by the score evaluation module, a convergence function on the set of relevant fraud risk scores to determine whether the plurality of fraud risk scores provides the reliable fraud evaluation answer.

16. The computer readable storage device of claim 10 further comprises:
at least one memory section storing operational instructions that, when executed by a computing entity of a data transactional network, causes the computing entity to execute at least one of the at least one of the following protocols:
an account-take-over protocol, a collusion protocol, a professional-bad-actor protocol, a behavior-pattern-being-an-attack protocol, a use-of-hacker-tools protocol, a zero-day-anomaly-is-an-attack protocol, a fake-account-registration protocol, a fraudulent-login-protocol, a weight-of-evidence protocol, a device-recognition protocol, an emergent-detection protocol, an external-interfacing protocol, a risky-behavior-patterns-protocol, a familiarity-detection protocol, an optimal-decision protocol, a multi-module-fusion protocol, a core-identity protocol, a rule-decay protocol, or an IP-proxy protocol.

17. The computer readable storage device of claim 10, wherein the first memory section further stores operational instructions that, when executed by a computing entity of a data transactional network, causes the computing entity to:
adjust, by the first fraud evaluation module, the first fraud evaluation protocol based on a first sub-set of the set of fraud assessment records to produce a first adjusted fraud evaluation protocol wherein the first fraud evaluation module is in the set of fraud evaluation modules.

18. The computer readable storage device of claim 17 wherein the first memory section further stores operational instructions that, when executed by a computing entity of a data transactional network, causes the computing entity to:
analyze the first sub-set of the set of fraud assessment records for fact patterns similar to a fact pattern of the current transaction evaluation data to produce prioritized relevant fraud assessment records;
determine accuracy classifications of prioritized relevant fraud assessment records;
determine a plurality of sets of fraud risk scores from the prioritized relevant fraud assessment records;
compare the plurality of sets of fraud risk scores with the plurality of fraud risk scores to produce a plurality of fraud risk score differences;
scale the plurality of fraud risk score differences based on the accuracy classifications to produce a plurality of scaled fraud risk score differences; and
adjust the first fraud evaluation protocol based on the plurality of scaled fraud risk score differences.

19. A method comprising:
evaluating a transaction to identify potential fraud related to a first aspect of the transaction using a first swarm member to generate a first cooperative prediction related to the first aspect of the transaction, wherein the first cooperative prediction is based, at least in part, on a first affinity value, and wherein the first affinity value represents a weight afforded by the first swarm member to predictions generated by one or more other swarm members with respect to the transaction;
evaluating the transaction to identify potential fraud related to a second aspect of the transaction using a second swarm member to arrive at a second cooperative prediction related to the transaction, wherein the second cooperative prediction is based, at least in part, on a second affinity value, wherein the second affinity value represents a weight afforded by the second swarm member to predictions generated by one or more other swarm members with respect to the transaction; and
generating a swarm prediction related to the transaction based on both the first cooperative prediction and the second cooperative prediction, wherein the swarm prediction includes a disposition decision indicating how the transaction is to be processed.

20. The method of claim 19, further comprising:
training the first swarm member to generate the first cooperative prediction, wherein the training includes:
obtaining an actual outcome of the transaction;
comparing the actual outcome of the transaction to the swarm prediction to generate a prediction accuracy; and
adjusting the first affinity value of the first swarm member based on the prediction accuracy.

21. The method of claim 20, further comprising:
determining that after successive adjustments to the first affinity value, cooperative predictions generated by the first swarm member differ, by more than a threshold amount, from expert predictions made by the first swarm member, wherein the expert predictions are generated independent of affinity values; and
in response to the determining, retraining the first swarm member.

22. The method of claim 21, wherein retraining the first swarm member includes:
incrementally updating an accuracy of the first swarm member.

23. The method of claim 20, wherein training the first swarm member to generate the first cooperative prediction includes:
obtaining historical data associated with historical transactions, the historical data including an actual historical outcome associated with a first historical transaction, and a result of an evaluation of the first historical transaction by the second swarm member;
generating a plurality of first cooperative predictions related to the first historical transaction using the first swarm member, wherein the plurality of first cooperative predictions are generated using different test affinity values of the first swarm member to the one or more other swarm members;
comparing the plurality of first cooperative predictions to the actual historical outcome; and
setting the first affinity value of the first swarm member based on comparisons of the plurality of first cooperative predictions to the actual historical outcome.

24. The method of claim 20, wherein training the first swarm member to generate the first cooperative prediction includes:
using different first affinity values for different transaction contexts.

25. The method of claim 19, wherein:
the first affinity value of the first swarm member is selected based on a context of the transaction.

26. A method of generating a swarm prediction, the method comprising:
training a first BOT to make cooperative predictions based, at least in part on a first affinity value, wherein the first affinity value represents a weight afforded by the first BOT to predictions generated by a second BOT;
training a second BOT to make cooperative predictions based, at least in part on a second affinity value, wherein the second affinity value represents a weight afforded by the second BOT to predictions generated by the first BOT;
evaluating a transaction using the first BOT to arrive at a first cooperative prediction related to an outcome of the transaction;
evaluating the transaction using the second BOT to arrive at a second cooperative prediction related to an outcome of the transaction; and
generating a swarm prediction related to an outcome of the transaction based on both the first cooperative prediction and the second cooperative prediction.

27. The method of claim 26, further comprising:
obtaining an actual outcome of the transaction;
comparing the actual outcome to the swarm prediction to generate a prediction accuracy; and
adjusting at least one of the first affinity value of the first BOT to the second BOT or the second affinity value of the second BOT to the first BOT based on the prediction accuracy.

28. The method of claim 27, further comprising:
determining that cooperative predictions made by the first BOT after successive adjustments to the first affinity value differ by more than a threshold amount from independent predictions made by the first BOT; and
in response to the determining, retraining the first BOT.

29. The method of claim 28, wherein retraining the first BOT includes:
incrementally updating a predictive accuracy of the first BOT.

30. The method of claim 26, wherein training the first BOT to make cooperative predictions based, at least in part on a first affinity of the first BOT to the second BOT includes:
obtaining historical data associated with historical transactions, the historical data including an actual historical outcome associated with a first historical transaction, and a result of an evaluation of the first historical transaction by the second BOT;
generating a plurality of first cooperative predictions related to an outcome of the first historical transaction using the first BOT, wherein the plurality of first cooperative predictions are generated using different test affinity values of the first BOT to the second BOT;
comparing the plurality of first cooperative predictions to the actual historical outcome; and
setting the first affinity value of the first BOT to the second BOT based on comparisons of the plurality of first cooperative predictions to the actual historical outcome.

31. The method of claim 26, wherein training the first BOT to make cooperative predictions based, at least in part on a first affinity of the first BOT to the second BOT includes:
using different first affinity values for different transaction contexts.

32. The method of claim 31, wherein evaluating the transaction using the first BOT further includes:
selecting the first affinity value based on information included in an affinity table associated with the first BOT.

33. A computer-readable storage device comprising:
a first memory section that stores operational instructions that, when executed by a computing entity of a data transactional network, causes the computing entity to:
train a first BOT to make cooperative predictions based, at least in part on a first affinity value, wherein:
the first affinity value represents a weight afforded by the first BOT to predictions generated by a second BOT; and
the first affinity value is associated with a first context;
train the second BOT to make cooperative predictions based, at least in part on a second affinity value, wherein:
the second affinity value represents a weight afforded by the second BOT to predictions generated by the first BOT; and
the second affinity value is associated with the first context;
a second memory section that stores operational instructions that, when executed by the computing entity, causes the computing entity to:
evaluate a transaction using the first BOT to arrive at a first cooperative prediction related to an outcome of the transaction;
evaluate the transaction using the second BOT to arrive at a second cooperative prediction related to an outcome of the transaction; and
a third memory section that stores operational instructions that, when executed by the computing entity, causes the computing entity to:
generate a swarm prediction related to an outcome of the transaction based on both the first cooperative prediction and the second cooperative prediction.

34. The computer-readable storage device of claim 33, further comprising:
obtaining an actual outcome of the transaction;
comparing the actual outcome to the swarm prediction to generate a prediction accuracy; and
adjusting at least one of the first affinity value of the first BOT to the second BOT or the second affinity value of the second BOT to the first BOT based on the prediction accuracy.

35. The computer-readable storage device of claim 34, further comprising:
determining that cooperative predictions made by the first BOT after successive adjustments to the first affinity value differ by more than a threshold amount from independent predictions made by the first BOT; and
in response to the determining, retraining the first BOT.

36. The computer-readable storage device of claim 35, wherein retraining the first BOT includes:
incrementally updating a predictive accuracy of the first BOT.

37. The computer-readable storage device of claim 33, wherein training the first BOT to make cooperative predictions based, at least in part on a first affinity of the first BOT to the second BOT includes:
obtaining historical data associated with historical transactions, the historical data including an actual historical outcome associated with a first historical transaction, and a result of an evaluation of the first historical transaction by the second BOT;
generating a plurality of first cooperative predictions related to an outcome of the first historical transaction using the first BOT, wherein the plurality of first cooperative predictions are generated using different test affinity values of the first BOT to the second BOT;
comparing the plurality of first cooperative predictions to the actual historical outcome; and
setting the first affinity value of the first BOT to the second BOT based on comparisons of the plurality of first cooperative predictions to the actual historical outcome.

38. The computer-readable storage device of claim 33, wherein evaluating the transaction using the first BOT further includes:
selecting an affinity value for evaluating the transaction based, at least in part, on information included in an affinity table associated with the first BOT.
